(19) United States
(12) Patent Application Publication
(10) Pub. No.: US 2017/0064341 A1
(43) Pub. Date: Mar. 2, 2017

(54) BROADCASTING TRANSMITTING APPARATUS, METHOD FOR OPERATING BROADCASTING TRANSMITTING APPARATUS, BROADCASTING RECEIVING APPARATUS, AND METHOD FOR OPERATING BROADCASTING RECEIVING APPARATUS

(71) Applicant: LG ELECTRONICS INC., Seoul (KR)

(72) Inventors: Sejin OH, Seoul (KR); Woosuk KO, Seoul (KR); Woosuk KWON, Seoul (KR); Jangwon LEE, Seoul (KR); Sungryong HONG, Seoul (KR); Kyoungsoo MOON, Seoul (KR)

(73) Assignee: LG ELECTRONICS INC., Seoul (KR)

(21) Appl. No.: 15/306,346

(22) PCT Filed: Apr. 20, 2015
(86) PCT No.: PCT/KR2015/003935

§ 371 Date: Oct. 24, 2016

Related U.S. Application Data
(60) Provisional application No. 61/984,015, filed on Apr. 24, 2014.
(60) Provisional application No. 62/000,514, filed on May 19, 2014.

(51) Int. Cl. H04N 21/235; H04N 21/2381; H04N 21/41; H04N 21/234

(52) U.S. Cl. CPC H04N 21/235; H04N 21/234; H04N 21/2381; H04N 21/41

(57) ABSTRACT

Disclosed is a broadcasting receiving apparatus. The broadcast receiving apparatus includes a reception unit configured to receive a transport protocol packet including a service signaling message for signaling a broadcast service; and a control unit configured to extract the service signaling message from the received transport protocol packet and acquire information for providing the broadcast service from the extracted service signaling message.

### TECHNICAL FIELD

The present invention relates to a broadcasting transmitting apparatus, a method for operating a broadcasting transmitting apparatus, a broadcasting receiving apparatus, and a method for operating broadcasting receiving apparatus

### BACKGROUND ART

Recent digital broadcasts require service and content transmission synchronization methods for supporting hybrid broadcasts to receive A/V through terrestrial broadcast networks and A/V and enhancement data through Internet networks.

Especially, as one of the promising applications to be used in the future DTV service, there are hybrid broadcast services interworking with Internet networks in addition to existing terrestrial broadcast networks. The hybrid broadcast services transmit enhancement data relating to a broadcast content transmitted via terrestrial broadcast networks or part of broadcast content, via Internet networks in realtime, so that they allow users to experience various contents. Therefore, there is a need for a broadcasting transmitting apparatus and a broadcasting receiving apparatus which transmit and receive broadcast content through both terrestrial broadcast networks and Internet networks.

### DISCLOSURE OF THE INVENTION

### Technical Problem

Embodiments provide a broadcasting transmitting apparatus and an operation method thereof, and a broadcasting receiving apparatus and an operation method thereof, which support future hybrid broadcasts interworking with terrestrial broadcast networks and Internet networks.

In particular, embodiments provide a broadcasting transmitting apparatus and an operation method thereof, and a broadcasting receiving apparatus and an operation method thereof, which use a payload format of a service signaling message in a future broadcast system.

In particular, embodiments provide a broadcasting transmitting apparatus and an operation method thereof, and a broadcasting receiving apparatus and an operation method thereof, which use broadcast service signaling in a future broadcast system.

In particular, embodiments provide a broadcasting transmitting apparatus and an operation method thereof, and a broadcasting receiving apparatus and an operation method thereof, which use signaling for a component acquisition path of a broadcast service in a future broadcast system.

In particular, embodiments provide a broadcasting transmitting apparatus and an operation method thereof, and a broadcasting receiving apparatus and an operation method thereof, which use signaling for a transmission flow of a component of a broadcast service in a future broadcast system.

### TECHNICAL SOLUTION

In one embodiment, a broadcasting receiving apparatus includes a reception unit configured to receive a transport protocol packet including a service signaling message for signaling a broadcast service; and a control unit configured to extract the service signaling message from the received transport protocol packet and acquire information for providing the broadcast service from the extracted service signaling message.

The information for providing the broadcast service may include at least one of first transport mode information for a timebase including metadata for a timeline that is a series of time information for content, used in the broadcast service, second transport mode information for detailed information for acquisition of segments constituting content in adaptive media streaming, third transport mode information for a path for acquisition of component data constituting content in the broadcast service, fourth transport mode information for a signaling message for an application used in the broadcast service, and fifth transport mode information for a signaling message for a service used in the broadcast service.

The control unit may acquire at least one of the timebase, the detailed information for acquisition of the segments, the path for acquisition of the component data, the signaling message for the application, and the signaling message for the service, via an Internet protocol datagram in the same broadcast stream as a broadcast stream through which the service signaling message is received currently.

The control unit may acquire at least one of the timebase, the detailed information for acquisition of the segments, the path for acquisition of the component data, the signaling message for the application, and the signaling message for the service, via an Internet protocol datagram in a different broadcast stream from a broadcast stream through which the service signaling message is received currently.

The control unit may acquire information for identifying a broadcaster which transmits the different broadcast stream from the broadcast stream through which the service signaling message is received currently.

The control unit may acquire at least one of the timebase, the detailed information for acquisition of the segments, the path for acquisition of the component data, the signaling message for the application, and the signaling message for the service, via a session-based transport protocol in the same broadcast stream as a broadcast stream through which the service signaling message is received currently.

The control unit may acquire at least one of the timebase, the detailed information for acquisition of the segments, the path for acquisition of the component data, the signaling message for the application, and the signaling message for the service, via a session-based transport protocol in a different broadcast stream from a broadcast stream through which the service signaling message is received currently.

The control unit may acquire at least one of the timebase, the detailed information for acquisition of the segments, the path for acquisition of the component data, the signaling message for the application, and the signaling message for the service, via a packet-based flow in the same broadcast stream as a broadcast stream through which the service signaling message is received currently.

The control unit may acquire at least one of the timebase, the detailed information for acquisition of the segments, the path for acquisition of the component data, the signaling message for the application, and the signaling message for the service, via a packet-based flow in a different broadcast stream from a broadcast stream through which the service signaling message is received currently.

The third transport mode information may include at least one of identification information of a physical layer pipe for delivering the component data, a source Internet protocol address of the Internet protocol datagram including the component data, and a destination Internet protocol address of the Internet protocol datagram including the component data.

The fourth transport mode information may include at least one of identifier information of a broadcaster which transmits the application, a source IP address of a Internet protocol datagram including the application, a destination IP address of the Internet protocol datagram including the application, a port number of a user datagram protocol (UDP) of the Internet protocol datagram including the application, identifier information of a transport session for transmitting the application, and identifier information of a packet for transmitting the application.

The information for providing the broadcast service may include sixth transport mode information for component data constituting a service, and the sixth transport mode information may indicate at least one of a transport mode for supporting a non-realtime service, a transport mode for supporting a realtime service, and a transport mode for transmitting a packet.

The information for providing the broadcast service may include information for receiving a realtime service with a file format.

In another embodiment, a method for operating a broadcasting receiving apparatus includes receiving a transport protocol packet including a service signaling message for signaling a broadcast service; extracting the service signaling message from the received transport protocol packet; and acquiring information for providing the broadcast service from the extracted service signaling message.

The acquiring of the information for providing the broadcast service may include acquiring at least one of first transport mode information for a timebase including metadata for a timeline that is a series of time information for content, used in the broadcast service, second transport mode information for detailed information for acquisition of segments constituting content in adaptive media streaming, third transport mode information for a path for acquisition of component data constituting content in a broadcast service, fourth transport mode information for a signaling message for an application used in the broadcast service, and fifth transport mode information for a signaling message for a service used in the broadcast service.

The acquiring of the information for providing the broadcast service may include acquiring sixth transport mode information for component data constituting a service, and

the sixth transport mode information may indicate at least one of a transport mode for supporting a non-realtime service, a transport mode for supporting a realtime service, and a transport mode for transmitting a packet.

The acquiring of the information for providing the broadcast service may include acquiring sixth transport mode information for component data constituting a service, and the sixth transport mode information may indicate at least one of a transport mode for supporting a non-realtime service, a transport mode for supporting a realtime service, and a transport mode for transmitting a packet.

The acquiring of the information for providing the broadcast service may include acquiring information for receiving a realtime service with a file format.

In further another embodiment, a broadcasting transmitting apparatus includes a control unit configured to insert information for providing a broadcast service into a service signaling message and packetize the service signaling message into a transport protocol packet; and a transmission unit configured to transmit the transport protocol packet through a specific transport mode.

The specific transport mode may be at least one of a transport mode for a timebase including metadata for a timeline that is a series of time information for content, used in the broadcast service, a second transport mode for detailed information for acquisition of segments constituting content in adaptive media streaming, a third transport mode for a path for acquisition of component data constituting content in a broadcast service, a fourth transport mode for a signaling message for an application used in the broadcast service, and a fifth transport mode for a signaling message for a service used in the broadcast service.

The specific transport mode may further include a transport mode for component data constituting the broadcast service.

### Advantageous Effects

According to the embodiments, it is possible to provide a broadcasting transmitting apparatus and an operation method thereof, and a broadcasting receiving apparatus and an operation method thereof, which support future hybrid broadcasts interworking with terrestrial broadcast networks and Internet networks.

According to the embodiments, it is possible to provide a broadcasting transmitting apparatus and an operation method thereof, and a broadcasting receiving apparatus and an operation method thereof, which use a payload format of a service signaling message in a future broadcast system.

According to the embodiments, it is possible to provide a broadcasting transmitting apparatus and an operation method thereof, and a broadcasting receiving apparatus and an operation method thereof, which use broadcast service signaling in a future broadcast system.

According to the embodiments, it is possible to provide a broadcasting transmitting apparatus and an operation method thereof, and a broadcasting receiving apparatus and an operation method thereof, which use signaling for a component acquisition path of a broadcast service in a future broadcast system.

According to the embodiments, it is possible to provide a broadcasting transmitting apparatus and an operation method thereof, and a broadcasting receiving apparatus and an operation method thereof, which use signaling for a transmission flow of a component of a broadcast service in a future broadcast system.

### BRIEF DESCRIPTION OF THE DRAWINGS

The accompanying drawings are included to provide a further understanding of the invention and are incorporated in and constitute a part of this specification, illustrate several embodiments of the invention and, together with the description, serve to explain the principles of the invention.

FIG. 1 illustrates a structure of an apparatus for transmitting broadcast signals for future broadcast services according to an embodiment of the present invention.

FIG. 2 illustrates an input formatting block according to one embodiment of the present invention.

FIG. 3 illustrates an input formatting block according to another embodiment of the present invention.

FIG. 4 illustrates a BICM block according to an embodiment of the present invention.

FIG. 5 illustrates a BICM block according to another embodiment of the present invention.

FIG. 6 illustrates a frame building block according to one embodiment of the present invention.

FIG. 7 illustrates an OFMD generation block according to an embodiment of the present invention.

FIG. 8 illustrates a structure of an apparatus for receiving broadcast signals for future broadcast services according to an embodiment of the present invention.

FIG. 9 illustrates a frame structure according to an embodiment of the present invention.

FIG. 10 illustrates a signaling hierarchy structure of the frame according to an embodiment of the present invention.

FIG. 11 illustrates preamble signaling data according to an embodiment of the present invention.

FIG. 12 illustrates PLS1 data according to an embodiment of the present invention.

FIG. 13 illustrates PLS2 data according to an embodiment of the present invention.

FIG. 14 illustrates PLS2 data according to another embodiment of the present invention.

FIG. 15 illustrates a logical structure of a frame according to an embodiment of the present invention.

FIG. 16 illustrates PLS mapping according to an embodiment of the present invention.

FIG. 17 illustrates EAC mapping according to an embodiment of the present invention.

FIG. 18 illustrates FIC mapping according to an embodiment of the present invention.

FIG. 19 illustrates an FEC structure according to an embodiment of the present invention.

FIG. 20 illustrates a time interleaving according to an embodiment of the present invention.

FIG. 21 illustrates the basic operation of a twisted row-column block interleaver according to an embodiment of the present invention.

FIG. 22 illustrates an operation of a twisted row-column block interleaver according to another embodiment of the present invention.

FIG. 23 illustrates a diagonal-wise reading pattern of a twisted row-column block interleaver according to an embodiment of the present invention.

FIG. 24 illustrates interleaved XFECBLOCKs from each interleaving array according to an embodiment of the present invention.

FIG. 25 illustrates a protocol stack for supporting a broadcast service, according to an embodiment of the present invention.

FIG. 26 illustrates a configuration of a media content transmitting/receiving system via an IP network, according to an embodiment of the present invention.

FIG. 27 illustrates a structure of a media presentation description (MPD), according to an embodiment of the present invention.

FIG. 28 illustrates a transport layer of a broadcast service, according to an embodiment of the present invention.

FIG. 29 illustrates a configuration of a broadcasting receiving apparatus according to an embodiment.

FIGS. 30 and 31 illustrate configurations of a broadcasting receiving apparatus, according to other embodiments of the present invention.

FIG. 32 illustrates a configuration of a broadcasting receiving apparatus, according to another embodiment.

FIG. 33 illustrates a broadcast transmission frame, according to an embodiment of the present invention.

FIG. 34 illustrates a broadcast transmission frame, according to another embodiment of the present invention.

FIG. 35 illustrates a configuration of a transport packet, according to an embodiment of the present invention.

FIG. 36 illustrates a configuration of a service signaling message, according to an embodiment of the present invention.

FIG. 37 illustrates a configuration of a broadcast service signaling message in a future broadcast system, according to an embodiment of the present invention.

FIG. 38 illustrates content meant by a value indicated by a timebase_transport_mode field and a signaling_transport_mode field in a service signaling message, according to an embodiment of the present invention.

FIGS. 39 to 45 illustrate a syntax of a bootstrap( ) field according to a signaling_transport_mode field and a value of the signaling_transport_mode field, according to an embodiment of the present invention.

FIG. 46 illustrates a process of acquiring a timebase and a signaling message according to the embodiments of FIGS. 37 to 45.

FIG. 47 illustrates a configuration of a broadcast service signaling message in a future broadcast system, according to an embodiment of the present invention.

FIG. 48 illustrates a configuration of a broadcast service signaling message in a future broadcast system, according to an embodiment of the present invention.

FIG. 49 illustrates the meaning of values represented by the transport modes described with reference to FIG. 48.

FIG. 50 illustrates a configuration of a signaling message for signaling a component data acquisition path of a broadcast service in a future broadcasting system.

FIG. 51 illustrates a syntax of an app_delevery_info( ) field, according to an embodiment of the present invention.

FIG. 52 illustrates a syntax of an app_delevery_info( ) field, according to another embodiment of the present invention.

FIG. 53 illustrates component location signaling including information about a path in which one or more pieces of component data constituting a broadcast service can be acquired.

FIG. 54 illustrates a vehicle moving along the component location signaling of FIG. 53.

FIG. 55 illustrates another information included in signaling of a broadcast service in a future broadcast system according to an embodiment of the present invention.

FIG. 56 illustrates another information included in signaling for an object flow.

FIG. 57 illustrates a combination of pieces of information for expressing a file template according to an embodiment of the present invention.

FIG. 58 illustrates another information included in signaling of a broadcast service in a future broadcast system according to an embodiment of the present invention.

FIG. 59 is a flowchart of operation of a broadcasting receiving apparatus according to an embodiment of the present invention.

FIG. 60 is a flowchart of operation of a broadcasting transmitting apparatus according to an embodiment of the present invention.

### MODE FOR CARRYING OUT THE INVENTION

Embodiments of the present invention are described with reference to the accompanying drawings. The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details.

Although most terms used in the present invention have been selected from general ones widely used in the art, some terms have been arbitrarily selected by the applicant and their meanings are explained in detail in the following description as needed. Thus, the present invention should be understood with the intended meanings of the terms rather than their simple names or meanings.

The present invention provides broadcast signal transmitting/receiving device and method. According to the embodiment of the present invention, the further broadcast services include a terrestrial broadcasting service, a mobile broadcasting server, and UHDTV service. The present invention may process broadcast signals for the future broadcast services through non-MIMO (Multiple Input Multiple Output) or MIMO according to one embodiment. A non-MIMO scheme according to an embodiment of the present invention may include a MISO (Multiple Input Single Output) scheme, a SISO (Single Input Single Output) scheme, etc.

While MISO or MIMO uses two antennas in the following for convenience of description, the present invention is applicable to systems using two or more antennas. The present invention may defines three physical layer (PL) profiles (base, handheld and advanced profiles) each optimized to minimize receiver complexity while attaining the performance required for a particular use case. The physical layer (PHY) profiles are subsets of all configurations that a corresponding receiver should implement.

The three PHY profiles share most of the functional blocks but differ slightly in specific blocks and/or parameters. Additional PHY profiles can be defined in the future. For the system evolution, future profiles can also be multiplexed with the existing profiles in a single RF channel through a future extension frame (FEF). The details of each PHY profile are described below.

1. Base Profile

The base profile represents a main use case for fixed receiving devices that are usually connected to a roof-top antenna. The base profile also includes portable devices that could be transported to a place but belong to a relatively stationary reception category. Use of the base profile could be extended to handheld devices or even vehicular by some improved implementations, but those use cases are not expected for the base profile receiver operation.

Target SNR range of reception is from approximately 10 to 20 dB, which includes the 15 dB SNR reception capability of the existing broadcast system (e.g. ATSC A/53). The receiver complexity and power consumption is not as critical as in the battery-operated handheld devices, which will use the handheld profile. Key system parameters for the base profile are listed in below table 1.

TABLE 1

| | |
|---|---|
| LDPC codeword length | 16K, 64K bits |
| Constellation size | 4~10 bpcu (bits per channel use) |
| Time de-interleaving memory size | ≦2¹⁹ data cells |
| Pilot patterns | Pilot pattern for fixed reception |
| FFT size | 16K, 32K points |

2. Handheld Profile

The handheld profile is designed for use in handheld and vehicular devices that operate with battery power. The devices can be moving with pedestrian or vehicle speed. The power consumption as well as the receiver complexity is very important for the implementation of the devices of the handheld profile. The target SNR range of the handheld profile is approximately 0 to 10 dB, but can be configured to reach below 0 dB when intended for deeper indoor reception.

In addition to low SNR capability, resilience to the Doppler Effect caused by receiver mobility is the most important performance attribute of the handheld profile. Key system parameters for the handheld profile are listed in the below table 2.

TABLE 2

| | |
|---|---|
| LDPC codeword length | 16K bits |
| Constellation size | 2~8 bpcu |
| Time de-interleaving memory size | ≦2¹⁸ data cells |
| Pilot patterns | Pilot patterns for mobile and |
| | indoor reception |
| FFT size | 8K, 16K points |

3. Advanced Profile

The advanced profile provides highest channel capacity at the cost of more implementation complexity. This profile requires using MIMO transmission and reception, and UHDTV service is a target use case for which this profile is specifically designed. The increased capacity can also be used to allow an increased number of services in a given bandwidth, e.g., multiple SDTV or HDTV services.

The target SNR range of the advanced profile is approximately 20 to 30 dB. MIMO transmission may initially use existing elliptically-polarized transmission equipment, with extension to full-power cross-polarized transmission in the future. Key system parameters for the advanced profile are listed in below table 3.

TABLE 3

| | |
|---|---|
| LDPC codeword length | 16K, 64K bits |
| Constellation size | 8~12 bpcu |
| Time de-interleaving memory size | ≦2¹⁹ data cells |
| Pilot patterns | Pilot pattern for fixed reception |
| FFT size | 16K, 32K points |

In this case, the base profile can be used as a profile for both the terrestrial broadcast service and the mobile broadcast service. That is, the base profile can be used to define a concept of a profile which includes the mobile profile. Also, the advanced profile can be divided advanced profile for a base profile with MIMO and advanced profile for a handheld profile with MIMO. Moreover, the three profiles can be changed according to intention of the designer.

The following terms and definitions may apply to the present invention. The following terms and definitions can be changed according to design.

auxiliary stream: sequence of cells carrying data of as yet undefined modulation and coding, which may be used for future extensions or as required by broadcasters or network operators

base data pipe: data pipe that carries service signaling data

baseband frame (or BBFRAME): set of K_{bch} bits which form the input to one FEC encoding process (BCH and LDPC encoding)

cell: modulation value that is carried by one carrier of the OFDM transmission

coded block: LDPC-encoded block of PLS1 data or one of the LDPC-encoded blocks of PLS2 data

data pipe: logical channel in the physical layer that carries service data or related metadata, which may carry one or multiple service(s) or service component(s).

data pipe unit: a basic unit for allocating data cells to a DP in a frame.

data symbol: OFDM symbol in a frame which is not a preamble symbol (the frame signaling symbol and frame edge symbol is included in the data symbol)

DP_ID: this 8 bit field identifies uniquely a DP within the system identified by the SYSTEM_ID

dummy cell: cell carrying a pseudorandom value used to fill the remaining capacity not used for PLS signaling, DPs or auxiliary streams

emergency alert channel: part of a frame that carries EAS information data

frame: physical layer time slot that starts with a preamble and ends with a frame edge symbol

frame repetition unit: a set of frames belonging to same or different physical layer profile including a FEF, which is repeated eight times in a super-frame

fast information channel: a logical channel in a frame that carries the mapping information between a service and the corresponding base DP

FECBLOCK: set of LDPC-encoded bits of a DP data

FFT size: nominal FFT size used for a particular mode, equal to the active symbol period Ts expressed in cycles of the elementary period T

frame signaling symbol: OFDM symbol with higher pilot density used at the start of a frame in certain combinations of FFT size, guard interval and scattered pilot pattern, which carries a part of the PLS data

frame edge symbol: OFDM symbol with higher pilot density used at the end of a frame in certain combinations of FFT size, guard interval and scattered pilot pattern

frame-group: the set of all the frames having the same PHY profile type in a super-frame.

future extension frame: physical layer time slot within the super-frame that could be used for future extension, which starts with a preamble

Futurecast UTB system: proposed physical layer broadcasting system, of which the input is one or more MPEG2-TS or IP or general stream(s) and of which the output is an RF signal

input stream: A stream of data for an ensemble of services delivered to the end users by the system.

normal data symbol: data symbol excluding the frame signaling symbol and the frame edge symbol

PHY profile: subset of all configurations that a corresponding receiver should implement

PLS: physical layer signaling data consisting of PLS1 and PLS2

PLS1: a first set of PLS data carried in the FSS symbols having a fixed size, coding and modulation, which carries basic information about the system as well as the parameters needed to decode the PLS2

NOTE: PLS1 data remains constant for the duration of a frame-group.

PLS2: a second set of PLS data transmitted in the FSS symbol, which carries, more detailed PLS data about the system and the DPs

PLS2 dynamic data: PLS2 data that may dynamically change frame-by-frame

PLS2 static data: PLS2 data that remains static for the duration of a frame-group

preamble signaling data: signaling data carried by the preamble symbol and used to identify the basic mode of the system

preamble symbol: fixed-length pilot symbol that carries basic PLS data and is located in the beginning of a frame

NOTE: The preamble symbol is mainly used for fast initial band scan to detect the system signal, its timing, frequency offset, and FFTsize.

reserved for future use: not defined by the present document but may be defined in future

superframe: set of eight frame repetition units

time interleaving block (TI block): set of cells within which time interleaving is carried out, corresponding to one use of the time interleaver memory

TI group: unit over which dynamic capacity allocation for a particular DP is carried out, made up of an integer, dynamically varying number of XFECBLOCKs.

NOTE: The TI group may be mapped directly to one frame or may be mapped to multiple frames. It may contain one or more TI blocks.

Type 1 DP: DP of a frame where all DPs are mapped into the frame in TDM fashion

Type 2 DP: DP of a frame where all DPs are mapped into the frame in FDM fashion

XFECBLOCK: set of Ncells cells carrying all the bits of one LDPC FECBLOCK

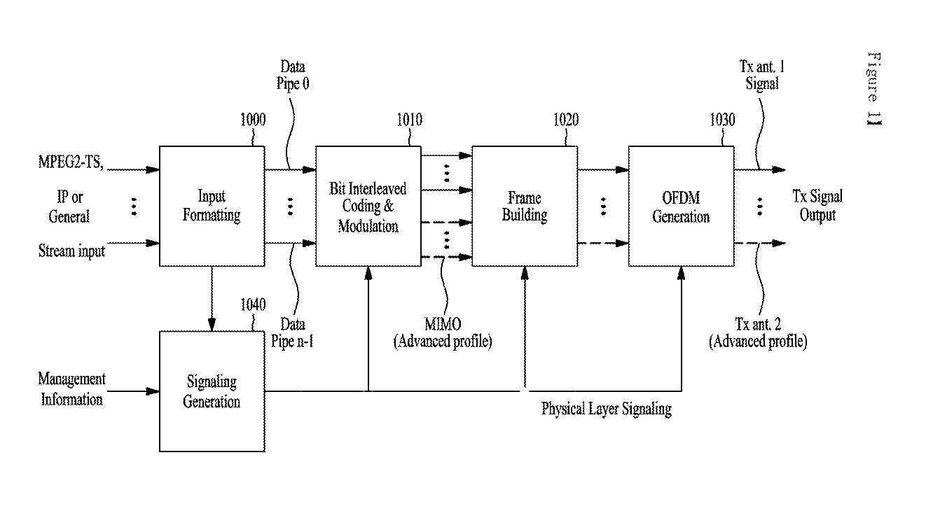

FIG. 1 illustrates a structure of an apparatus for transmitting broadcast signals for future broadcast services according to an embodiment of the present invention.

The apparatus for transmitting broadcast signals for future broadcast services according to an embodiment of the present invention can include an input formatting block 1000, a BICM (Bit interleaved coding & modulation) block 1010, a frame building block 1020, an OFDM (Orthogonal Frequency Division Multiplexing) generation block 1030 and a signaling generation block 1040. A description will be given of the operation of each module of the apparatus for transmitting broadcast signals.

IP stream/packets and MPEG2-TS are the main input formats, other stream types are handled as General Streams. In addition to these data inputs, Management Information is input to control the scheduling and allocation of the corresponding bandwidth for each input stream. One or multiple TS stream(s), IP stream(s) and/or General Stream(s) inputs are simultaneously allowed.

The input formatting block 1000 can demultiplex each input stream into one or multiple data pipe(s), to each of which an independent coding and modulation is applied. The data pipe (DP) is the basic unit for robustness control, thereby affecting quality-of-service (QoS). One or multiple service(s) or service component(s) can be carried by a single DP. Details of operations of the input formatting block 1000 will be described later.

The data pipe is a logical channel in the physical layer that carries service data or related metadata, which may carry one or multiple service(s) or service component(s).

Also, the data pipe unit: a basic unit for allocating data cells to a DP in a frame.

In the BICM block 1010, parity data is added for error correction and the encoded bit streams are mapped to complex-value constellation symbols. The symbols are interleaved across a specific interleaving depth that is used for the corresponding DP. For the advanced profile, MIMO encoding is performed in the BICM block 1010 and the additional data path is added at the output for MIMO transmission. Details of operations of the BICM block 1010 will be described later.

The frame building block 1020 can map the data cells of the input DPs into the OFDM symbols within a frame. After mapping, the frequency interleaving is used for frequency-domain diversity, especially to combat frequency-selective fading channels. Details of operations of the frame building block 1020 will be described later.

After inserting a preamble at the beginning of each frame, the OFDM generation block 1030 can apply conventional OFDM modulation having a cyclic prefix as guard interval. For antenna space diversity, a distributed MISO scheme is applied across the transmitters. In addition, a Peak-to-Average Power Reduction (PAPR) scheme is performed in the time domain. For flexible network planning, this proposal provides a set of various FFT sizes, guard interval lengths and corresponding pilot patterns. Details of operations of the OFDM generation block 1030 will be described later.

The Signaling generation block 1040 can create physical layer signaling information used for the operation of each functional block. This signaling information is also transmitted so that the services of interest are properly recovered at the receiver side. Details of operations of the Signaling generation block 1040 will be described later.

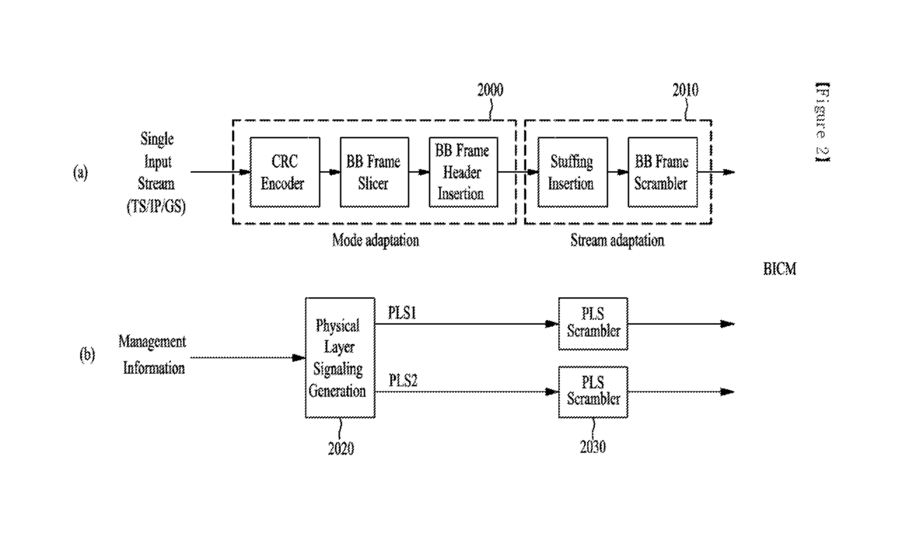

FIGS. 2, 3 and 4 illustrate the input formatting block 1000 according to embodiments of the present invention.

A description will be given of each figure.

FIG. 2 illustrates an input formatting block according to one embodiment of the present invention. FIG. 2 shows an input formatting module when the input signal is a single input stream.

The input formatting block illustrated in FIG. 2 corresponds to an embodiment of the input formatting block 1000 described with reference to FIG. 1.

The input to the physical layer may be composed of one or multiple data streams. Each data stream is carried by one DP. The mode adaptation modules slice the incoming data stream into data fields of the baseband frame (BBF). The system supports three types of input data streams: MPEG2-TS, Internet protocol (IP) and Generic stream (GS). MPEG2-TS is characterized by fixed length (188 byte) packets with the first byte being a sync-byte (0x47). An IP stream is composed of variable length IP datagram packets, as signaled within IP packet headers. The system supports both IPv4 and IPv6 for the IP stream. GS may be composed of variable-length packets or constant length packets, signaled within encapsulation packet headers.

(a) shows a mode adaptation block 2000 and a stream adaptation 2010 for signal DP and (b) shows a PLS generation block 2020 and a PLS scrambler 2030 for generating and processing PLS data. A description will be given of the operation of each block.

The Input Stream Splitter splits the input TS, IP, GS streams into multiple service or service component (audio, video, etc.) streams. The mode adaptation module 2000 is comprised of a CRC Encoder, BB (baseband) Frame Slicer, and BB Frame Header Insertion block.

The CRC Encoder provides three kinds of CRC encoding for error detection at the user packet (UP) level, i.e., CRC-8, CRC-16, and CRC-32. The computed CRC bytes are appended after the UP. CRC-8 is used for TS stream and CRC-32 for IP stream. If the GS stream doesn't provide the CRC encoding, the proposed CRC encoding should be applied.

BB Frame Slicer maps the input into an internal logical-bit format. The first received bit is defined to be the MSB. The BB Frame Slicer allocates a number of input bits equal to the available data field capacity. To allocate a number of input bits equal to the BBF payload, the UP packet stream is sliced to fit the data field of BBF.

BB Frame Header Insertion block can insert fixed length BBF header of 2 bytes is inserted in front of the BB Frame. The BBF header is composed of STUFFI (1 bit), SYNCD (13 bits), and RFU (2 bits). In addition to the fixed 2-Byte BBF header, BBF can have an extension field (1 or 3 bytes) at the end of the 2-byte BBF header.

The stream adaptation 2010 is comprised of stuffing insertion block and BB scrambler. The stuffing insertion block can insert stuffing field into a payload of a BB frame. If the input data to the stream adaptation is sufficient to fill a BB-Frame, STUFFI is set to ‘0’ and the BBF has no stuffing field. Otherwise STUFI is set to ‘1’ and the stuffing field is inserted immediately after the BBF header. The stuffing field comprises two bytes of the stuffing field header and a variable size of stuffing data.

The BB scrambler scrambles complete BBF for energy dispersal. The scrambling sequence is synchronous with the BBF. The scrambling sequence is generated by the feed-back shift register.

The PLS generation block 2020 can generate physical layer signaling (PLS) data. The PLS provides the receiver with a means to access physical layer DPs. The PLS data consists of PLS1 data and PLS2 data.

The PLS1 data is a first set of PLS data carried in the FSS symbols in the frame having a fixed size, coding and modulation, which carries basic information about the system as well as the parameters needed to decode the PLS2 data. The PLS1 data provides basic transmission parameters including parameters required to enable the reception and decoding of the PLS2 data. Also, the PLS1 data remains constant for the duration of a frame-group.

The PLS2 data is a second set of PLS data transmitted in the FSS symbol, which carries more detailed PLS data about the system and the DPs. The PLS2 contains parameters that provide sufficient information for the receiver to decode the desired DP. The PLS2 signaling further consists of two types of parameters, PLS2 Static data (PLS2-STAT data) and PLS2 dynamic data (PLS2-DYN data). The PLS2 Static data is PLS2 data that remains static for the duration of a frame-group and the PLS2 dynamic data is PLS2 data that may dynamically change frame-by-frame.

Details of the PLS data will be described later.

The PLS scrambler 2030 can scramble the generated PLS data for energy dispersal.

The above-described blocks may be omitted or replaced by blocks having similar or identical functions.

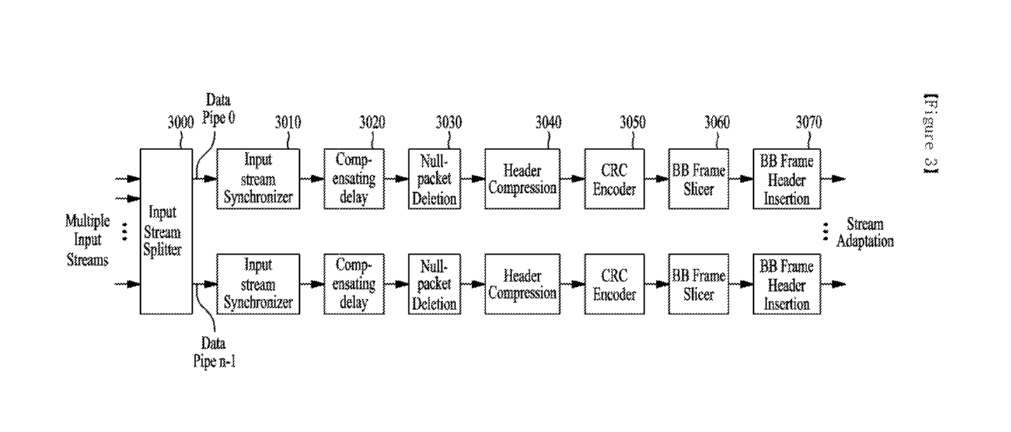

FIG. 3 illustrates an input formatting block according to another embodiment of the present invention.

The input formatting block illustrated in FIG. 3 corresponds to an embodiment of the input formatting block 1000 described with reference to FIG. 1.

FIG. 3 shows a mode adaptation block of the input formatting block when the input signal corresponds to multiple input streams.

The mode adaptation block of the input formatting block for processing the multiple input streams can independently process the multiple input streams.

Referring to FIG. 3, the mode adaptation block for respectively processing the multiple input streams can include an input stream splitter 3000, an input stream synchronizer 3010, a compensating delay block 3020, a null packet deletion block 3030, a head compression block 3040, a CRC encoder 3050, a BB frame slicer 3060 and a BB header insertion block 3070. Description will be given of each block of the mode adaptation block.

Operations of the CRC encoder 3050, BB frame slicer 3060 and BB header insertion block 3070 correspond to those of the CRC encoder, BB frame slicer and BB header insertion block described with reference to FIG. 2 and thus description thereof is omitted.

The input stream splitter 3000 can split the input TS, IP, GS streams into multiple service or service component (audio, video, etc.) streams.

The input stream synchronizer 3010 may be referred as ISSY. The ISSY can provide suitable means to guarantee Constant Bit Rate (CBR) and constant end-to-end transmission delay for any input data format. The ISSY is always used for the case of multiple DPs carrying TS, and optionally used for multiple DPs carrying GS streams.

The compensating delay block 3020 can delay the split TS packet stream following the insertion of ISSY information to allow a TS packet recombining mechanism without requiring additional memory in the receiver.

The null packet deletion block 3030, is used only for the TS input stream case. Some TS input streams or split TS streams may have a large number of null-packets present in order to accommodate VBR (variable bit-rate) services in a CBR TS stream. In this case, in order to avoid unnecessary transmission overhead, null-packets can be identified and not transmitted. In the receiver, removed null-packets can be re-inserted in the exact place where they were originally by reference to a deleted null-packet (DNP) counter that is inserted in the transmission, thus guaranteeing constant bit-rate and avoiding the need for time-stamp (PCR) updating.

The head compression block 3040 can provide packet header compression to increase transmission efficiency for TS or IP input streams. Because the receiver can have a priori information on certain parts of the header, this known information can be deleted in the transmitter.

For Transport Stream, the receiver has a-priori information about the sync-byte configuration (0x47) and the packet length (188 Byte). If the input TS stream carries content that has only one PID, i.e., for only one service component (video, audio, etc.) or service sub-component (SVC base layer, SVC enhancement layer, MVC base view or MVC dependent views), TS packet header compression can be applied (optionally) to the Transport Stream. IP packet header compression is used optionally if the input steam is an IP stream. The above-described blocks may be omitted or replaced by blocks having similar or identical functions.

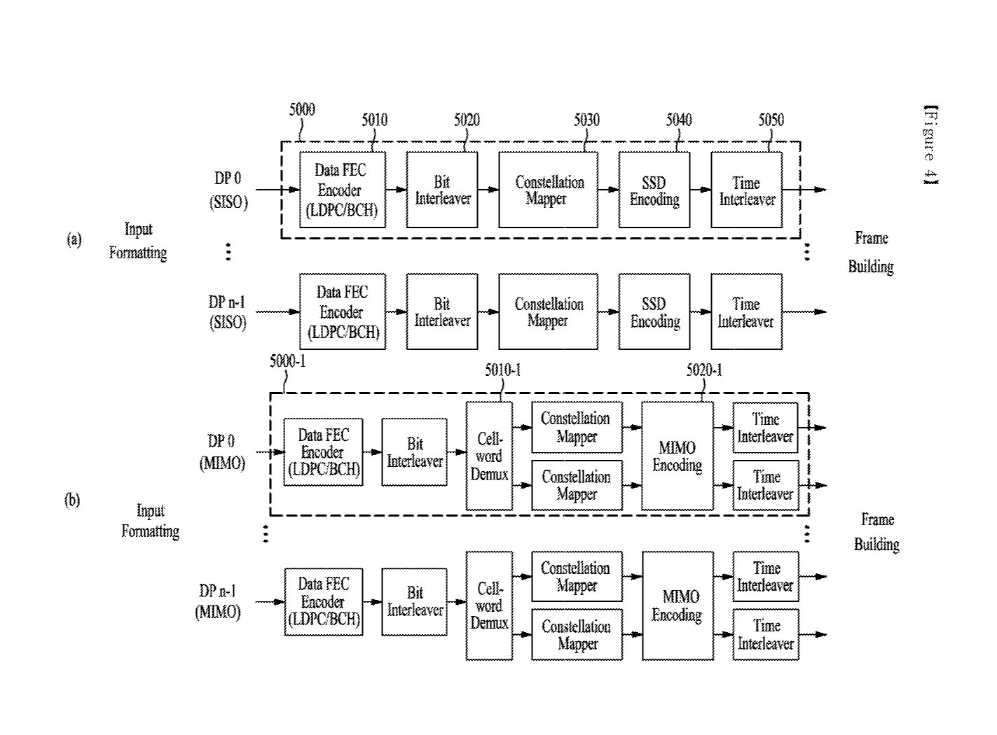

FIG. 4 illustrates a BICM block according to an embodiment of the present invention.

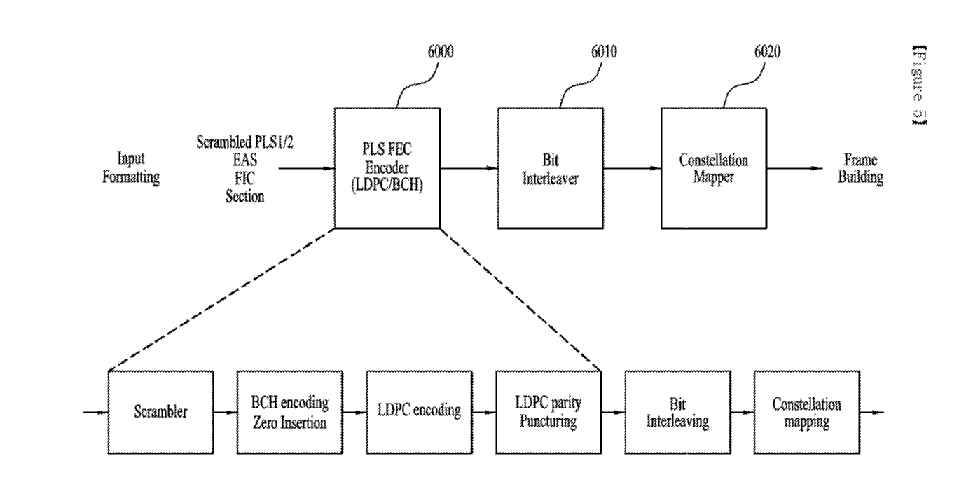

The BICM block illustrated in FIG. 5 corresponds to an embodiment of the BICM block 1010 described with reference to FIG. 1.

As described above, the apparatus for transmitting broadcast signals for future broadcast services according to an embodiment of the present invention can provide a terrestrial broadcast service, mobile broadcast service, UHDTV service, etc.

Since QoS (quality of service) depends on characteristics of a service provided by the apparatus for transmitting broadcast signals for future broadcast services according to an embodiment of the present invention, data corresponding to respective services needs to be processed through different schemes. Accordingly, the a BICM block according to an embodiment of the present invention can independently process DPs input thereto by independently applying SISO, MISO and MIMO schemes to the data pipes respectively corresponding to data paths. Consequently, the apparatus for transmitting broadcast signals for future broadcast services according to an embodiment of the present invention can control QoS for each service or service component transmitted through each DP.

(a) shows the BICM block shared by the base profile and the handheld profile and (b) shows the BICM block of the advanced profile.

The BICM block shared by the base profile and the handheld profile and the BICM block of the advanced profile can include plural processing blocks for processing each DP.

A description will be given of each processing block of the BICM block for the base profile and the handheld profile and the BICM block for the advanced profile.

A processing block 5000 of the BICM block for the base profile and the handheld profile can include a Data FEC encoder 5010, a bit interleaver 5020, a constellation mapper 5030, an SSD (Signal Space Diversity) encoding block 5040 and a time interleaver 5050.

The Data FEC encoder 5010 can perform the FEC encoding on the input BBF to generate FECBLOCK procedure using outer coding (BCH), and inner coding (LDPC). The outer coding (BCH) is optional coding method. Details of operations of the Data FEC encoder 5010 will be described later.

The bit interleaver 5020 can interleave outputs of the Data FEC encoder 5010 to achieve optimized performance with combination of the LDPC codes and modulation scheme while providing an efficiently implementable structure. Details of operations of the bit interleaver 5020 will be described later.

The constellation mapper 5030 can modulate each cell word from the bit interleaver 5020 in the base and the handheld profiles, or cell word from the Cell-word demultiplexer 5010-1 in the advanced profile using either QPSK, QAM-16, non-uniform QAM (NUQ-64, NUQ-256, NUQ-1024) or non-uniform constellation (NUC-16, NUC-64, NUC-256, NUC-1024) to give a power-normalized constellation point, el. This constellation mapping is applied only for DPs. Observe that QAM-16 and NUQs are square shaped, while NUCs have arbitrary shape. When each constellation is rotated by any multiple of 90 degrees, the rotated constellation exactly overlaps with its original one. This “rotation-sense” symmetric property makes the capacities and the average powers of the real and imaginary components equal to each other. Both NUQs and NUCs are defined specifically for each code rate and the particular one used is signaled by the parameter DP_MOD filed in PLS2 data.

The SSD encoding block 5040 can precode cells in two (2D), three (3D), and four (4D) dimensions to increase the reception robustness under difficult fading conditions.

The time interleaver 5050 can operates at the DP level. The parameters of time interleaving (TI) may be set differently for each DP. Details of operations of the time interleaver 5050 will be described later.

A processing block 5000-1 of the BICM block for the advanced profile can include the Data FEC encoder, bit interleaver, constellation mapper, and time interleaver. However, the processing block 5000-1 is distinguished from the processing block 5000 further includes a cell-word demultiplexer 5010-1 and a MIMO encoding block 5020-1.

Also, the operations of the Data FEC encoder, bit interleaver, constellation mapper, and time interleaver in the processing block 5000-1 correspond to those of the Data FEC encoder 5010, bit interleaver 5020, constellation mapper 5030, and time interleaver 5050 described and thus description thereof is omitted.

The cell-word demultiplexer 5010-1 is used for the DP of the advanced profile to divide the single cell-word stream into dual cell-word streams for MI-MO processing. Details of operations of the cell-word demultiplexer 5010-1 will be described later.

The MIMO encoding block 5020-1 can processing the output of the cell-word demultiplexer 5010-1 using MIMO encoding scheme. The MIMO encoding scheme was optimized for broadcasting signal transmission. The MIMO technology is a promising way to get a capacity increase but it depends on channel characteristics. Especially for broadcasting, the strong LOS component of the channel or a difference in the received signal power between two antennas caused by different signal propagation characteristics makes it difficult to get capacity gain from MIMO. The proposed MIMO encoding scheme overcomes this problem using a rotation-based pre-coding and phase randomization of one of the MIMO output signals.

MIMO encoding is intended for a 2×2 MIMO system requiring at least two antennas at both the transmitter and the receiver. Two MIMO encoding modes are defined in this proposal; full-rate spatial multiplexing (FR-SM) and full-rate full-diversity spatial multiplexing (FRFD-SM). The FR-SM encoding provides capacity increase with relatively small complexity increase at the receiver side while the FRFD-SM encoding provides capacity increase and additional diversity gain with a great complexity increase at the receiver side. The proposed MIMO encoding scheme has no restriction on the antenna polarity configuration.

MIMO processing is required for the advanced profile frame, which means all DPs in the advanced profile frame are processed by the MIMO encoder. MIMO processing is applied at DP level. Pairs of the Constellation Mapper outputs NUQ (e1,i and e2,i) are fed to the input of the MIMO Encoder. Paired MIMO Encoder output (g1,i and g2,i) is transmitted by the same carrier k and OFDM symbol l of their respective TX antennas.

The above-described blocks may be omitted or replaced by blocks having similar or identical functions.

FIG. 5 illustrates a BICM block according to another embodiment of the present invention.

The BICM block illustrated in FIG. 5 corresponds to an embodiment of the BICM block 1010 described with reference to FIG. 1.

FIG. 5 illustrates a BICM block for protection of physical layer signaling (PLS), emergency alert channel (EAC) and fast information channel (FIC). EAC is a part of a frame that carries EAS information data and FIC is a logical channel in a frame that carries the mapping information between a service and the corresponding base DP. Details of the EAC and FIC will be described later.

Referring to FIG. 5, the BICM block for protection of PLS, EAC and FIC can include a PLS FEC encoder 6000, a bit interleaver 6010 and a constellation mapper 6020.

Also, the PLS FEC encoder 6000 can include a scrambler, BCH encoding/zero insertion block, LDPC encoding block and LDPC parity punturing block. Description will be given of each block of the BICM block.

The PLS FEC encoder 6000 can encode the scrambled PLS 1/2 data, EAC and FIC section.

The scrambler can scramble PLS1 data and PLS2 data before BCH encoding and shortened and punctured LDPC encoding.

The BCH encoding/zero insertion block can perform outer encoding on the scrambled PLS 1/2 data using the shortened BCH code for PLS protection and insert zero bits after the BCH encoding. For PLS1 data only, the output bits of the zero insertion may be permutted before LDPC encoding.

The LDPC encoding block can encode the output of the BCH encoding/zero insertion block using LDPC code. To generate a complete coded block, C_{ldpc}, parity bits, P_{ldpc} are encoded systematically from each zero-inserted PLS information block, I_{ldpc} and appended after it.

C_{idpc}=[I_{ldpc}P_{ldpc}]=[i₀,i₁, . . . ,i_{K}_{_{ldpc}}₋₁,p₀,p₁, . . . ,p_{N}_{_{ldpc}}_{-K}_{_{ldpc}}₋₁] [Math Figure. 1]

The LDPC code parameters for PLS1 and PLS2 are as following table 4.

TABLE 4

| Signaling | | | | K_{ldpc} | | | code | |
|---|---|---|---|---|---|---|---|---|
| Type | K_{sig} | K_{bch} | N_{bch}_{_{—}}_{parity} | (=N_{bch}) | N_{ldpc} | N_{ldpc}_{_{—}}_{parity} | rate | Q_{ldpc} |
| PLS1 | 342 | 1020 | 60 | 1080 | 4320 | 3240 | 1/4 | 36 |
| PLS2 | <1021 | | | | | | | |
| | >1020 | 2100 | | 2160 | 7200 | 5040 | 3/10 | 56 |

The LDPC parity punturing block can perform puncturing on the PLSL data and PLS2 data.

When shortening is applied to the PLS1 data protection, some LDPC parity bits are punctured after LDPC encoding. Also, for the PLS2 data protection, the LDPC parity bits of PLS2 are punctured after LDPC encoding. These punctured bits are not transmitted.

The bit interleaver 6010 can interleave the each shortened and punctured PLS1 data and PLS2 data.

The constellation mapper 6020 can map the bit ineterlaeved PLS1 data and PLS2 data onto constellations.

The above-described blocks may be omitted or replaced by blocks having similar or identical functions.

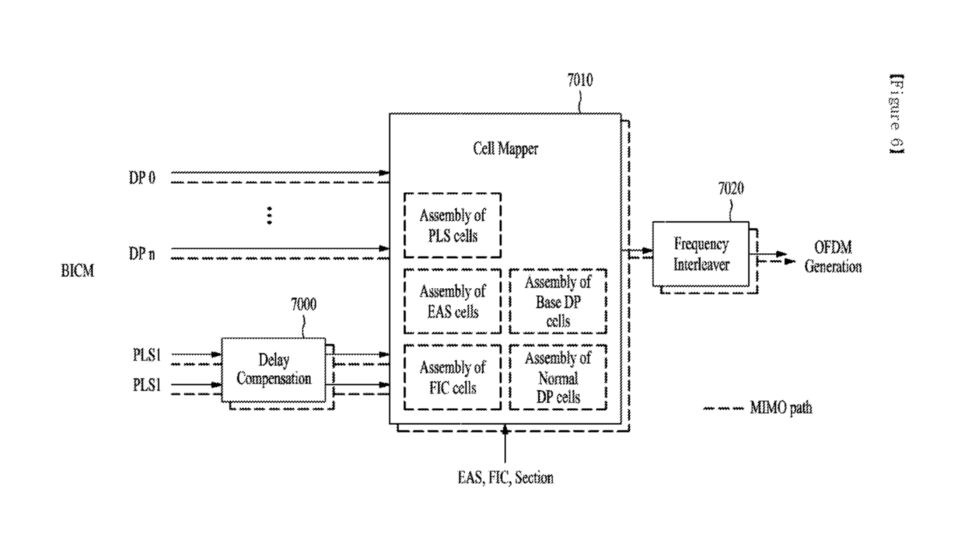

FIG. 6 illustrates a frame building block according to one embodiment of the present invention.

The frame building block illustrated in FIG. 6 corresponds to an embodiment of the Frame Building block 1020 described with reference to FIG. 1.

Referring to FIG. 6, the frame building block can include a delay compensation block 7000, a cell mapper 7010 and a frequency interleaver 7020. Description will be given of each block of the frame building block.

The delay compensation block 7000 can adjust the timing between the data pipes and the corresponding PLS data to ensure that they are co-timed at the transmitter end. The PLS data is delayed by the same amount as data pipes are by addressing the delays of data pipes caused by the Input Formatting block and BICM block. The delay of the BICM block is mainly due to the time interleaver. In-band signaling data carries information of the next TI group so that they are carried one frame ahead of the DPs to be signaled. The Delay Compensating block delays in-band signaling data accordingly.

The cell mapper 7010 can map PLS, EAC, FIC, DPs, auxiliary streams and dummy cells into the active carriers of the OFDM symbols in the frame. The basic function of the cell mapper 7010 is to map data cells produced by the TIs for each of the DPs, PLS cells, and EAC/FIC cells, if any, into arrays of active OFDM cells corresponding to each of the OFDM symbols within a frame. Service signaling data (such as PSI (program specific information)/SI) can be separately gathered and sent by a data pipe. The Cell Mapper operates according to the dynamic information produced by the scheduler and the configuration of the frame structure. Details of the frame will be described later.

The frequency interleaver 7020 can randomly interleave data cells received from the cell mapper 7010 to provide frequency diversity. Also, the frequency interleaver 7020 can operate on very OFDM symbol pair comprised of two sequential OFDM symbols using a different interleaving-seed order to get maximum interleaving gain in a single frame. Details of operations of the frequency interleaver 7020 will be described later.

The above-described blocks may be omitted or replaced by blocks having similar or identical functions.

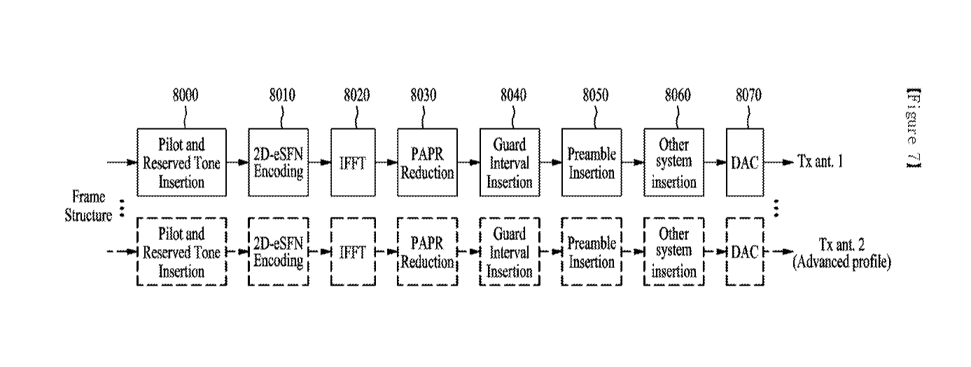

FIG. 7 illustrates an OFMD generation block according to an embodiment of the present invention.

The OFMD generation block illustrated in FIG. 7 corresponds to an embodiment of the OFMD generation block 1030 described with reference to FIG. 1.

The OFDM generation block modulates the OFDM carriers by the cells produced by the Frame Building block, inserts the pilots, and produces the time domain signal for transmission. Also, this block subsequently inserts guard intervals, and applies PAPR (Peak-to-Average Power Radio) reduction processing to produce the final RF signal.

Referring to FIG. 7, the frame building block can include a pilot and reserved tone insertion block 8000, a 2D-eSFN encoding block 8010, an IFFT (Inverse Fast Fourier Transform) block 8020, a PAPR reduction block 8030, a guard interval insertion block 8040, a preamble insertion block 8050, other system insertion block 8060 and a DAC block 8070. Description will be given of each block of the frame building block.

The other system insertion block 8060 can multiplex signals of a plurality of broadcast transmission/reception systems in the time domain such that data of two or more different broadcast transmission/reception systems providing broadcast services can be simultaneously transmitted in the same RF signal bandwidth. In this case, the two or more different broadcast transmission/reception systems refer to systems providing different broadcast services. The different broadcast services may refer to a terrestrial broadcast service, mobile broadcast service, etc.

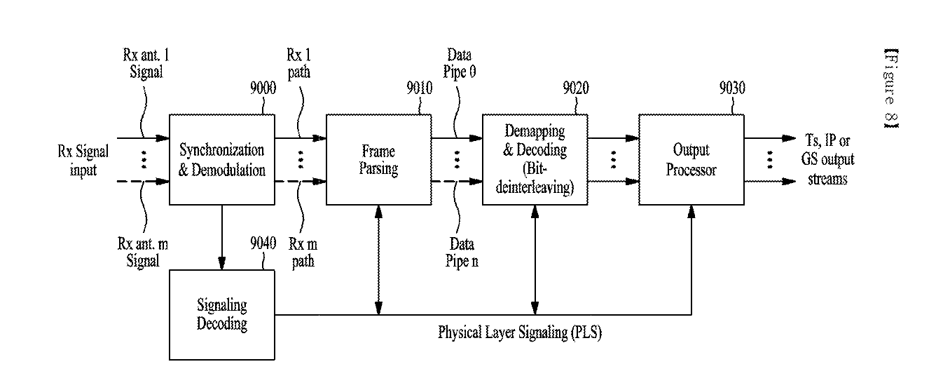

FIG. 8 illustrates a structure of an apparatus for receiving broadcast signals for future broadcast services according to an embodiment of the present invention.

The apparatus for receiving broadcast signals for future broadcast services according to an embodiment of the present invention can correspond to the apparatus for transmitting broadcast signals for future broadcast services, described with reference to FIG. 1.

The apparatus for receiving broadcast signals for future broadcast services according to an embodiment of the present invention can include a synchronization & demodulation module 9000, a frame parsing module 9010, a demapping & decoding module 9020, an output processor 9030 and a signaling decoding module 9040. A description will be given of operation of each module of the apparatus for receiving broadcast signals.

The synchronization & demodulation module 9000 can receive input signals through m Rx antennas, perform signal detection and synchronization with respect to a system corresponding to the apparatus for receiving broadcast signals and carry out demodulation corresponding to a reverse procedure of the procedure performed by the apparatus for transmitting broadcast signals.

The frame parsing module 9100 can parse input signal frames and extract data through which a service selected by a user is transmitted. If the apparatus for transmitting broadcast signals performs interleaving, the frame parsing module 9100 can carry out deinterleaving corresponding to a reverse procedure of interleaving. In this case, the positions of a signal and data that need to be extracted can be obtained by decoding data output from the signaling decoding module 9400 to restore scheduling information generated by the apparatus for transmitting broadcast signals.

The demapping & decoding module 9020 can convert the input signals into bit domain data and then deinterleave the same as necessary. The demapping & decoding module 9020 can perform demapping for mapping applied for transmission efficiency and correct an error generated on a transmission channel through decoding. In this case, the demapping & decoding module 9020 can obtain transmission parameters necessary for demapping and decoding by decoding the data output from the signaling decoding module 9040.

The output processor 9030 can perform reverse procedures of various compression/signal processing procedures which are applied by the apparatus for transmitting broadcast signals to improve transmission efficiency. In this case, the output processor 9030 can acquire necessary control information from data output from the signaling decoding module 9040. The output of the output processor 8300 corresponds to a signal input to the apparatus for transmitting broadcast signals and may be MPEG-TSs, IP streams (v4 or v6) and generic streams.

The signaling decoding module 9040 can obtain PLS information from the signal demodulated by the synchronization & demodulation module 9000. As described above, the frame parsing module 9010, demapping & decoding module 9020 and output processor 9030 can execute functions thereof using the data output from the signaling decoding module 9040.

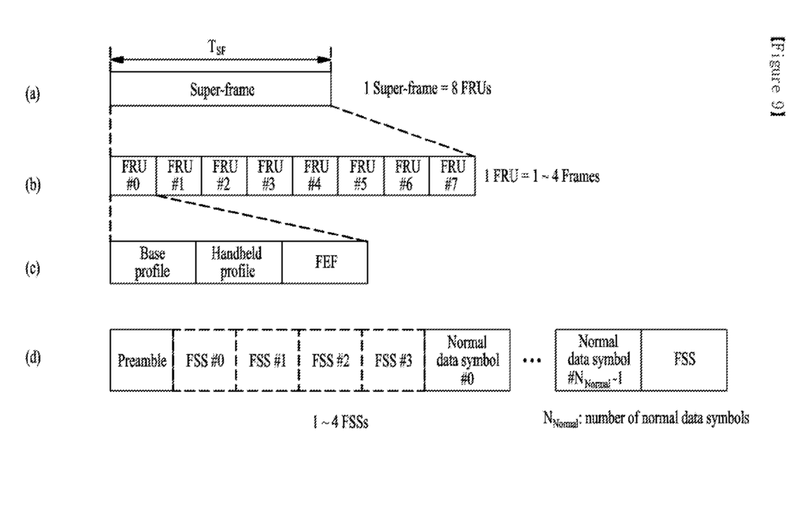

FIG. 9 illustrates a frame structure according to an embodiment of the present invention.

FIG. 9 shows an example configuration of the frame types and FRUs in a super-frame. (a) shows a super frame according to an embodiment of the present invention, (b) shows FRU (Frame Repetition Unit) according to an embodiment of the present invention, (c) shows frames of variable PHY profiles in the FRU and (d) shows a structure of a frame.

A super-frame may be composed of eight FRUs. The FRU is a basic multiplexing unit for TDM of the frames, and is repeated eight times in a super-frame.

Each frame in the FRU belongs to one of the PHY profiles, (base, handheld, advanced) or FEF. The maximum allowed number of the frames in the FRU is four and a given PHY profile can appear any number of times from zero times to four times in the FRU (e.g., base, base, handheld, advanced). PHY profile definitions can be extended using reserved values of the PHY_PROFILE in the preamble, if required.

The FEF part is inserted at the end of the FRU, if included. When the FEF is included in the FRU, the minimum number of FEFs is 8 in a super-frame. It is not recommended that FEF parts be adjacent to each other.

One frame is further divided into a number of OFDM symbols and a preamble. As shown in (d), the frame comprises a preamble, one or more frame signaling symbols (FSS), normal data symbols and a frame edge symbol (FES).

The preamble is a special symbol that enables fast Futurecast UTB system signal detection and provides a set of basic transmission parameters for efficient transmission and reception of the signal. The detailed description of the preamble will be will be described later.

The main purpose of the FSS(s) is to carry the PLS data. For fast synchronization and channel estimation, and hence fast decoding of PLS data, the FSS has more dense pilot pattern than the normal data symbol. The FES has exactly the same pilots as the FSS, which enables frequency-only interpolation within the FES and temporal interpolation, without extrapolation, for symbols immediately preceding the FES.

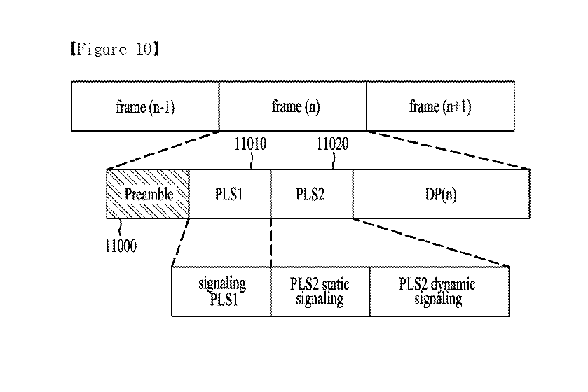

FIG. 10 illustrates a signaling hierarchy structure of the frame according to an embodiment of the present invention.

FIG. 10 illustrates the signaling hierarchy structure, which is split into three main parts: the preamble signaling data 11000, the PLS1 data 11010 and the PLS2 data 11020. The purpose of the preamble, which is carried by the preamble symbol in every frame, is to indicate the transmission type and basic transmission parameters of that frame. The PLS1 enables the receiver to access and decode the PLS2 data, which contains the parameters to access the DP of interest. The PLS2 is carried in every frame and split into two main parts: PLS2-STAT data and PLS2-DYN data. The static and dynamic portion of PLS2 data is followed by padding, if necessary.

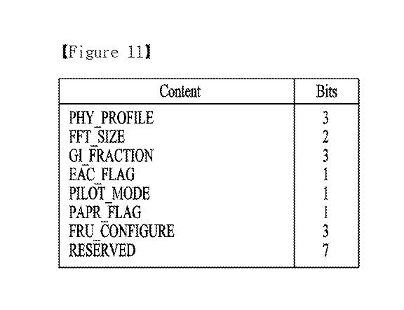

FIG. 11 illustrates preamble signaling data according to an embodiment of the present invention.

Preamble signaling data carries 21 bits of information that are needed to enable the receiver to access PLS data and trace DPs within the frame structure. Details of the preamble signaling data are as follows:

PHY_PROFILE: This 3-bit field indicates the PHY profile type of the current frame. The mapping of different PHY profile types is given in below table 5.

TABLE 5

| Value | PHY profile |
|---|---|
| 000 | Base profile |
| 001 | Handheld profile |
| 010 | Advanced profiled |
| 011~110 | Reserved |
| 111 | FEF |

FFT_SIZE: This 2 bit field indicates the FFT size of the current frame within a frame-group, as described in below table 6.

TABLE 6

| Value | FFT size |
|---|---|
| 00 | 8K FFT |
| 01 | 16K FFT |
| 10 | 32K FFT |
| 11 | Reserved |

GI_FRACTION: This 3 bit field indicates the guard interval fraction value in the current super-frame, as described in below table 7.

TABLE 7

| Value | GI_FRACTION |
|---|---|
| 000 | 1/5 |
| 001 | 1/10 |
| 010 | 1/20 |
| 011 | 1/40 |
| 100 | 1/80 |
| 101 | 1/160 |
| 110~111 | Reserved |

EAC_FLAG: This 1 bit field indicates whether the EAC is provided in the current frame. If this field is set to ‘1’, emergency alert service (EAS) is provided in the current frame. If this field set to ‘0’, EAS is not carried in the current frame. This field can be switched dynamically within a super-frame.

PILOT_MODE: This 1-bit field indicates whether the pilot mode is mobile mode or fixed mode for the current frame in the current frame-group. If this field is set to ‘0’, mobile pilot mode is used. If the field is set to ‘1’, the fixed pilot mode is used.

PAPR_FLAG: This 1-bit field indicates whether PAPR reduction is used for the current frame in the current frame-group. If this field is set to value ‘1’, tone reservation is used for PAPR reduction. If this field is set to ‘0’, PAPR reduction is not used.

FRU_CONFIGURE: This 3-bit field indicates the PHY profile type configurations of the frame repetition units (FRU) that are present in the current super-frame. All profile types conveyed in the current super-frame are identified in this field in all preambles in the current super-frame. The 3-bit field has a different definition for each profile, as show in below table 8.

TABLE 8

| | Current | Current | Current | Current |
|---|---|---|---|---|
| | PHY_PRO- | PHY_PRO- | PHY_PRO- | PHY_PRO- |
| | FILE = | FILE = | FILE = | FILE = |
| | ‘000’ | ‘001’ | ‘010’ | ‘111’ |
| | (base) | (handheld) | (advanced) | (FEF) |
| FRU_CON- | Only | Only | Only | Only |
| FIGURE = | base | handheld | advanced | FEF |
| 000 | profile | profile | profile | present |
| | present | present | present | |
| FRU_CON- | Handheld | Base | Base | Base |
| FIGURE = | profile | profile | profile | profile |
| 1XX | present | present | present | present |
| FRU_CON- | Advanced | Advanced | Handheld | Handheld |
| FIGURE = | profile | profile | profile | profile |
| X1X | present | present | present | present |
| FRU_CON- | FEF | FEF | FEF | Advanced |
| FIGURE = | present | present | present | profile |
| XX1 | | | | present |

RESERVED: This 7-bit field is reserved for future use.

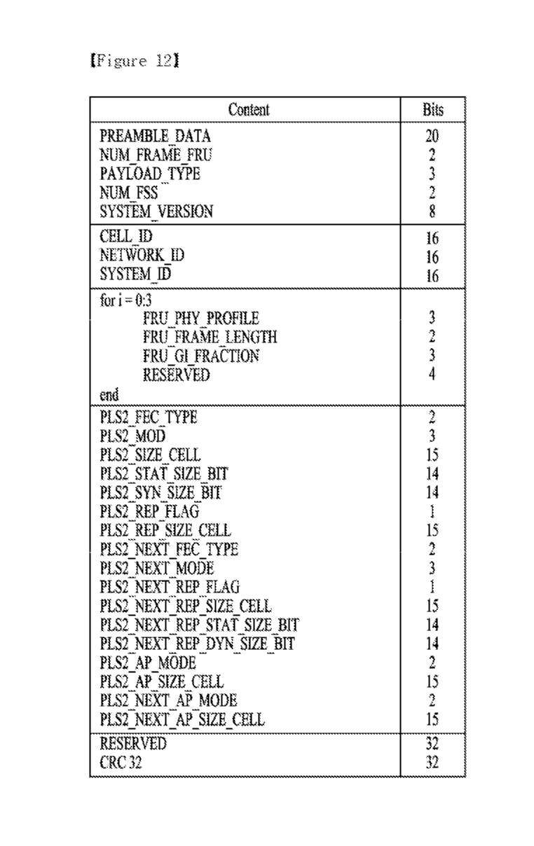

FIG. 12 illustrates PLS1 data according to an embodiment of the present invention.

PLS1 data provides basic transmission parameters including parameters required to enable the reception and decoding of the PLS2. As above mentioned; the PLS1 data remain unchanged for the entire duration of one frame-group. The detailed definition of the signaling fields of the PLS1 data are as follows:

PREAMBLE_DATA: This 20-bit field is a copy of the preamble signaling data excluding the EAC_FLAG.

NUM_FRAME_FRU: This 2-bit field indicates the number of the frames per FRU.

PAYLOAD_TYPE: This 3-bit field indicates the format of the payload data carried in the frame-group. PAYLOAD_TYPE is signaled as shown in table 9.

TABLE 9

| value | Payload type |
|---|---|
| 1XX | TS stream is transmitted |
| X1X | IP stream is transmitted |
| XX1 | GS stream is transmitted |

NUM_FSS: This 2-bit field indicates the number of FSS symbols in the current frame.

SYSTEM_VERSION: This 8-bit field indicates the version of the transmitted signal format. The SYSTEM_VERSION is divided into two 4-bit fields, which are a major version and a minor version.

Major version: The MSB four bits of SYSTEM_VERSION field indicate major version information. A change in the major version field indicates a non-backward-compatible change. The default value is ‘0000’. For the version described in this standard, the value is set to ‘0000’.

Minor version: The LSB four bits of SYSTEM_VERSION field indicate minor version information. A change in the minor version field is backward-compatible.

CELL_ID: This is a 16-bit field which uniquely identifies a geographic cell in an ATSC network. An ATSC cell coverage area may consist of one or more frequencies, depending on the number of frequencies used per Futurecast UTB system. If the value of the CELL_ID is not known or unspecified, this field is set to ‘0’.

NETWORK_ID: This is a 16-bit field which uniquely identifies the current ATSC network.

SYSTEM_ID: This 16-bit field uniquely identifies the Futurecast UTB system within the ATSC network. The Futurecast UTB system is the terrestrial broadcast system whose input is one or more input streams (TS, IP, GS) and whose output is an RF signal. The Futurecast UTB system carries one or more PHY profiles and FEF, if any. The same Futurecast UTB system may carry different input streams and use different RF frequencies in different geographical areas, allowing local service insertion. The frame structure and scheduling is controlled in one place and is identical for all transmissions within a Futurecast UTB system. One or more Futurecast UTB systems may have the same SYSTEM_ID meaning that they all have the same physical layer structure and configuration.

The following loop consists of FRU_PHY_PROFILE, FRU_FRAME_LENGTH, FRU_GI_FRACTION, and RESERVED which are used to indicate the FRU configuration and the length of each frame type. The loop size is fixed so that four PHY profiles (including a FEF) are signaled within the FRU. If NUM_FRAME_FRU is less than 4, the unused fields are filled with zeros.

FRU_PHY_PROFILE: This 3-bit field indicates the PHY profile type of the (i+1)th (i is the loop index) frame of the associated FRU. This field uses the same signaling format as shown in the table 8.

FRU_FRAME_LENGTH: This 2-bit field indicates the length of the (i+1)th frame of the associated FRU. Using FRU_FRAME_LENGTH together with FRU_GI_FRACTION, the exact value of the frame duration can be obtained.

FRU_GI_FRACTION: This 3-bit-field indicates the guard interval fraction value of the (i+1)th frame of the associated FRU. FRU_GI_FRACTION is signaled according to the table 7.

RESERVED: This 4-bit field is reserved for future use.

The following fields provide parameters for decoding the PLS2 data.

PLS2_FEC_TYPE: This 2-bit field indicates the FEC type used by the PLS2 protection. The FEC type is signaled according to table 10. The details of the LDPC codes will be described later.

TABLE 10

| Content | PLS2 FEC type |
|---|---|
| 00 | 4K-1/4 and 7K-3/10 LDPC codes |
| 01~11 | Reserved |

PLS2_MOD: This 3-bit field indicates the modulation type used by the PLS2. The modulation type is signaled according to table 11.

TABLE 11

| Value | PLS2_MODE |
|---|---|
| 000 | BPSK |
| 001 | QPSK |
| 010 | QAM-16 |
| 011 | NUQ-64 |
| 100~111 | Reserved |

PLS2_SIZE_CELL: This 15-bit field indicates Cₜₒₜₐₗ_{_}ₚₐᵣₜᵢₐₗ_{_}_{block}, the size (specified as the number of QAM cells) of the collection of full coded blocks for PLS2 that is carried in the current frame-group. This value is constant during the entire duration of the current frame-group.

PLS2_STAT_SIZE_BIT: This 14-bit field indicates the size, in bits, of the PLS2-STAT for the current frame-group. This value is constant during the entire duration of the current frame-group.

PLS2_DYN_SIZE_BIT: This 14-bit field indicates the size, in bits, of the PLS2-DYN for the current frame-group.

This value is constant during the entire duration of the current frame-group.

PLS2_REP_FLAG: This 1-bit flag indicates whether the PLS2 repetition mode is used in the current frame-group. When this field is set to value. ‘1’, the PLS2 repetition mode is activated. When this field is set to value ‘0’, the PLS2 repetition mode is deactivated.

PLS2_REP_SIZE_CELL: This 15-bit field indicates Cₜₒₜₐₗ_{_}ₚₐᵣₜᵢₐₗ_{_}_{block}, the size (specified as the number of QAM cells) of the collection of partial coded blocks for PLS2 carried in every frame of the current frame-group, when PLS2 repetition is used. If repetition is not used, the value of this field is equal to 0. This value is constant during the entire duration of the current frame-group.

PLS2_NEXT_FEC_TYPE: This 2-bit field indicates the FEC type used for PLS2 that is carried in every frame of the next frame-group. The FEC type is signaled according to the table 10.

PLS2_NEXT_MOD: This 3-bit field indicates the modulation type used for PLS2 that is carried in every frame of the next frame-group. The modulation type is signaled according to the table 11.

PLS2 NEXT_REP_FLAG: This 1-bit flag indicates whether the PLS2 repetition mode is used in the next frame-group. When this field is set to value ‘1’, the PLS2 repetition mode is activated. When this field is set to value ‘0’, the PLS2 repetition mode is deactivated.

PLS2_NEXT_REP_SIZE_CELL: This 15-bit field indicates Cₜₒₜₐₗ_{_}_{full}_{_}_{block}, The size (specified as the number of QAM cells) of the collection of full coded blocks for PLS2 that is carried in every frame of the next frame-group, when PLS2 repetition is used. If repetition is not used in the next frame-group, the value of this field is equal to 0. This value is constant during the entire duration of the current frame-group.

PLS2_NEXT_REP_STAT_SIZE_BIT: This 14-bit field indicates the size, in bits, of the PLS2-STAT for the next frame-group. This value is constant in the current frame-group.

PLS2_NEXT_REP_DYN_SIZE_BIT: This 14-bit field indicates the size, in bits, of the PLS2-DYN for the next frame-group. This value is constant in the current frame-group.

PLS2_AP_MODE: This 2-bit field indicates whether additional parity is provided for PLS2 in the current frame-group. This value is constant during the entire duration of the current frame-group. The below table 12 gives the values of this field. When this field is set to ‘00’, additional parity is not used for the PLS2 in the current frame-group.

TABLE 12

| Value | PLS2-AP mode |
|---|---|
| 00 | AP is not provided |
| 01 | AP1 mode |
| 10~11 | Reserved |

PLS2_AP_SIZE_CELL: This 15-bit field indicates the size (specified as the number of QAM cells) of the additional parity bits of the PLS2. This value is constant during the entire duration of the current frame-group.

PLS2_NEXT_AP_MODE: This 2-bit field indicates whether additional parity is provided for PLS2 signaling in every frame of next frame-group. This value is constant during the entire duration of the current frame-group. The table 12 defines the values of this field

PLS2_NEXT_AP_SIZE_CELL: This 15-bit field indicates the size (specified as the number of QAM cells) of the additional parity bits of the PLS2 in every frame of the next frame-group. This value is constant during the entire duration of the current frame-group.

RESERVED: This 32-bit field is reserved for future use.

CRC_32: A 32-bit error detection code, which is applied to the entire PLS1 signaling.

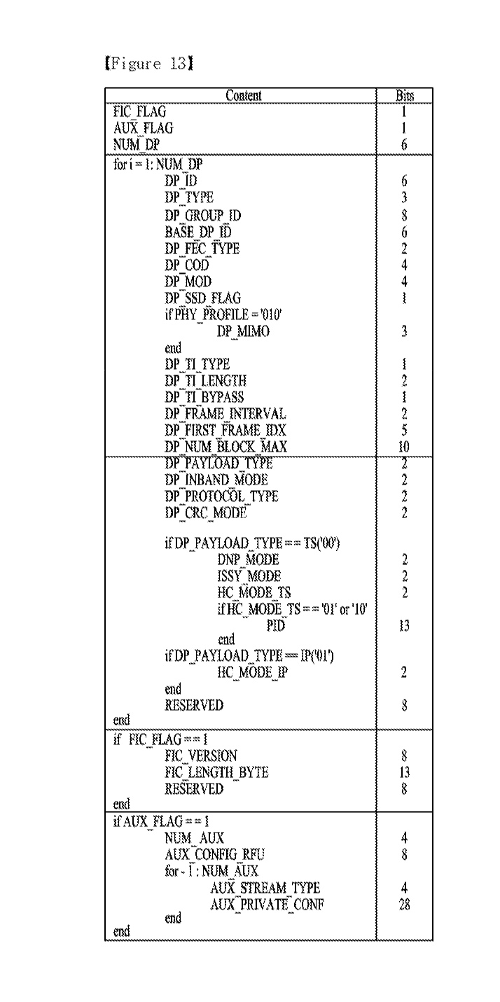

FIG. 13 illustrates PLS2 data according to an embodiment of the present invention.

FIG. 13 illustrates PLS2-STAT data of the PLS2 data. The PLS2-STAT data are the same within a frame-group, while the PLS2-DYN data provide information that is specific for the current frame.

The details of fields of the PLS2-STAT data are as follows:

FIC_FLAG: This 1-bit field indicates whether the FIC is used in the current frame-group. If this field is set to ‘1’, the FIC is provided in the current frame. If this field set to ‘0’, the FIC is not carried in the current frame. This value is constant during the entire duration of the current frame-group.

AUX_FLAG: This 1-bit field indicates whether the auxiliary, stream(s) is used in the current frame-group. If this field is set to ‘1’, the auxiliary stream is provided in the current frame. If this field set to ‘0’, the auxiliary stream is not carried in the current frame. This value is constant during the entire duration of current frame-group.

NUM_DP: This 6-bit field indicates the number of DPs carried within the current frame. The value of this field ranges from 1 to 64, and the number of DPs is NUM_DP+1.

DP_ID: This 6-bit field identifies uniquely a DP within a PHY profile.

DP_TYPE: This 3-bit field indicates the type of the DP. This is signaled according to the below table 13.

TABLE 13

| Value | DP Type |
|---|---|
| 000 | DP Type 1 |
| 001 | DP Type 2 |
| 010~111 | reserved |

DP_GROUP_ID: This 8-bit field identifies the DP group with which the current DP is associated. This can be used by a receiver to access the DPs of the service components associated with a particular service, which will have the same DP_GROUP_ID.

BASE_DP_ID: This 6-bit field indicates the DP carrying service signaling data (such as PSI/SI) used in the Management layer. The DP indicated by BASE_DP_ID may be either a normal DP carrying the service signaling data along with the service data or a dedicated DP carrying only the service signaling data

DP_FEC_TYPE: This 2-bit field indicates the FEC type used by the associated DP. The FEC type is signaled according to the below table 14.

TABLE 14

| Value | FEC_TYPE |
|---|---|
| 00 | 16K LDPC |
| 01 | 64K LDPC |
| 10~11 | Reserved |

DP_COD: This 4-bit field indicates the code rate used by the associated DP. The code rate is signaled according to the below table 15.

TABLE 15

| Value | Code rate |
|---|---|
| 0000 | 5/15 |
| 0001 | 6/15 |
| 0010 | 7/15 |
| 0011 | 8/15 |
| 0100 | 9/15 |
| 0101 | 10/15 |
| 0110 | 11/15 |
| 0111 | 12/15 |
| 1000 | 13/15 |
| 1001~1111 | Reserved |

DP_MOD: This 4-bit field indicates the modulation used by the associated DP. The modulation is signaled according to the below table 16.

TABLE 16

| Value | Modulation |
|---|---|
| 0000 | QPSK |
| 0001 | QAM-16 |
| 0010 | NUQ-64 |
| 0011 | NUQ-256 |
| 0100 | NUQ-1024 |
| 0101 | NUC-16 |
| 0110 | NUC-64 |
| 0111 | NUC-256 |
| 1000 | NUC-1024 |
| 1001~1111 | reserved |

DP_SSD_FLAG: This 1-bit field indicates whether the SSD mode is used in the associated DP. If this field is set to value ‘1’, SSD is used. If this field is set to value ‘0’, SSD is not used.

The following field appears only if PHY_PROFILE is equal to ‘010’, which indicates the advanced profile:

DP_MIMO: This 3-bit field indicates which type of MIMO encoding process is applied to the associated DP. The type of MIMO encoding process is signaled according to the table 17.

TABLE 17

| Value | MIMO encoding |
|---|---|
| 000 | FR-SM |
| 001 | FRFD-SM |
| 010~111 | reserved |

DP_TI_TYPE: This 1-bit field indicates the type of time-interleaving. A value of ‘0’ indicates that one TI group corresponds to one frame and contains one or more TI-blocks. A value of ‘1’ indicates that one TI group is carried in more than one frame and contains only one TI-block.

DP_TI_LENGTH: The use of this 2-bit field (the allowed values are only 1, 2, 4, 8) is determined by the values set within the DP_TI_TYPE field as follows:

If the DP_TI_TYPE is set to the value ‘1’, this field indicates PI, the number of the frames to which each TI group is mapped, and there is one TI-block per TI group (NTI=1). The allowed PI values with 2-bit field are defined in the below table 18.

If the DP_TI_TYPE is set to the value ‘0’, this field indicates the number of TI-blocks NTI per TI group, and there is one TI group per frame (PI=1). The allowed PI values with 2-bit field are defined in the below table 18.

TABLE 18

| 2-bit field | P_{I} | N_{TI} |
|---|---|---|
| 00 | 1 | 1 |
| 01 | 2 | 2 |
| 10 | 4 | 3 |
| 11 | 8 | 4 |

DP_FRAME_INTERVAL: This 2-bit field indicates the frame interval (I_{JUMP}) within the frame-group for the associated DP and the allowed values are 1, 2, 4, 8 (the corresponding 2-bit field is ‘00’, ‘01’, ‘10’, or ‘11’, respectively). For DPs that do not appear every frame of the frame-group, the value of this field is equal to the interval between successive frames. For example, if a DP appears on the frames 1, 5, 9, 13, etc., this field is set to ‘4’. For DPs that appear in every frame, this field is set to ‘1’.

DP_TI_BYPASS: This 1-bit field determines the availability of time interleaver. If time interleaving is not used for a DP, it is set to ‘1’. Whereas if time interleaving is used it is set to ‘0’.

DP_FIRST_FRAME_IDX: This 5-bit field indicates the index of the first frame of the super-frame in which the current DP occurs. The value of DP_FIRST_FRAME_IDX ranges from 0 to 31

DP_NUM_BLOCK_MAX: This 10-bit field indicates the maximum value of DP_NUM_BLOCKS for this DP. The value of this field has the same range as DP_NUM_BLOCKS.

DP_PAYLOAD_TYPE: This 2-bit field indicates the type of the payload data carried by the given DP. DP_PAYLOAD_TYPE is signaled according to the below table 19.

TABLE 19

| Value | Payload Type |
|---|---|
| 00 | TS. |
| 01 | IP |
| 10 | GS |
| 11 | reserved |

DP_INBAND_MODE: This 2-bit field indicates whether the current DP carries in-band signaling information. The in-band signaling type is signaled according to the below table 20.

TABLE 20

| Value | In-band mode |
|---|---|
| 00 | In-band signaling is not carried. |
| 01 | INBAND-PLS is carried only |
| 10 | INBAND-ISSY is carried only |
| 11 | INBAND-PLS and INBAN-ISSY are carried |

DP_PROTOCOL_TYPE: This 2-bit field indicates the protocol type of the payload carried by the given DP. It is signaled according to the below table 21 when input payload types are selected.

TABLE 21

| | If DP_PAYLOAD_TYPE | If DP_PAYLOAD_TYPE | If DP_PAYLOAD_TYPE |
|---|---|---|---|
| Value | Is TS | Is IP | Is GS |
| 00 | MPEG2-TS | IPv4 | (Note) |
| 01 | Reserved | IPv6 | Reserved |
| 10 | Reserved | Reserved | Reserved |
| 11 | Reserved | Reserved | Reserved |

DP_CRC_MODE: This 2-bit field indicates whether CRC encoding is used in the Input Formatting block. The CRC mode is signaled according to the below table 22.

TABLE 22

| Value | CRC mode |
|---|---|
| 00 | Not used |
| 01 | CRC-8 |
| 10 | CRC-16 |
| 11 | CRC-32 |

DNP_MODE: This 2-bit field indicates the null-packet deletion mode used by the associated DP when DP_PAYLOAD_TYPE is set to TS (‘00’). DNP_MODE is signaled according to the below table 23. If DP_PAYLOAD_TYPE is not TS (‘00’), DNP_MODE is set to the value ‘00’.

TABLE 23

| Value | Null-packet deletion mode |
|---|---|
| 00 | Not used |
| 01 | DNP-NORMAL |
| 10 | DNP-OFFSET |
| 11 | reserved |

ISSY_MODE: This 2-bit field indicates the ISSY mode used by the associated DP when DP_PAYLOAD_TYPE is set to TS (‘00’). The ISSY_MODE is signaled according to the below table 24 If DP_PAYLOAD_TYPE is not TS (‘00’), ISSY_MODE is set to the value ‘00’.

TABLE 24

| Value | ISSY mode |
|---|---|
| 00 | Not used |
| 01 | ISSY-UP |
| 10 | ISSY-BBF |
| 11 | reserved |

HC_MODE_TS: This 2-bit field indicates the TS header compression mode used by the associated DP when DP_PAYLOAD_TYPE is set to TS (‘00’). The HC_MODE_TS is signaled according to the below table 25.

TABLE 25

| Value | Header compression mode |
|---|---|
| 00 | HC_MODE_TS 1 |
| 01 | HC_MODE_TS 2 |
| 10 | HC_MODE_TS 3 |
| 11 | HC_MODE_TS 4 |

TABLE 26

| Value | Header compression mode |
|---|---|
| 00 | No compression |
| 01 | HC_MODE_IP 1 |
| 10-11 | reserved |

PID: This 13-bit field indicates the PID number for TS header compression when DP_PAYLOAD_TYPE is set to TS (‘00’) and HC_MODE_TS is set to ‘01’ or ‘10’.

RESERVED: This 8-bit field is reserved for future use.

The following field appears only if FIC_FLAG is equal to ‘1’:

FIC_VERSION: This 8-bit field indicates the version number of the FIC.

FIC_LENGTH_BYTE: This 13-bit field indicates the length, in bytes, of the FIC.

RESERVED: This 8-bit field is reserved for future use.

The following field appears only if AUX_FLAG is equal to ‘1’:

NUM_AUX: This 4-bit field indicates the number of auxiliary streams. Zero means no auxiliary streams are used.

AUX_CONFIG_RFU: This 8-bit field is reserved for future use.

AUX_STREAM_TYPE: This 4-bit is reserved for future use for indicating the type of the current auxiliary stream.

AUX_PRIVATE_CONFIG: This 28-bit field is reserved for future use for signaling auxiliary streams.

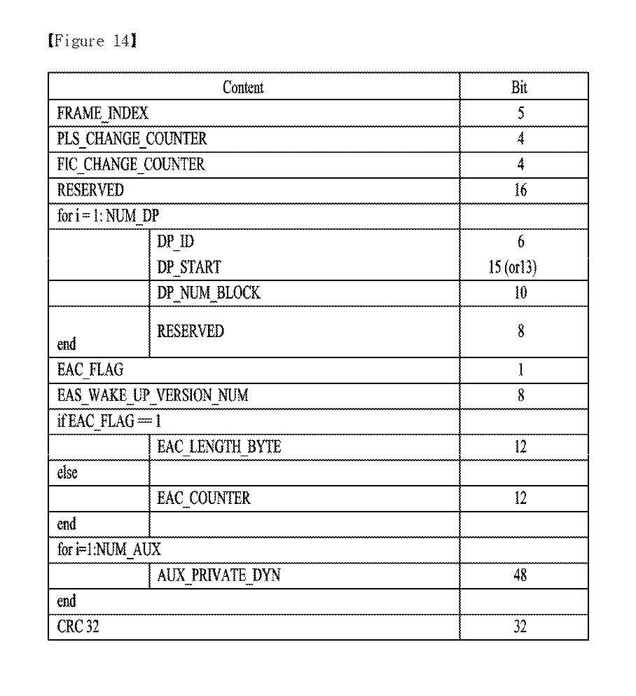

FIG. 14 illustrates PLS2 data according to another embodiment of the present invention.

FIG. 14 illustrates PLS2-DYN data of the PLS2 data. The values of the PLS2-DYN data may change during the duration of one frame-group, while the size of fields remains constant.

The details of fields of the PLS2-DYN data are as follows:

FRAME_INDEX: This 5-bit field indicates the frame index of the current frame within the super-frame. The index of the first frame of the super-frame is set to ‘0’.

PLS_CHANGE_COUNTER: This 4-bit field indicates the number of super-frames ahead where the configuration will change. The next super-frame with changes in the configuration is indicated by the value signaled within this field. If this field is set to the value ‘0000’, it means that no scheduled change is foreseen: e.g., value ‘1’ indicates that there is a change in the next super-frame.

FIC_CHANGE_COUNTER: This 4-bit field indicates the number of super-frames ahead where the configuration (i.e., the contents of the FIC) will change. The next super-frame with changes in the configuration is indicated by the value signaled within this field. If this field is set to the value ‘0000’, it means that no scheduled change is foreseen: e.g. value ‘0001’ indicates that there is a change in the next super-frame.

RESERVED: This 16-bit field is reserved for future use.

The following fields appear in the loop over NUM_DP, which describe the parameters associated with the DP carried in the current frame.

DP_ID: This 6-bit field indicates uniquely the DP within a PHY profile.

DP_START: This 15-bit (or 13-bit) field indicates the start position of the first of the DPs using the DPU addressing scheme. The DP_START field has differing length according to the PHY profile and FFT size as shown in the below table 27.

TABLE 27

DP_START field size

| PHY profile | 64K | 16K |
|---|---|---|
| Base | 13 bit | 15 bit |
| Handheld | — | 13 bit |
| Advanced | 13 bit | 15 bit |

DP_NUM_BLOCK: This 10-bit field indicates the number of FEC blocks in the current TI group for the current DP. The value of DP_NUM_BLOCK ranges from 0 to 1023

RESERVED: This 8-bit field is reserved for future use.

The following fields indicate the FIC parameters associated with the EAC.

EAC_FLAG: This 1-bit field indicates the existence of the EAC in the current frame. This bit is the same value as the EAC_FLAG in the preamble.

EAS_WAKE_UP_VERSION_NUM: This 8-bit field indicates the version number of a wake-up indication.

If the EAC_FLAG field is equal to ‘1’, the following 12 bits are allocated for EAC_LENGTH_BYTE field. If the EAC_FLAG field is equal to ‘0’, the following 12 bits are allocated for EAC_COUNTER.

EAC_LENGTH_BYTE: This 12-bit field indicates the length, in byte, of the EAC.

EAC_COUNTER: This 12-bit field indicates the number of the frames before the frame where the EAC arrives.

The following field appears only if the AUX_FLAG field is equal to ‘1’:

AUX_PRIVATE_DYN: This 48-bit field is reserved for future use for signaling auxiliary streams. The meaning of this field depends on the value of AUX_STREAM_TYPE in the configurable PLS2-STAT.

CRC_32: A 32-bit error detection code, which is applied to the entire PLS2.

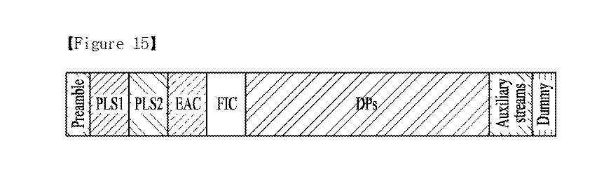

FIG. 15 illustrates a logical structure of a frame according to an embodiment of the present invention.

As above mentioned, the PLS, EAC, FIC, DPs, auxiliary streams and dummy cells are mapped into the active carriers of the OFDM symbols in the frame. The PLS1 and PLS2 are first mapped into one or more FSS(s). After that, EAC cells, if any, are mapped immediately following the PLS field, followed next by FIC cells, if any. The DPs are mapped next after the PLS or EAC, FIC, if any. Type 1 DPs follows first, and Type 2 DPs next. The details of a type of the DP will be described later. In some case, DPs may carry some special data for EAS or service signaling data. The auxiliary stream or streams, if any, follow the DPs, which in turn are followed by dummy cells. Mapping them all together in the above mentioned order, i.e. PLS, EAC, FIC, DPs, auxiliary streams and dummy data cells exactly fill the cell capacity in the frame.

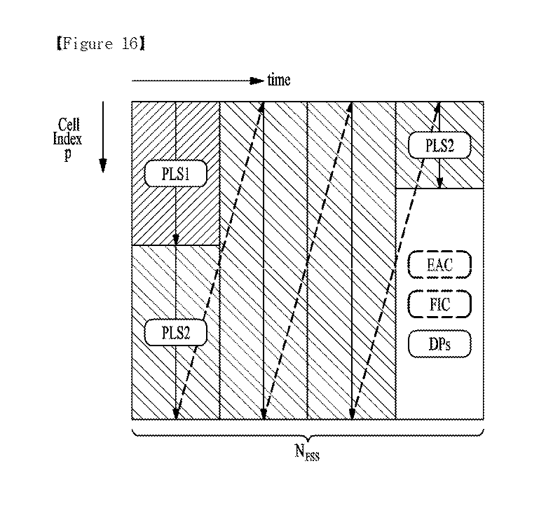

FIG. 16 illustrates PLS mapping according to an embodiment of the present invention.

PLS cells are mapped to the active carriers of FSS(s). Depending on the number of cells occupied by PLS, one or more symbols are designated as FSS(s), and the number of FSS(s) NFSS is signaled by NUM_FSS in PLS1. The FSS is a special symbol for carrying PLS cells. Since robustness and latency are critical issues in the PLS, the FSS(s) has higher density of pilots allowing fast synchronization and frequency-only interpolation within the FSS.

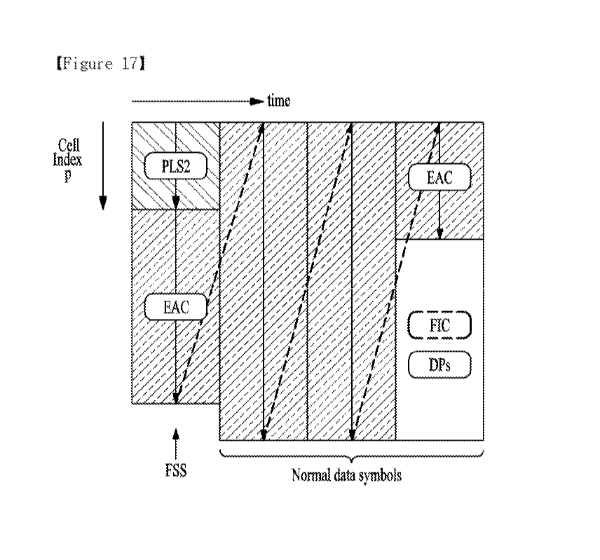

PLS cells are mapped to active carriers of the NFSS FSS(s) in a top-down manner as shown in an example in FIG. 17. The PLS1 cells are mapped first from the first cell of the first FSS in an increasing order of the cell index. The PLS2 cells follow immediately after the last cell of the PLS1 and mapping continues downward until the last cell index of the first FSS. If the total number of required PLS cells exceeds the number of active carriers of one FSS, mapping proceeds to the next FSS and continues in exactly the same manner as the first FSS.

After PLS mapping is completed, DPs are carried next. If EAC, FIC or both are present in the current frame, they are placed between PLS and “normal” DPs.

FIG. 17 illustrates EAC mapping according to an embodiment of the present invention.

EAC is a dedicated channel for carrying EAS messages and links to the DPs for EAS. EAS support is provided but EAC itself may or may not be present in every frame. EAC, if any, is mapped immediately after the PLS2_cells. EAC is not preceded by any of the FIC, DPs, auxiliary streams or dummy cells other than the PLS cells. The procedure of mapping the EAC cells is exactly the same as that of the PLS.

The EAC cells are mapped from the next cell of the PLS2 in increasing order of the cell index as shown in the example in FIG. 17. Depending on the EAS message size, EAC cells may occupy a few symbols, as shown in FIG. 17.

EAC cells follow immediately after the last cell of the PLS2, and mapping continues downward until the last cell index of the last FSS. If the total number of required EAC cells exceeds the number of remaining active carriers of the last FSS mapping proceeds to the next symbol and continues in exactly the same manner as FSS(s). The next symbol for mapping in this case is the normal data symbol, which has more active carriers than a FSS.

After EAC mapping is completed, the FIC is carried next, if any exists. If FIC is not transmitted (as signaled in the PLS2 field), DPs follow immediately after the last cell of the EAC.

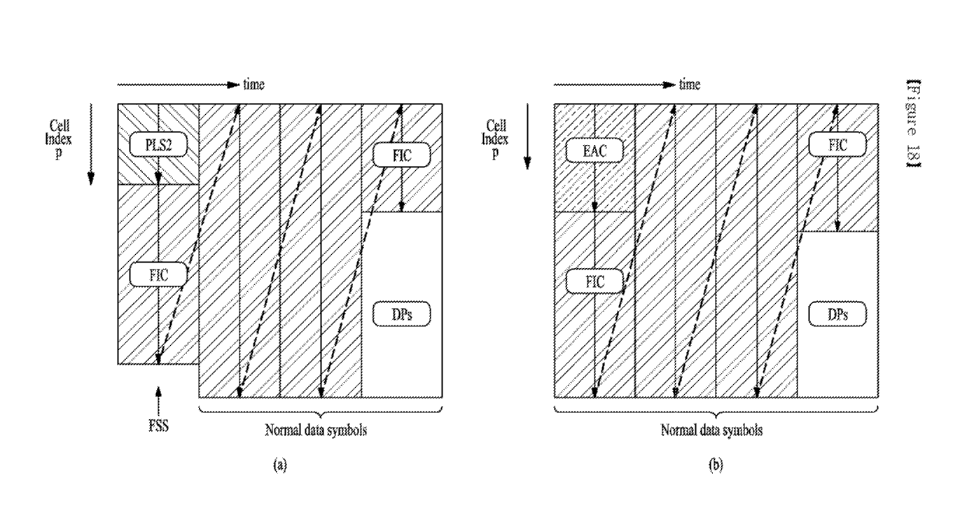

FIG. 18 illustrates FIC mapping according to an embodiment of the present invention.

(a) shows an example mapping of FIC cell without EAC and (b) shows an example mapping of FIC cell with EAC.

FIC is a dedicated channel for carrying cross-layer information to enable fast service acquisition and channel scanning. This information primarily includes channel binding information between DPs and the services of each broadcaster. For fast scan, a receiver can decode FIC and obtain information such as broadcaster ID, number of services, and BASE_DP_ID. For fast service acquisition, in addition to FIC, base DP can be decoded using BASE_DP_ID. Other than the content it carries, a base DP is encoded and mapped to a frame in exactly the same way as a normal DP. Therefore, no additional description is required for a base DP. The FIC data is generated and consumed in the Management Layer. The content of FIC data is as described in the Management Layer specification.

The FIC data is optional and the use of FIC is signaled by the FIC_FLAG parameter in the static part of the PLS2. If FIC is used, FIC_FLAG is set to ‘1’ and the signaling field for FIC is defined in the static part of PLS2. Signaled in this field are FIC_VERSION, and FIC_LENGTH_BYTE. FIC uses the same modulation, coding and time interleaving parameters as PLS2. FIC shares the same signaling parameters such as PLS2_MOD and PLS2_FEC. FIC data, if any, is mapped immediately after PLS2 or EAC if any. FIC is not preceded by any normal DPs, auxiliary streams or dummy cells. The method of mapping FIC cells is exactly the same as that of EAC which is again the same as PLS.

Without EAC after PLS, FIC cells are mapped from the next cell of the PLS2 in an increasing order of the cell index as shown in an example in (a). Depending on the FIC data size, FIC cells may be mapped over a few symbols, as shown in (b).

FIC cells follow immediately after the last cell of the PLS2, and mapping continues downward until the last cell index of the last FSS. If the total number of required FIC cells exceeds the number of remaining active carriers of the last FSS, mapping proceeds to the next symbol and continues in exactly the same manner as FSS(s). The next symbol for mapping in this case is the normal data symbol which has more active carriers than a FSS.

If EAS messages are transmitted in the current frame, EAC precedes FIC, and FIC cells are mapped from the next cell of the EAC in an increasing order of the cell index as shown in (b).

After FIC mapping is completed, one or more DPs are mapped, followed by auxiliary streams, if any, and dummy cells.

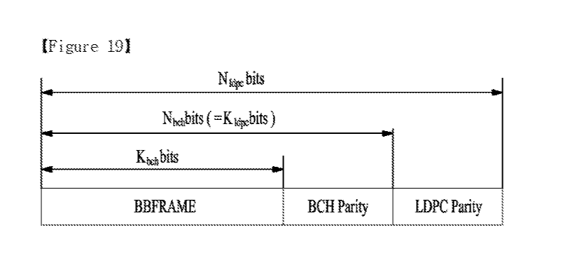

FIG. 19 illustrates an FEC structure according to an embodiment of the present invention.

FIG. 19 illustrates an FEC structure according to an embodiment of the present invention before bit interleaving. As above mentioned, Data FEC encoder may perform the FEC encoding on the input BBF to generate FECBLOCK procedure using outer coding (BCH), and inner coding (LDPC). The illustrated FEC structure corresponds to the FECBLOCK. Also, the FECBLOCK and the FEC structure have same value corresponding to a length of LDPC codeword.

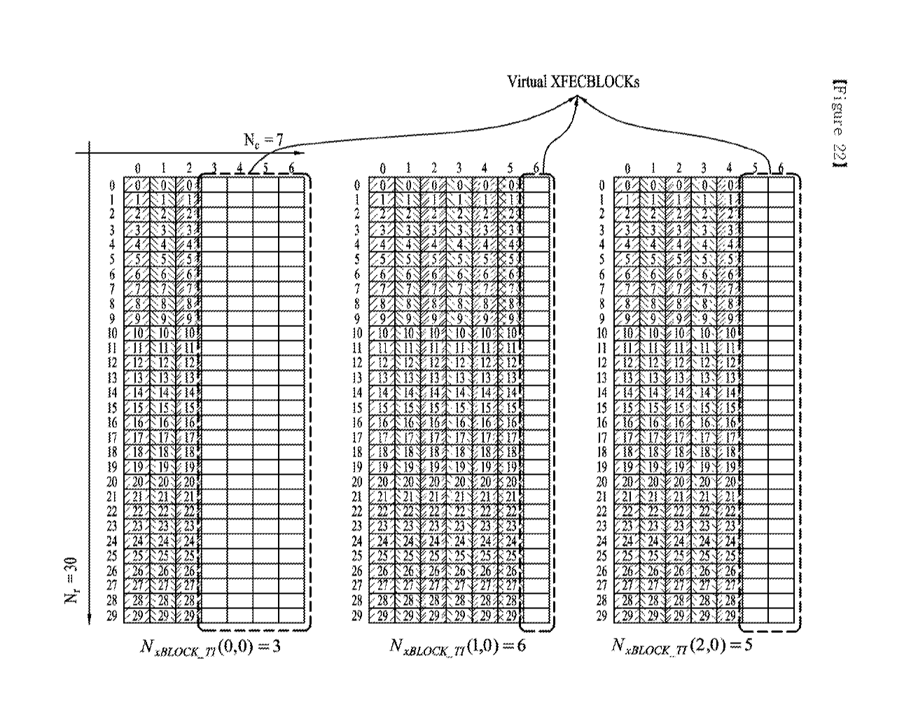

The BCH encoding is applied to each BBF (K_{bch} bits), and then LDPC encoding is applied to BCH-encoded BBF (K_{ldpc} bits=N_{bch} bits) as illustrated in FIG. 22.

The value of N_{ldpc} is either 64800 bits (long FECBLOCK) or 16200 bits (short FECBLOCK).

The below table 28 and table 29 show FEC encoding parameters for a long FECBLOCK and a short FECBLOCK, respectively.

TABLE 28

| | | | | BCH error | |
|---|---|---|---|---|---|
| | | | | correction | |
| LDPC Rate | N_{ldpc} | K_{ldpc} | K_{bch} | capability | N_{bch} − K_{bch} |
| 5/15 | 64800 | 21600 | 21408 | 12 | 192 |
| 6/15 | | 25920 | 25728 | | |
| 7/15 | | 30240 | 30048 | | |
| 8/15 | | 34560 | 34368 | | |
| 9/15 | | 38880 | 38688 | | |
| 10/15 | | 43200 | 43008 | | |
| 11/15 | | 47520 | 47328 | | |
| 12/15 | | 51840 | 51648 | | |
| 13/15 | | 56160 | 55968 | | |

TABLE 29

| | | | | BCH | |
|---|---|---|---|---|---|
| | | | | error | |
| LDPC | | | | correction | |
| Rate | N_{ldpc} | K_{ldpc} | K_{bch} | capability | N_{bch} − K_{bch} |
| 5/15 | 16200 | 5400 | 5232 | 12 | 168 |
| 6/15 | | 6480 | 6312 | | |
| 7/15 | | 7560 | 7392 | | |
| 8/15 | | 8640 | 8472 | | |
| 9/15 | | 9720 | 9552 | | |
| 10/15 | | 10800 | 10632 | | |
| 11/15 | | 11880 | 11712 | | |
| 12/15 | | 12960 | 12792 | | |
| 13/15 | | 14040 | 13872 | | |

The details of operations of the BCH encoding and LDPC-encoding are as follows:

A 12-error correcting BCH code is used for outer encoding of the BBF. The BCH generator polynomial for short FECBLOCK and long FECBLOCK are obtained by multiplying together all polynomials.

LDPC code is used to encode the output of the outer BCH encoding. To generate a completed B_{ldpc} (FECBLOCK), P_{ldpc} (parity bits) is encoded systematically from each I_{ldpc} (BCH-encoded BBF), and appended to I_{ldpc}. The completed B_{ldpc} (FECBLOCK) are expressed as follow Math figure.

B_{ldpc}=[I_{ldpc}P_{ldpc}]=[i₀,i₁, . . . ,i_{K}_{_{ldpc}}₋₁,p₀,p₁, . . . ,p_{N}_{_{ldpc}}_{-K}_{_{ldpc}}₋₁] [Math Figure 2]

The parameters for long FECBLOCK and short FECBLOCK are given in the above table 28 and 29, respectively.

The detailed procedure to calculate N_{ldpc}−K_{ldpc} parity bits for long FECBLOCK, is as follows:

1) Initialize the parity bits,

p₀=p₁=p₂= . . . =p_{N}_{_{ldpc}}_{-K}_{_{ldpc}}₋₁=0 [Math Figure 3]

2) Accumulate the first information bit—i₀, at parity bit addresses specified in the first row of an addresses, of parity check matrix. The details of addresses of parity check matrix will be described later. For example, for rate 13/15:

p₉₈₃=p₉₈₃⊕i₀ p₂₈₁=p₂₈₁₅⊕i₀

p₄₈₃₇=p₄₈₃₇⊕i₀ p₄₉₈₉ p₄₉₈₉⊕i₀

p₆₁₃₈=p₆₁₃₈δi₀ p₆₄₅₈=p₆₄₅₈⊕i₀

p₆₉₂₁=p₆₉₂₁⊕i₀ p₆₉₇₄=p₆₉₇₄⊕i₀

p₇₅₇₂=p₇₅₇₂⊕i₀ p₈₂₆₀=p₈₂₆₀⊕i₀

p₈₄₉₆=p₈₄₉₆⊕i₀ [Math Figure 4]

3) For the next 359 information bits, iₛ, s=1, 2, . . . , 359 accumulate iₛ at parity bit addresses using following Math figure.

{x+(s mod 360)×Q_{ldpc}} mod(N_{ldpc}−K_{ldpc}) [Math Figure 5]

where x denotes the address of the parity bit accumulator corresponding to the first bit i₀, and Q_{ldpc} is a code rate dependent constant specified in the addresses of parity check matrix. Continuing with the example, Q_{ldpc}=24 for rate 13/15, so for information bit i₁, the following operations are performed:

p₁₀₀₇=p₁₀₀₇⊕i₁ p₂₈₃₉=p₂₈₃₉⊕i₁

p₄₈₆₁=p₄₈₆₁⊕i₁ p₅₀₁₃=p₅₀₁₃⊕i₁

p₆₁₆₂=p₆₁₆₂⊕i₁ p₆₄₈₂=p₆₄₈₂⊕i₁

p₆₉₄₅=p₆₉₄₅⊕i₁ p₆₉₉₈=p₆₉₉₈⊕i₁

p₇₅₉₆=p₇₅₉₆⊕i₁ p₈₂₈₄=p₈₂₈₄⊕i₁

p₈₅₂₀=p₈₅₂₀⊕i₁ [Math Figure 6]

4) For the 361st information bit i₃₆₀, the addresses of the parity bit accumulators are given in the second row of the addresses of parity check matrix. In a similar manner the addresses of the parity bit accumulators for the following 359 information bits iₛ, s=361, 362, . . . , 719 are obtained using the Math figure 6, where x denotes the address of the parity bit accumulator corresponding to the information bit i₃₆₀, i.e., the entries in the second row of the addresses of parity check matrix.

5) In a similar manner, for every group of 360 new information bits, a new row from addresses of parity check matrixes used to find the addresses of the parity bit accumulators.

After all of the information bits are exhausted, the final parity bits are obtained as follows:

6) Sequentially perform the following operations starting with i=l

pᵢ=pᵢ⊕pᵢ₋₁,i=1,2, . . . ,N_{ldpc}−K_{ldpc}−1 [Math Figure 7]

where final content of pi, i=0, 1, . . . , N_{ldpc}−K_{ldpc}−1 is equal to the parity bit pi.

TABLE 30

| Code Rate | Q_{ldpc} |
|---|---|
| 5/15 | 120 |
| 6/15 | 108 |
| 7/15 | 96 |
| 8/15 | 84 |
| 9/15 | 72 |
| 10/15 | 60 |
| 11/15 | 48 |
| 12/15 | 36 |
| 13/15 | 24 |

This LDPC encoding procedure for a short FECBLOCK is in accordance with t LDPC encoding procedure for the long FECBLOCK, except replacing the table 30 with table 31, and replacing the addresses of parity check matrix for the long FECBLOCK with the addresses of parity check matrix for the short FECBLOCK.

TABLE 31

| Code Rate | Q_{ldpc} |
|---|---|
| 5/15 | 30 |
| 6/15 | 27 |
| 7/15 | 24 |
| 8/15 | 21 |
| 9/15 | 18 |
| 10/15 | 15 |
| 11/15 | 12 |
| 12/15 | 9 |
| 13/15 | 6 |

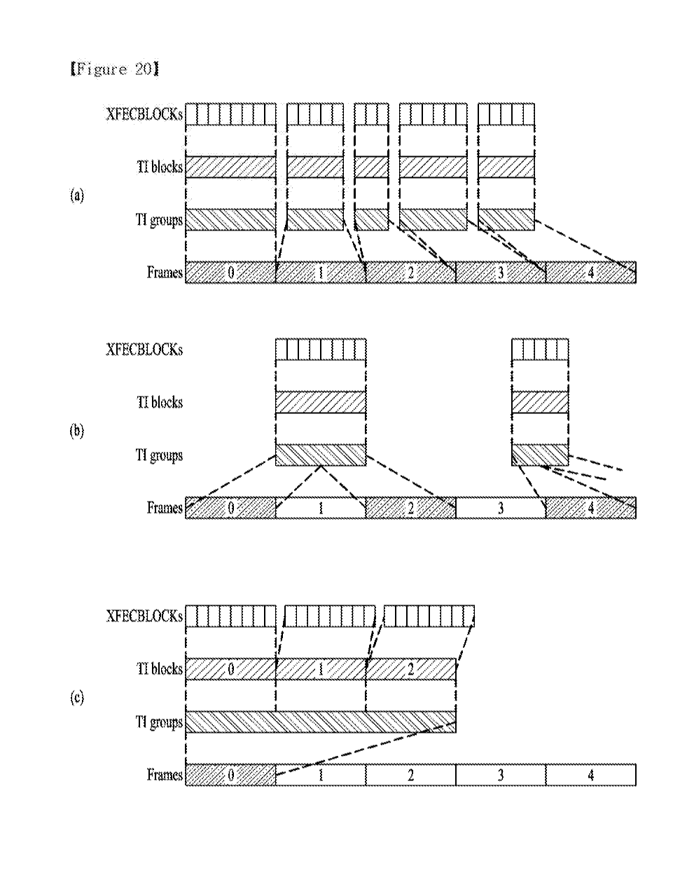

FIG. 20 illustrates a time interleaving according to an embodiment of the present invention.

(a) to (c) show examples of TI mode.

The time interleaver operates at the DP level. The parameters of time interleaving (TI) may be set differently for each DP.

The following parameters, which appear in part of the PLS2-STAT data, configure the TI:

DP_TI_TYPE (allowed values: 0 or 1): Represents the TI mode; ‘0’ indicates the mode with multiple TI blocks (more than one. TI block) per TI group. In this case, one TI group is directly mapped to one frame (no inter-frame interleaving) ‘1’ indicates the mode with only one TI block per TI group. In this case, the TI block may be spread, over more than one frame (inter-frame interleaving).

DP_TI_LENGTH: If DP_TI_TYPE=‘0’, this parameter is the number of TI blocks NTI per TI group. For DP_TI_TYPE=‘1’, this parameter is the number of frames PI spread from one TI group.

DP_NUM_BLOCK_MAX (allowed values: 0 to 1023): Represents the maximum number of XFECBLOCKs per TI group.

DP_FRAME_INTERVAL (allowed values: 1, 2, 4, 8): Represents the number of the frames I_{JUMP} between two successive frames carrying the same DP of a given PHY profile.

DP_TI_BYPASS (allowed values: 0 or 1): If time interleaving is not used for a DP, this parameter is set to ‘1’. It is set to ‘0’ if time interleaving is used.

Additionally, the parameter DP_NUM_BLOCK from the PLS2-DYN data is used to represent the number of XFECBLOCKs carried by one TI group of the DP.

When time interleaving is not used for a DP, the following TI group, time interleaving operation, and TI mode are not considered. However, the Delay Compensation block for the dynamic configuration information from the scheduler will still be required. In each DP, the XFECBLOCKS received from the SSD/MIMO encoding are grouped into TI groups. That is, each TI group is a set of an integer number of XFECBLOCKs and will contain a dynamically variable number of XFECBLOCKs. The number of XFECBLOCKs in the TI group of index n is denoted by N_{xBLOCK}_{_}_{Group}(n) and is signaled as DP_NUM_BLOCK in the PLS2-DYN data. Note that N_{xBLOCK}_{_}_{Group}(n) may vary from the minimum value of 0 to the maximum value N_{xBLOCK}_{_}_{Group}_{_}_{MAX} (corresponding to DP_NUM_BLOCK_MAX) of which the largest value is 1023.

Each TI group is either mapped directly onto one frame or spread over PI frames. Each TI group is also divided into more than one TI blocks (NTI), where each TI block corresponds to one usage of time interleaver memory. The TI blocks within the TI group may contain slightly different numbers of XFECBLOCKs. If the TI group is divided into multiple TI blocks, it is directly mapped to only one frame. There are three options for time interleaving (except the extra option of skipping the time interleaving) as shown in the below table 33.

TABLE 32

| Modes | Descriptions |
|---|---|
| Option-1 | Each TI group contains one TI block and is mapped directly to |
| | one frame as shown in (a). This option is signaled in the |
| | PLS2-STAT by DP_TI_TYPE = ‘0’ and |
| | DP_TI_LENGTH = ‘1’ (NTI = 1). |
| Option-2 | Each TI group contains one TI block and is mapped to more |
| | than one frame. (b) shows an example, where one TI group |
| | is mapped to two frames, i.e., DP_TI_LENGTH = ‘2’ |
| | (PI = 2) and DP_FRAME_INTERVAL (IJUMP = 2). |
| | This provides greater time diversity for low data-rate |
| | services. This option is signaled in the PLS2-STAT by |
| | DP_TI_TYPE = ‘1’. |
| Option-3 | Each TI group is divided into multiple TI blocks and is |
| | mapped directly to one frame as shown in (c). Each TI block |
| | may use full TI memory, so as to provide the maximum |
| | bit-rate for a DP. This option is signaled in the PLS2-STAT |
| | signaling by DP_TI_TYPE = ‘0’ and DP_TI_LENGTH = |
| | NTI, while PI = 1. |

[Table 32]

Typically, the time interleaver will also act as a buffer for DP data prior to the process of frame building. This is achieved by means of two memory banks for each DP. The first TI-block is written to the first bank. The second TI-block is written to the second bank while the first bank is being read from and so on.

The TI is a twisted row-column block interleaver. For the sth TI block of the nth TI group, the number of rows Nᵣ of a TI memory is equal to the number of cells N_{cells}, i.e., Nᵣ=N_{cells} while the number of columns N_{c} is equal to the number N_{xBLOCK}_{_}_{TI}(n, s).

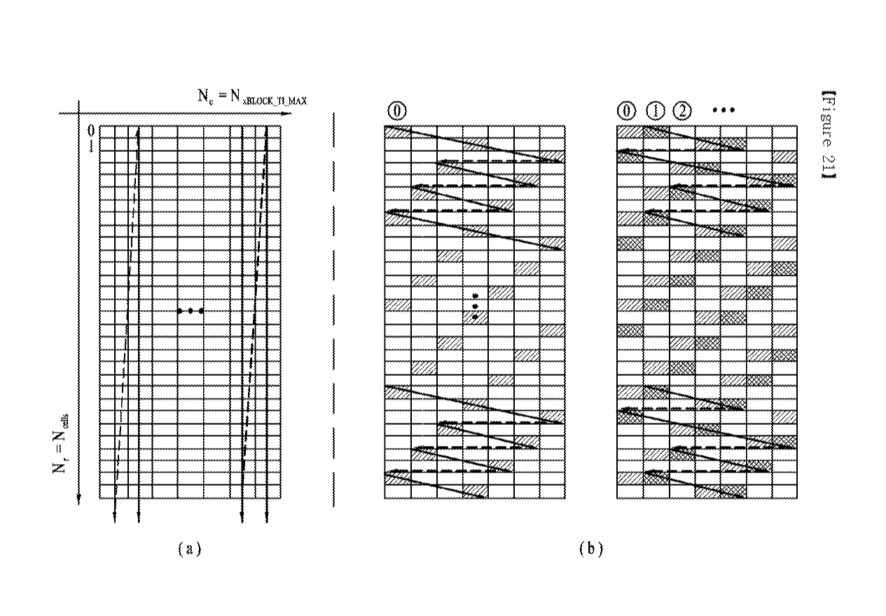

FIG. 21 illustrates the basic operation of a twisted row-column block interleaver according to an embodiment of the present invention.

(a) shows a writing operation in the time interleaver and (b) shows a reading operation in the time interleaver The first XFECBLOCK is written column-wise into the first column of the TI memory, and the second XFECBLOCK is written into the next column, and so on as shown in (a). Then, in the interleaving array, cells are read out diagonal-wise. During diagonal-wise reading from the first row (rightwards along the row beginning with the left-most column) to the last row, Nᵣ cells are read out as shown in (b). In detail, assuming Z_{a,s,i}(i=0, . . . , NₜN_{c}) as the TI memory cell position to be read sequentially, the reading process in such an interleaving array is performed by calculating the row index R_{a,s,i}, the column index C_{a,s,i}, and the associated twisting parameter T_{a,s,i}, as follows expression.

$$GENERATE ( {R}_{n , s , i} , {C}_{n , s , i} ) = \\ \{ \\ {R}_{n , s , i} = mod ( i , {N}_{r} ) , \\ {T}_{n , s , i} = mod ( {S}_{shift} \times {S}_{n , s , i} , {S}_{c} ) \\ {C}_{n , s , i} = mod ( {t}_{n , s , i} + ⌊ \frac{i}{{N}_{r}} ⌋ , {N}_{c} ) \\ \} \qquad [ Math Figure 8 ]$$

where S_{shift} is a common shift value for the diagonal-wise reading process regardless of N_{xBLOCK,TI}(n,s), and it is determined by N_{xBLOCK,TI}_{_}_{MAX} given in the PLS2-STAT as follows expression.

$$for \{ \begin{matrix}\begin{matrix}{N}_{xBLOCK\_TI \_MAX}^{′} = \\ {N}_{xBLOCK\_TI \_MAX} + 1 ,\end{matrix} & if {N}_{xBLOCK\_TI \_MAX} mod 2 = 0 \\ \begin{matrix}{N}_{xBLOCK\_TI \_MAX}^{′} = \\ {N}_{xBLOCK\_TI \_MAX} ,\end{matrix} & if {N}_{xBLOCK\_TI \_MAX} mod 2 = 1\end{matrix} , \\ {S}_{shift} = \frac{{N}_{xBLOCK\_TI \_MAX}^{′} - 1}{2} \qquad [ Math Figure 9 ]$$

As a result, the cell positions to be read are calculated by a coordinate as z_{n,s,i}=NᵣC_{n,s,i}+R_{n,s,i}.

FIG. 22 illustrates an operation of a twisted row-column block interleaver according to another embodiment of the present invention.

More specifically, FIG. 22 illustrates the interleaving array in the TI memory for each TI group, including virtual XFECBLOCKs when N_{xBLOCK}_{_}_{TI}(0,0)=3, N_{xBLOCK}_{_}_{TI} (1,0)=6, N_{xBLOCK}_{_}_{TI}(2,0)=5.

The variable number N_{xBLOCK}_{_}_{TI}(n,s)=Nᵣ will be less than or equal to N′_{xBLOCK}_{_}_{TI}_{_}_{MAX}. Thus, in order to achieve a single-memory deinterleaving at the receiver side, regardless of N_{xBLOCK}_{_}_{TI}(n,s), the interleaving array for use in a twisted row-column block interleaver is set to the size of Nᵣ×N_{c}=N_{cells}×N′_{xBLOCK}_{_}_{TI}_{_}_{MAX} by inserting the virtual XFECBLOCKs into the TI memory and the reading process is accomplished as follow expression.

[Math FIG. 10]

p=0 ;
for i=0 ; i<N_{cells} N′_{xBLOCK}_{_{—}}_{TI}_{_{—}}_{MAX} ; i=i+1
{GENERATE (R_{n,s,i} , C_{n,s,i} ) ;
Vᵢ = Nᵣ C_{n,s,j} +R_{n,s,i}

if Vᵢ < N_{cells} N_{xBLOCK}_{_{—}}_{TI} (n,s)
{
Z_{n,s,p} = Vᵢ ;p=p+1 ;
}

}

The number of TI groups is set to 3. The option of time interleaver is signaled in the PLS2-STAT data by DP_TI_TYPE=‘0’, DP_FRAME_INTERVAL=‘1’, and DP_TI_LENGTH=‘1’, i.e., NTI=1, I_{JUMP}=1, and PI=1. The number of XFECBLOCKs, each of which has Ncells=30 cells, per TI group is signaled in the PLS2-DYN data by NxBLOCK_TI(0,0)=3, NxBLOCK_TI(1,0)=6, and NxBLOCK_TI(2,0)=5, respectively. The maximum number of XFECBLOCK is signaled in the PLS2-STAT data by NxBLOCK_Group_MAX, which leads to └N_{xBLOCK}_{_}_{Group}_{_}_{MAX}/N_{TI}┘=N_{xBLOCK}_{_}_{TI}_{_}_{MAX}=6.

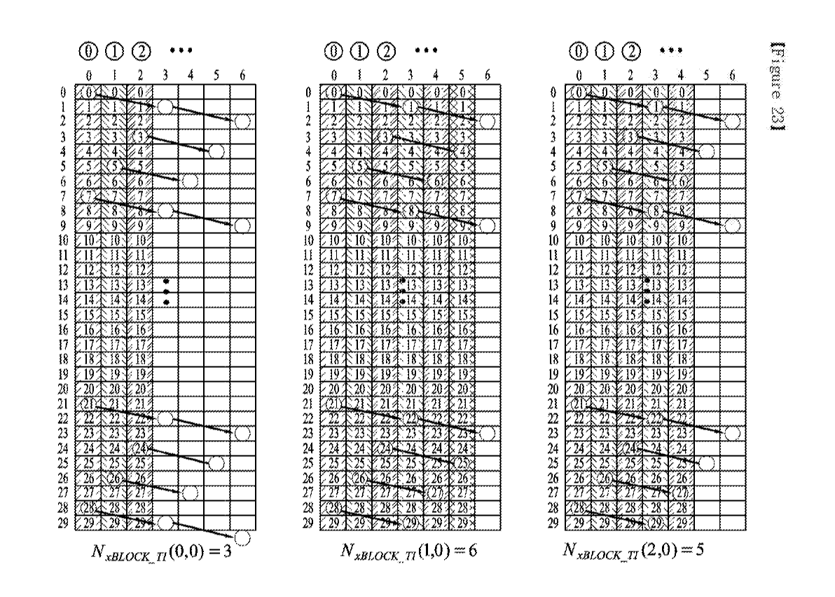

FIG. 23 illustrates a diagonal-wise reading pattern of a twisted row-column block interleaver according to an embodiment of the present invention.

More specifically FIG. 23 shows a diagonal-wise reading pattern from each interleaving array with parameters of N′_{xBLOCK}_{_}_{TI}_{_}_{MAX}=7 and Sshift=(7−1)/2=3. Note that in the reading process shown as pseudocode above, if Vᵢ≧N_{cells} N_{xBLOCK}_{_}_{TI}(n,s), the value of Vi is skipped and the next calculated value of Vi is used.

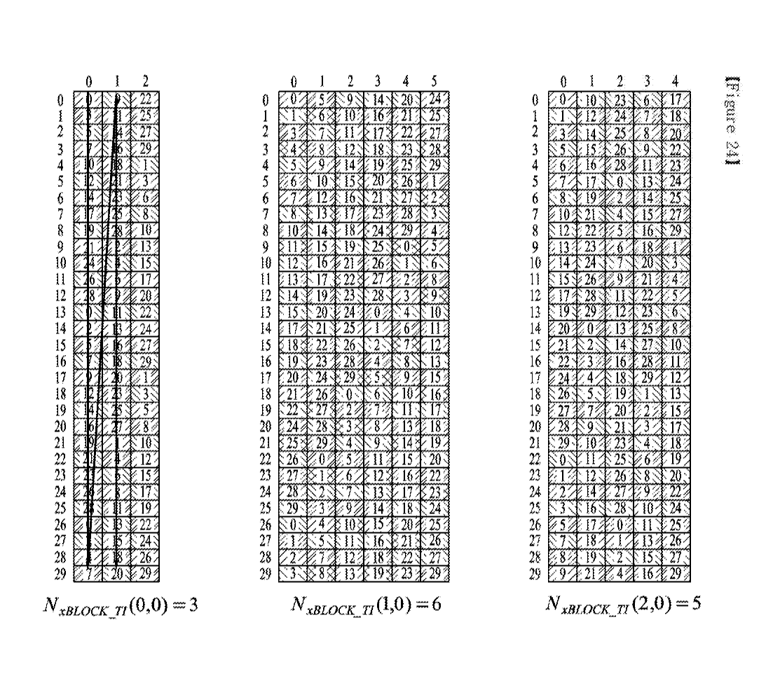

FIG. 24 illustrates interlaved XFECBLOCKs from each interleaving array according to an embodiment of the present invention.

FIG. 24 illustrates the interleaved XFECBLOCKs from each interleaving array with parameters of N′_{xBLOCK}_{_}_{TI}_{_}_{MAX}=7 and Sshift=3.

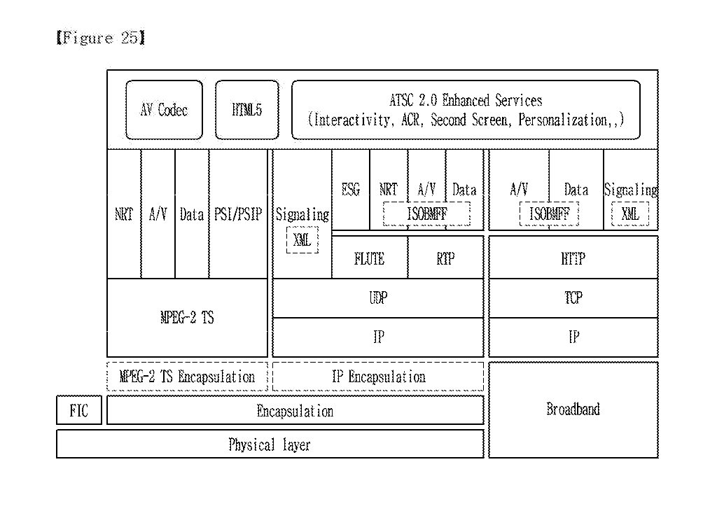

FIG. 25 is a view of a protocol stack for supporting a broadcast service according to an embodiment of the present invention.

The broadcast service may provide adjunct services, for example, audio/video (A/V) data and HTML5 application, interactive service, ACR service, second screen service, and personalization service.

Such a broadcast service may be transmitted through a physical layer (i.e., broadcast signal) such as terrestrial wave and a cable satellite. Additionally, a broadcast service according to an embodiment of the present invention may be transmitted through an internet communication network (e.g., broadband).

When the broadcast service is transmitted through a physical layer, i.e., a broadcast signal such as terrestrial wave and a cable satellite, a broadcasting receiving apparatus may extract an encapsulated MPEG-2 Transport Stream (TS) and an encapsulated IP datagram by demodulating the broadcast signal. The broadcasting receiving apparatus may extract a user datagram protocol (UDP) datagram from the IP datagram. At this point, the signaling information may be in XML format. The broadcasting receiving apparatus may extract signaling information from the UDP datagram. Additionally, the broadcasting receiving apparatus may extract an Asynchronous Layered Coding/Layered Coding Transport (ALC/LCT) packet from the UDP datagram. The broadcasting receiving apparatus may extract a File Delivery over Unidirectional Transport (FLUTE) packet from the ALC/LCT packet. At this point, the FLUTE packet may include realtime audio/video/closed caption data, Non-Real Time (NRT) data and Electronic Service Guide (ESG) data. Additionally, the broadcasting receiving apparatus may extract a Realtime Transport Protocol (RTP) packet and an RTP Control Protocol (RTCP) packet from the UDP datagram. The broadcasting receiving apparatus may extract A/V data and enhanced data from the RTP/RTCP packet. At this point, at least one of NRT data, A/V data, and enhanced data may be in ISO Base Media File Format (ISO BMFF). Additionally, the broadcasting receiving apparatus may extract signaling information such as NRT data, A/V data, and PSI/PSIP from an MPEG-2 TS packet or an IP packet. At this point signaling information in XML or binary format.

When the broadcast service is transmitted through an internet communication network (e.g., broadband), the broadcasting receiving apparatus may receive an IP packet from the internet communication network. The broadcasting receiving apparatus may extract a TCP packet from the IP packet. The broadcasting receiving apparatus may extract an HTTP packet from the TCP packet. The broadcasting receiving apparatus may extract A/V data, enhanced data, and signaling information from the HTTP packet. At this point, at least one of A/V and enhanced data may be in ISO BMFF format. Additionally, the signaling information may in XML format.

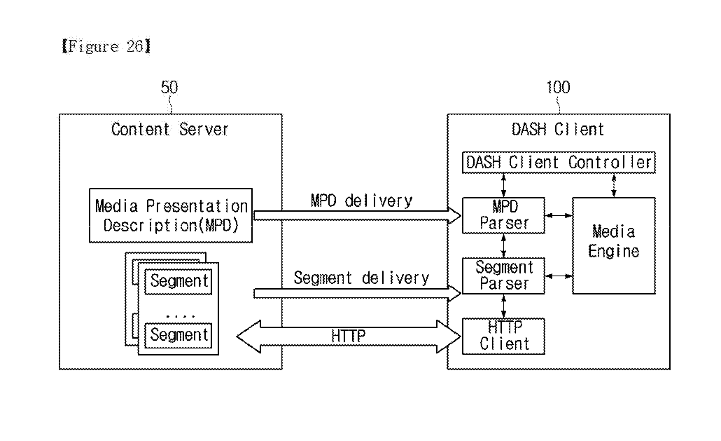

FIG. 26 is a diagram illustrating a system for transmitting/receiving media content via an IP network according to an embodiment.

The media content transmission/reception via an IP network according to an embodiment is divided into transmission/reception of a transmission packet including actual media content and transmission/reception of media content presentation information. The broadcasting receiving apparatus 100 receives the media content presentation information, and receives the transmission packet including media content. The media content presentation information represents information required for presenting the media content. The media content presentation information includes at least one of spatial information or temporal information required for presenting the media content. The broadcasting receiving apparatus 100 presents the media content on the basis of the media content presentation information.

In a specific embodiment, media content may be transmitted/received via an IP network according to an MPEG Media Transport (MMT) standard. The content server 50 transmits a presentation information (PI) document including the media content presentation information. Furthermore, the content server 50 transmits an MMT protocol (MMTP) packet including media content on the basis of a request of the broadcasting receiving apparatus 100. The broadcasting receiving apparatus 100 receives the PI document. The broadcasting receiving apparatus 100 receives a transmission packet including media content. The broadcasting receiving apparatus 100 extracts the media content from the transmission packet including the media content. The broadcasting receiving apparatus 100 presents the media content on the basis of the PI document.

In another specific embodiment, as illustrated in FIG. 26, media content may be transmitted/received via an IP network according to an MPEG-Dynamic Adaptive Streaming over HTTP (DASH) standard. In FIG. 26, the content server 50 transmits a media presentation description (MPD) including the media content presentation information. However, depending on a specific embodiment, the MPD may be transmitted by another external server instead of the content server 50. Furthermore, the content server 50 transmits a segment including media content on the basis of a request of the broadcasting receiving apparatus 100. The broadcasting receiving apparatus 100 receives the MPD. The broadcasting receiving apparatus 100 requests media content from the content server 50 on the basis of the MPD. The broadcasting receiving apparatus 100 receives a transmission packet including media content on the basis of a request. The broadcasting receiving apparatus 100 presents the media content on the basis of the MPD. To this end, the broadcasting receiving apparatus 100 may include a DASH client in the control unit 150. The DASH client may include an MPD parser for parsing the MPD, a segment parser for parsing the segment, an HTTP client for transmitting an HTTP request message and receiving an HTTP response message via the IP communication unit 130, and a media engine for presenting media.

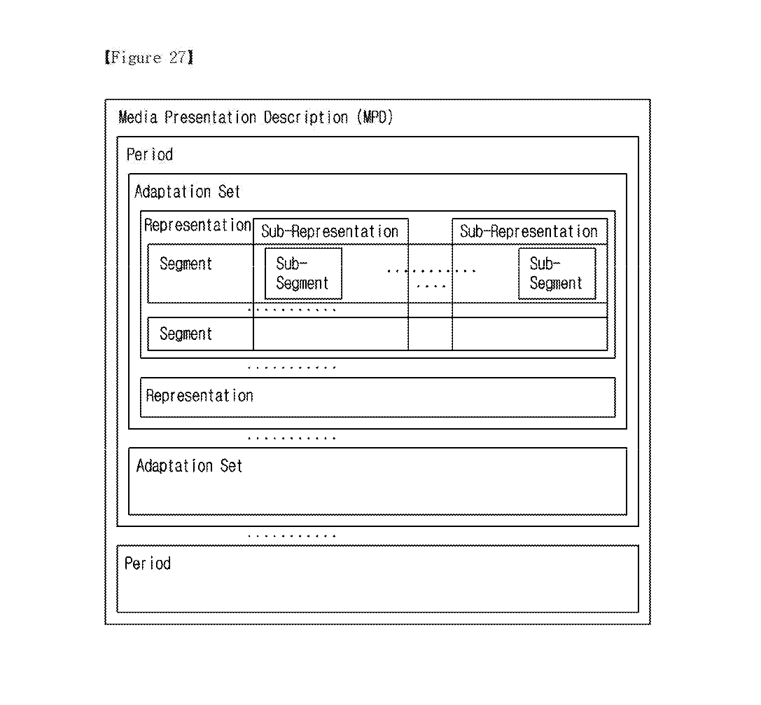

FIG. 27 illustrates a structure of the MPD according to an embodiment. The MPD may include a period element, an adaptation set element, and a representation element.

The period element includes information on a period. The MPD may include information on a plurality of periods. The period represents a continuous time interval of media content presentation.

The adaptation set element includes information on an adaptation set. The MPD may include information on a plurality of adaptation sets. The adaptation set is a set of media components including one or more interconvertible media content components. The adaptation set may include one or more representations. The adaptation sets may respectively include audios of different languages or subtitles of different languages.

The representation element includes information on a representation. The MPD may include information on a plurality of representations. The representation is a structured set of one or more media components. There may exist a plurality of representations differently encoded for the same media content component. In the case where bitstream switching is allowed, the broadcasting receiving apparatus 100 may switch a received representation to another representation on the basis of information updated during presentation of media content. In particular, the broadcasting receiving apparatus 100 may switch a received representation to another representation according to conditions of a bandwidth. The representation is divided into a plurality of segments.

The segment is a unit of media content data. The representation may be transmitted as the segment or a part of the segment according to a request of the media content receiver 30 using the HTTP GET or HTTP partial GET method defined in the HTTP 1.1 (RFC 2616) protocol.

Furthermore, the segment may include a plurality of sub-segments. The sub-segment may represent a smallest unit able to be indexed at a segment level. The segment may include an initialization segment, a media segment, an index segment, and a bitstream switching segment.

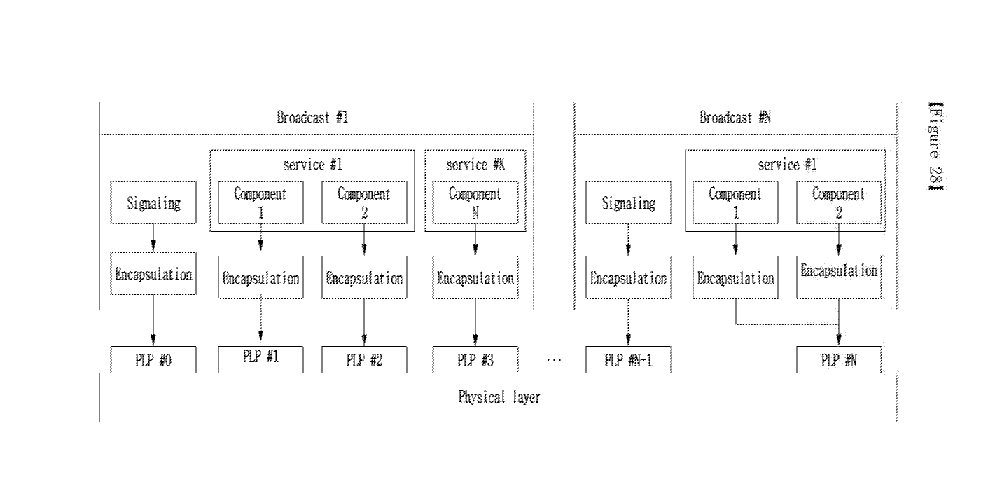

FIG. 28 is a view illustrating a transport layer of broadcast service according to an embodiment of the present invention.

A broadcasting transmitting apparatus may transport broadcast service and broadcast service related data through at least one physical layer pipe (PLP) on one frequency or a plurality of frequencies. At this point, the PLP is a series of logical data delivery paths identifiable on a physical layer. The PLP may be also referred to as a data pipe. One broadcast service may include a plurality of components. At this point, each of the plurality of components may be one of audio, video, and data components. Each broadcasting station may transmit encapsulated broadcast service by using a broadcasting transmitting apparatus through one PLP or a plurality of PLPs. In more detail, a broadcasting station may transmit a plurality of components included in one service to a plurality of PLPs through a broadcasting transmitting apparatus. Additionally, a broadcasting station may transmit a plurality of components included in one service to one PLP through a broadcasting transmitting apparatus. For example, according to the embodiment of FIG. 28, a first broadcasting station Broadcast #1 may transmit signaling information by using a broadcasting transmitting apparatus through one PLP PLP#0. Additionally, according to the embodiment of FIG. 28, the first broadcasting station Broadcast #1 may transmit a first component Component 1 and a second component Component 2 included in a first broadcast service by using a broadcasting transmitting apparatus through a different first PLP PLP #1 and second PLP PLP #2. Additionally, according to the embodiment of FIG. 28, the Nth broadcasting station Broadcast #N may transmit a first component Component 1 and a second component Component 2 included in a first broadcast service Service #1 through an Nth PLP PLP #N. At this point, realtime broadcast service may be encapsulated into one of the user datagram protocol (UDP) and a protocol for realtime contents transmission, for example, the realtime transport protocol (RTP). In the case of non-realtime contents and non-realtime data, realtime broadcast service may be encapsulated into a packet of at least one of IP, UDP, and a contents transmission protocol, for example, FLUTE. Therefore, a plurality of PLPs delivering a least one component may be included in a transport frame that a broadcasting transmitting apparatus transmits. Accordingly, the broadcasting receiving apparatus 100 may need to check all of a plurality of PLPs to perform a broadcast service scan for obtaining broadcast service connection information. Therefore, a broadcast transmission method and a broadcast reception method of the broadcasting receiving apparatus 100 to perform a broadcast service scan are required.

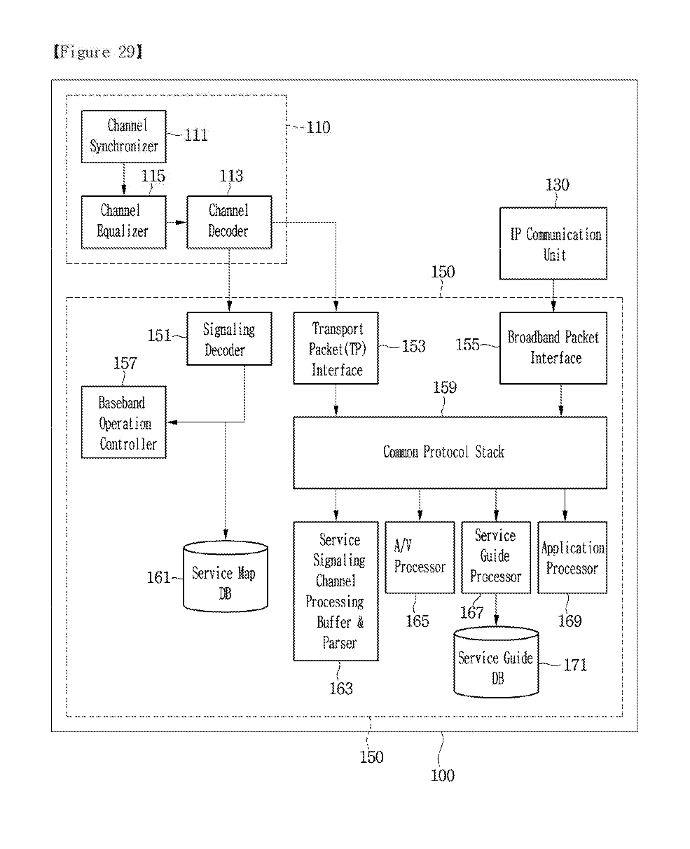

FIG. 29 is a view illustrating a configuration of a broadcasting receiving apparatus according to an embodiment of the present invention.

The broadcasting receiving apparatus 100 of FIG. 29 includes a broadcast reception unit 110, an internet protocol (IP) communication unit 130, and a control unit 150.

The broadcast reception unit 110 includes a channel synchronizer 111, a channel equalizer 113, and a channel decoder 115.

The channel synchronizer 111 synchronizes a symbol frequency with a timing in order for decoding in a baseband where a broadcast signal is received.

The channel equalizer 113 corrects the distortion of a synchronized broadcast signal. In more detail, the channel equalizer 113 corrects the distortion of a synchronized signal due to multipath and Doppler effects.

The channel decoder 115 decodes a distortion corrected broadcast signal. In more detail, the channel decoder 115 extracts a transmission frame from the distortion corrected broadcast signal. At this point, the channel decoder 115 may perform forward error correction (FEC).

The IP communication unit 130 receives and transmits data through internet network.

The control unit 150 includes a signaling decoder 151, a transport packet interface 153, a broadband packet interface 155, a baseband operation control unit 157, a common protocol stack 159, a service map database 161, a service signaling channel processing buffer and parser 163, an A/V processor 161, a broadcast service guide processor 167, an application processor 169, and a service guide database 171.

The signaling decoder 151 decodes signaling information of a broadcast signal.

The transport packet interface 153 extracts a transport packet from a broadcast signal. At this point, the transport packet interface 153 may extract data such as signaling information or IP datagram from the extracted transport packet.

The broadband packet interface 155 extracts an IP packet from data received from internet network. At this point, the broadband packet interface 155 may extract signaling data or IP datagram from the IP packet.

The baseband operation control unit 157 controls an operation relating to receiving broadcast information from a baseband.

The common protocol stack 159 extracts audio or video from a transport packet.

The A/V processor 547 processes audio or video.

The service signaling channel processing buffer and parser 163 parses and buffers signaling information that signals broadcast service. In more detail, the service signaling channel processing buffer and parser 163 parses and buffers signaling information that signals broadcast service from the IP datagram.

The service map database 161 stores a broadcast service list including information on broadcast services.

The service guide processor 167 processes terrestrial broadcast service guide data guiding programs of terrestrial broadcast service.

The application processor 169 extracts and processes application related information from a broadcast signal.

The service guide database 171 stores program information of a broadcast service.

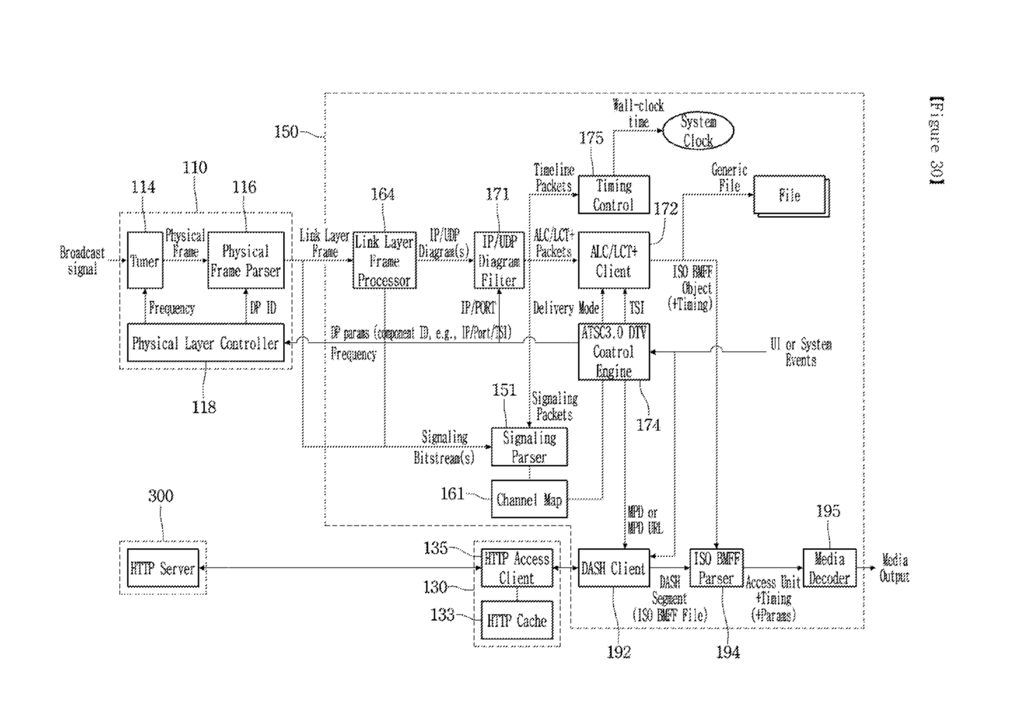

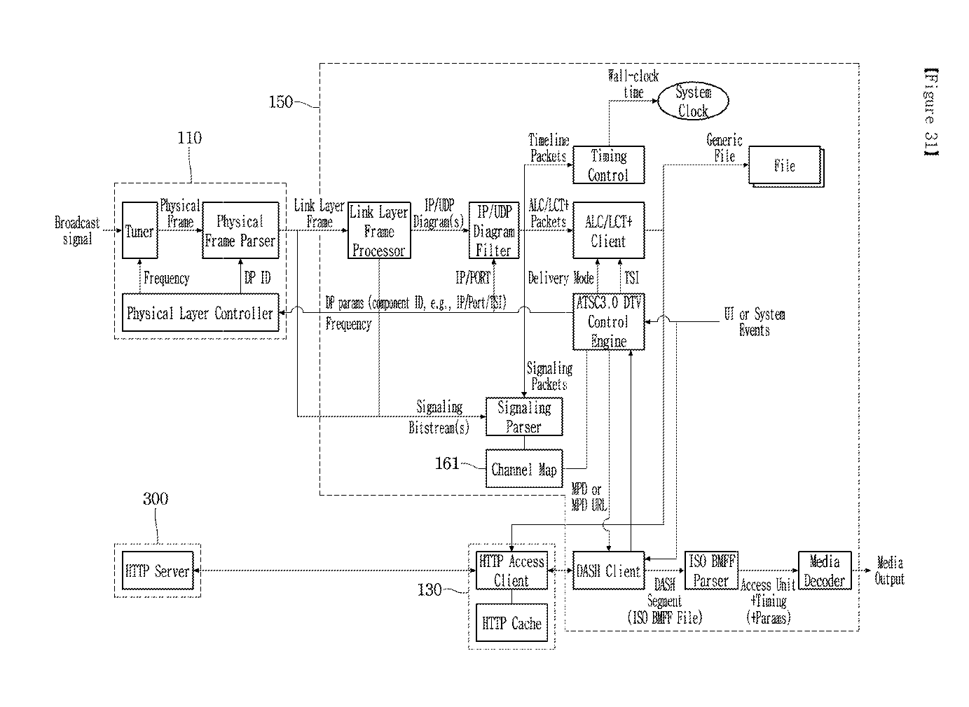

FIGS. 30 and 31 illustrate configurations of a broadcasting receiving apparatus, according to other embodiments of the present invention.

In the embodiments of FIGS. 30 and 31, the broadcasting receiving apparatus 100 includes a broadcast reception unit 110, an Internet protocol (IP) communication unit 130, and a control unit 150.

The broadcast reception unit 110 may include a tuner 114, a physical frame parser 116, and a physical layer controller 118.

The tuner 114 receives a broadcast signal via a broadcast channel and extracts a physical frame. The physical frame is a transmission unit on a physical layer. The physical frame parser 116 acquires a link layer frame by parsing the received physical frame.

The physical layer controller 118 controls the operations of the tuner 114 and the physical frame parser 116.

In an embodiment, the physical layer controller 118 may Control the tuner 114 by using radio frequency (RF) information of the broadcast channel. Specifically, when the physical layer controller 118 transmits the frequency information to the tuner 114, the tuner 114 may acquire a physical frame corresponding to the received frequency information.

In another embodiment, the physical layer controller 118 may control an operation of the physical frame parser 116 through an identifier of a physical layer pipe. Specifically, the physical layer controller 118 transmits identifier information for identifying a specific physical layer pipe of a plurality of physical layer pipes constituting a physical layer pipe to the physical frame parser 116. The physical frame parser 116 may identify the physical layer pipe based on the received identifier information and acquire a link layer frame from the identified physical layer pipe.

The control unit 150 includes a link layer frame parser 164, an IP/UDP datagram filter 171, a DTV control engine 174, an ALC/LCT+ client 172, a timing controller 175, a DASH client 192, an ISO BMFF parser 194, and a media decoder 195.

The link layer frame parser 164 extracts data from the link layer frame. Specifically, the link layer frame parser 164 may acquire a link layer signaling from the link layer frame. Also, the link layer frame parser 164 may acquire an IP/UDP datagram from the link layer frame.

The IP/UDP datagram filter 171 filters out a specific IP/UDP datagram from the IP/UDP datagram received from the link layer frame parser 164.

The ALC/LCT+ client 172 processes an application layer transport packet. The application layer transport packet may include an ALC/LCT+ packet. Specifically, the ALC/LCT+ client 172 may collect a plurality of application layer transport packets and generate one or more ISO BMFF media file format objects.

The timing controller 175 processes a packet including system time information. Also, the timing controller 175 controls a system clock according to a result of the processing.

The DASH client 192 processes realtime streaming or adaptive media streaming. Specifically, the DASH client 192 may acquire a DASH segment by processing HTTP-based adaptive media streaming. In this case, the DASH segment may have the form of the ISO BMFF object.

The ISO BMFF parser 194 extracts audio/video data from the ISO BMFF object received from the DASH client 192.

The ISO BMFF parser 194 may extract the audio/video data in the units of access units. Also, the ISO BMFF parser 194 may acquire timing information for the audio/video from the ISO BMFF object.

The media decoder 195 decodes the received audio and video data. Also, the media decoder 195 performs presentation of a result of the decoding through a media output terminal.

The DTV control engine 174 functions as an interface between the modules. Specifically, the DTV control engine 174 may transfer a parameter necessary for an operation of each module to control the operation of the module.

The Internet protocol (IP) communication unit 130 may include an HTTP access client 135. The HTTP access client 135 may transmit/receive a request or a response to the request to/from an HTTP server.

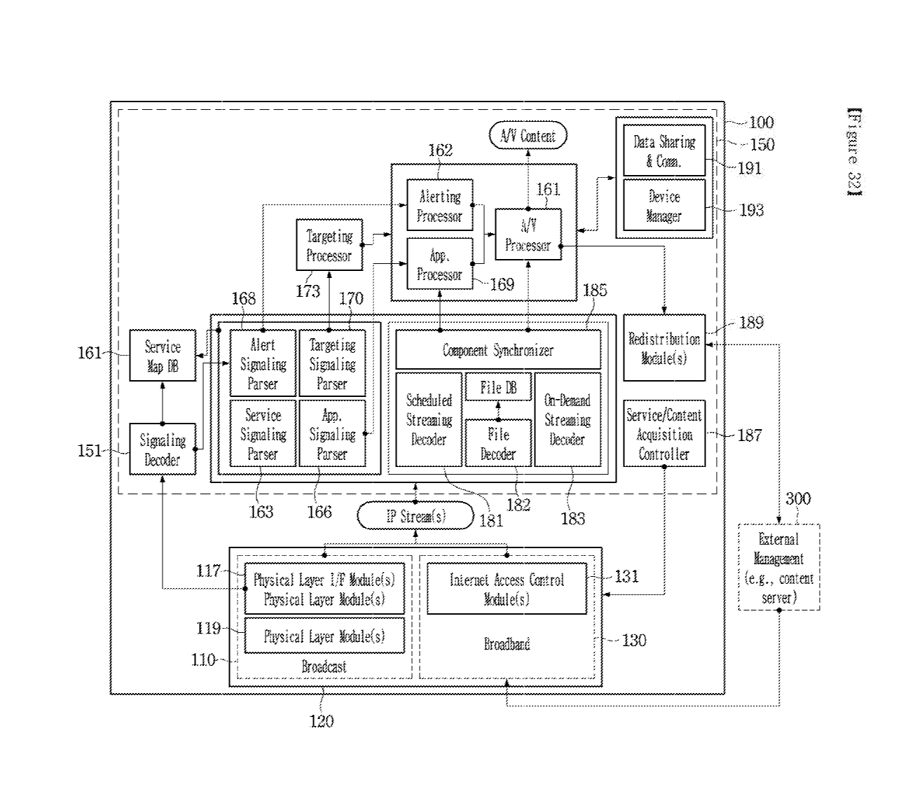

FIG. 32 is a view illustrating a configuration of a broadcasting receiving apparatus according to another embodiment of the present invention.

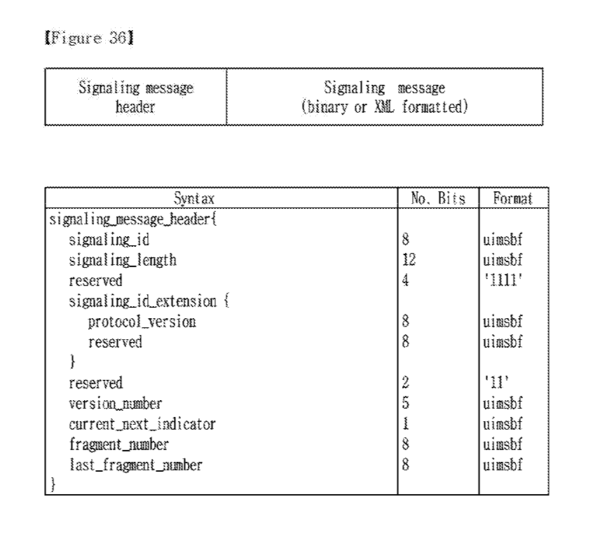

In an embodiment of FIG. 32, the broadcasting receiving apparatus 100 of FIG. 36 includes a broadcast reception unit 110, an internet protocol (IP) communication unit 130, and a control unit 150.

The broadcast reception unit 110 may include one or more processors, one or more circuits, and one or more hardware modules, which perform each of a plurality of functions that the broadcast reception unit 110 performs. In more detail, the broadcast reception unit 110 may be a System On Chip (SOC) in which several semiconductor parts are integrated into one. At this point, the SOC may be semiconductor in which various multimedia components such as graphics, audio, video, and modem and a semiconductor such as a processor and D-RAM are integrated into one. The broadcast reception unit 110 may include a physical layer module 119 and a physical layer IP frame module 117. The physical layer module 119 receives and processes a broadcast related signal through a broadcast channel of a broadcast network. The physical layer IP frame module 117 converts a data packet such as an IP datagram obtained from the physical layer module 119 into a specific frame. For example, the physical layer module 119 may convert an IP datagram into an RS Frame or GSE.

The IP communication unit 130 may include one or more processors, one or more circuits, and one or more hardware modules, which perform each of a plurality of functions that the IP communication unit 130 performs. In more detail, the IP communication unit 130 may be a System On Chip (SOC) in which several semiconductor parts are integrated into one. At this point, the SOC may be semiconductor in which various multimedia components such as graphics, audio, video, and modem and a semiconductor such as a processor and D-RAM are integrated into one. The IP communication unit 130 may include an internet access control module 131. The internet access control module 131 may control an operation of the broadcasting receiving apparatus 100 to obtain at least one of service, content, and signaling data through an internet communication network (for example, broad band).

The control unit 150 may include one or more processors, one or more circuits, and one or more hardware modules, which perform each of a plurality of functions that the control unit 150 performs. In more detail, the control unit 150 may be a System On Chip (SOC) in which several semiconductor parts are integrated into one. At this point, the SOC may be semiconductor in which various multimedia components such as graphics, audio, video, and modem and a semiconductor such as a processor and D-RAM are integrated into one. The control unit 150 may include at least one of a signaling decoder 151, a service map database 161, a service signaling channel parser 163, an application signaling parser 166, an alert signaling parser 168, a targeting signaling parser 170, a targeting processor 173, an A/V processor 161, an alerting processor 162, an application processor 169, a scheduled streaming decoder 181, a file decoder 182, a user request streaming decoder 183, a file database 184, a component synchronization unit 185, a service/content acquisition control unit 187, a redistribution module 189, a device manager 193, and a data sharing unit 191.

The service/content acquisition control unit 187 controls operations of a receiver to obtain services or contents through a broadcast network or an internet communication network and signaling data relating to services or contents.

The signaling decoder 151 decodes signaling information.

The service signaling channel parser 163 parses service signaling information.

The application signaling parser 166 extracts and parses service related signaling information. At this point, the service related signaling information may be service scan related signaling information. Additionally, the service related signaling information may be signaling information relating to contents provided through a service.

The alert signaling parser 168 extracts and parses alerting related signaling information.

The targeting signaling parser 170 extracts and parses information for personalizing services or contents or information for signaling targeting information.

The targeting processor 173 processes information for personalizing services or contents.

The alerting processor 162 processes alerting related signaling information.

The application processor 169 controls application related information and the execution of an application. In more detail, the application processor 169 processes a state of a downloaded application and a display parameter.

The A/V processor 161 processes an A/V rendering related operation on the basis of decoded audio or video and application data.

The scheduled streaming decoder 181 decodes a scheduled streaming that is a content streamed according to a schedule defined by a contents provider such as broadcaster.

The file decoder 182 decodes a downloaded file. Especially, the file decoder 182 decodes a file downloaded through an internet communication network.

The user request streaming decoder 183 decodes a content (for example, On Demand Content) provided by a user request.

The file database 184 stores files. In more detail, the file database 184 may store a file downloaded through an internet communication network.

The component synchronization unit 185 synchronizes contents or services. In more detail, the component synchronization unit 185 synchronizes a presentation time of a content obtained through at least one of the scheduled streaming decoder 181, the file decoder 182, and the user request streaming decoder 183.

The service/content acquisition control unit 187 controls operations of a receiver to obtain services, contents or signaling information relating to services or contents.

When services or contents are not received through a broadcast network, the redistribution module 189 performs operations to support obtaining at least one of services, contents, service related information, and content related information. In more detail, the redistribution module 189 may request at least one of services, contents, service related information, and content related information from the external management device 300. At this point, the external management device 300 may be a content server.

The device manager 193 manages an interoperable external device. In more detail, the device manager 193 may perform at least one of the addition, deletion, and update of an external device. Additionally, an external device may perform connection and data exchange with the broadcasting receiving apparatus 100.

The data sharing unit 191 performs a data transmission operation between the broadcasting receiving apparatus 100 and an external device and processes exchange related information. In more detail, the data sharing unit 191 may transmit AV data or signaling information to an external device. Additionally, the data sharing unit 191 may receive AV data or signaling information from an external device.

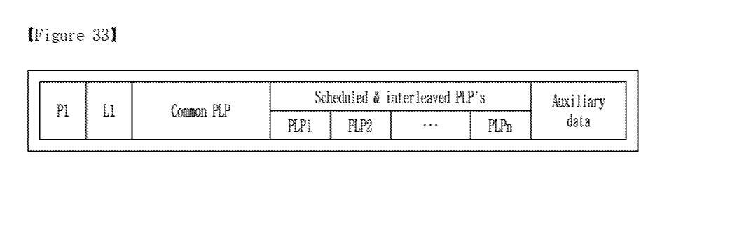

FIG. 33 is a view illustrating a broadcast transmission frame according to an embodiment of the present invention.

According to the embodiment of FIG. 33, the broadcast transmission frame includes a P1 part, an L1 part, a common PLP part, an interleaved PLP part (e.g., a scheduled & interleaved PLP's part), and an auxiliary data part.

According to the embodiment of FIG. 31, the broadcasting transmitting apparatus transmits information on transport signal detection through the P1 part of the transmission frame. Additionally, the broadcasting transmitting apparatus may transmit turning information on broadcast signal tuning through the P1 part.

According to the embodiment of FIG. 33, the broadcasting transmitting apparatus transmits a configuration of the broadcast transmission frame and characteristics of each PLP through the L1 part. At this pint, the broadcasting receiving apparatus 100 decodes the L1 part on the basis of the P1 part to obtain the configuration of the broadcast transmission frame and the characteristics of each PLP.

According to the embodiment of FIG. 33, the broadcasting transmitting apparatus may transmit information commonly applied to PLPs through the common PLP part. According to a specific embodiment of the present invention, the broadcast transmission frame may not include the common PLP part.

According to the embodiment of FIG. 33, the broadcasting transmitting apparatus transmits a plurality of components included in broadcast service through an interleaved PLP part. At this point, the interleaved PLP part includes a plurality of PLPs.

Moreover, according to the embodiment of FIG. 31, the broadcasting transmitting apparatus may signal to which PLP components configuring each broadcast service are transmitted through an L1 part or a common PLP part. However, the broadcasting receiving apparatus 100 decodes all of a plurality of PLPs of an interleaved PLP part in order to obtain specific broadcast service information on broadcast service scan.

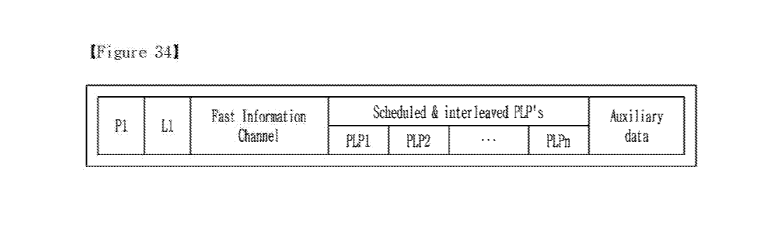

Unlike the embodiment of FIG. 33, the broadcasting transmitting apparatus may transmit a broadcast transmission frame including a broadcast service transmitted through a broadcast transmission frame and an additional part that includes information on a component included in the broadcast service. At this point, the broadcasting receiving apparatus 100 may instantly obtain information on the broadcast service and the components therein through the additional part. This will be described with reference to FIG. 34.

FIG. 34 is a view of a broadcast transmission frame according to another embodiment of the present invention.

According to the embodiment of FIG. 34, the broadcast transmission frame includes a P1 part, an L1 part, a fast information channel (FIC) part, an interleaved PLP part (e.g., a scheduled & interleaved PLP's part), and an auxiliary data part.

Except the FIC part, other parts are identical to those of FIG. 33.

The broadcasting transmitting apparatus transmits fast information through the FIC part. The fast information may include configuration information of a broadcast stream transmitted through a transmission frame, simple broadcast service information, and service signaling relating to a corresponding service/component. The broadcasting receiving apparatus 100 may scan broadcast service on the basis of the FIC part. In more detail, the broadcasting receiving apparatus 100 may extract information on broadcast service from the FIC part.

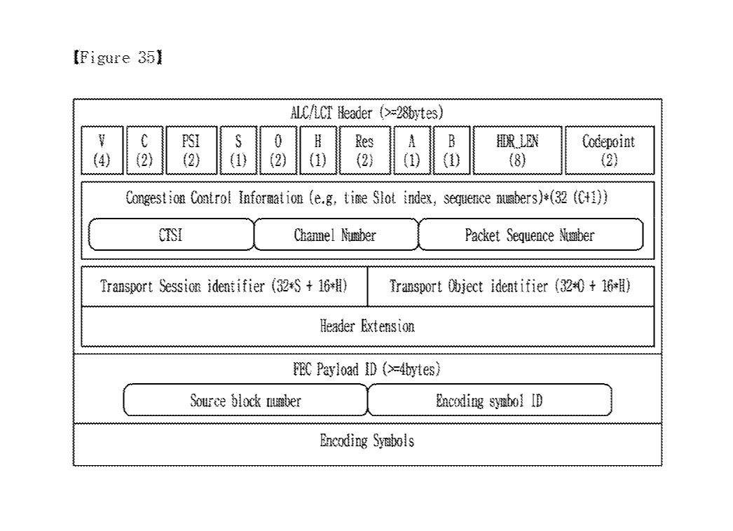

FIG. 35 illustrates a configuration of a transport packet, according to an embodiment of the present invention. The transport packet illustrated in FIG. 35 may use a transport protocol for supporting reliable data transmission. In a specific embodiment, a reliable data transport protocol may be an asynchronous layered coding (ALC) protocol. In another embodiment, a reliable data transport protocol may be a layered coding transport (LCT) protocol.

According to an embodiment of the present invention, a packet header may include version information of a packet.

Specifically, the packet header may include the version information of a transport packet using a corresponding transport protocol. In a specific embodiment, the above-described information may be a V field. Also, the V field may be four bits.

Also, according to an embodiment of the present invention the packet header may include information associated with a length of information for congestion control. Specifically, the packet header may include information about the length of information for congestion control and information, about a multiple number to be multiplied by a basic unit of the length of information for congestion control.

In a specific embodiment, the above-described information may be a C field. In an embodiment, the C field may be set to 0x00, and in this case, may indicate that the length of the information for congestion control is 32 bits. In another embodiment, the C field may be set to 0x01, and in this case, the length of the information for congestion control may be 64 bits. In another embodiment, the C field may be set to 0x02, and in this case, the length of the information for congestion control may be 96 bits. In another embodiment, the C field may be set to 0x03, and in this case, the length of the information for congestion control may be 128 bits. The C field may be two bits.

According to an embodiment of the present invention, the packet header may include specialized information for the protocol. In a specific embodiment, the above-described information may be a PSI field. Also, the PSI field may be two bits.

Also, according to an embodiment of the present invention, the packet header may include information associated with a length of a field indicating identification information of a transport session. Specifically, the packet header may include information about a multiple number of the field indicating the identification information of the transport session. The above-described information may be referred to as an S field. The S field may be one bit.

Also, according to an embodiment of the present invention, the packet header may include information associated with a length of a field indicating identification information of a transmission object. Specifically, the packet header may include information about a multiple number to be multiplied by a basic length of the field indicating the identification information of the transmission object. The above-described information may be referred to as an O field. The O field may be two bits.

Also, according to an embodiment of the present invention, the packet header may include additional information associated with the length of the field indicating the identification information of the transport session. Also, the packet header may include additional information associated with the length of the field indicating the identification information of the transmission object. The additional information may be information indicating whether a half-word is added. It is necessary that there are a field indicating the identification information of the transport packet and a field indicating the identification information of the transmission object. The S field and the H field, or the O field and the H field cannot represent zero (0) at the same time.

Also, according to the present embodiment of the present invention, the packet header may include information indicating that a session is terminated or a session is going to be terminated soon. The above-described information may be referred to as an A field. In a specific embodiment, the A field may be set to 1 when the A field indicates that a session is terminated or a session is going to be terminated soon. Therefore, in a general case, the A field may be set to zero. When the broadcasting transmitting apparatus sets the A field to 1, it may indicates that the last packet is being transmitted via a session. When the A field is set to 1, the broadcasting transmitting apparatus is required to maintain the A field at a value of 1. Also, when the A field is set to 1, the broadcasting receiving apparatus may recognize that the broadcasting transmitting apparatus is going to stop packet transmission via a session soon. In other words, when the A field is set to 1, the broadcasting receiving apparatus may recognize that there is no further packet transmission via a session. According to an embodiment, the A field may be one bit.

Also, according to an embodiment of the present invention, the packet header may include information indicating that object transmission is terminated or is going to be terminated soon. The above-described information may be referred to as a B field. In a specific embodiment, the broadcasting transmitting apparatus may set the B field to 1 when object transmission is going to be terminated. Therefore, in a general case, the B field may be set to zero. When information for identifying a transmission object is not present in a transport packet, the B field may be set to 1. It is possible to indicate that object transmission via a session identified by out-of-band information is going to be terminated soon. Also, the B field may be set to 1 when the last packet for an object is transmitted. In addition, the B field may be set to 1 when packets of the last seconds for the object are transmitted. When the B field of a packet for a specific object is set to 1, the broadcasting transmitting apparatus is required to set the B field to 1 until transmission of packets following a corresponding packet is terminated. When the B field is set to 1, the broadcasting receiving apparatus 100 may recognize that the broadcasting transmitting apparatus is going to stop transmission of packets for an object. In other words, the broadcasting receiving apparatus 100 may recognize that there is no further object transmission via a session, based on the B field set to 1. According to an embodiment, the B field may be one bit.

Also, the packet header according to the present embodiment of the present invention may include specialized information for the protocol. The above-described information may be referred to as a HDR_LEN field. The HDR_LEN field may be a multiple of 32 bits. In a specific embodiment, when the HDR_LEN field is set to 5, the total length of the packet header may be 160 bits that is five times 32 bits. Also, the HDR_LEN field may be eight bits.

Also, according to an embodiment of the present invention, the packet header may include information associated with encoding or decoding of a payload included in a corresponding packet. The above-described information may be referred to as a Codepoint field. According to an embodiment, the Codepoint field may be eight bits.

Also, according to an embodiment of the present invention, the packet header may include information for congestion control. The above-described information may be referred to as a Congestion Control Information (hereinafter referred to as CCI) field. In a specific embodiment, the CCI field may include at least one of a Current time slot index (CTSI) field, a channel number field, and a packet sequence number field.

Also, according to an embodiment of the present invention, the packet header may include information for identification of a transport session. The above-described information may be referred to as a Transport Session Identifier (hereinafter referred to as TSI). Also, a field of the packet header including TSI information may be referred to as a TSI field.

Also, according to an embodiment of the present invention, the packet header may include information for identification of an object transmitted via a transport session. The above-described information may be referred to as a Transport Object Identifier (hereinafter referred to as TOI). Also, a field of the packet header including TOI information may be referred to as a TOI field.

Also, according to an embodiment of the present invention, the packet header may include information for transmitting additional information. The above-described information may be referred to as a Header Extension field. According to an embodiment, the additional information may be time information related with the presentation of a transmission object. According to another embodiment, the additional information may be time information related with decoding of a transmission object.

Also, according to an embodiment of the present invention, a transport packet may include payload identification information. According to an embodiment, the identification information may be payload identification information related with with a forward error correction (FEC) scheme. In this case, the FEC is one of payload formats defined in RFC 5109. The FEC may be used in Realtime Transport Protocol (RTP) or Secure Realtime Transport Protocol (SRTP). The above-described information may be referred to as a FEC Payload ID field.

In an embodiment, the FEC Payload ID field may include information for identifying a source block of an object. The above-described information may be referred to as a Source block number field. For example, when the Source block number field is set to N, source blocks in an object may be numbered from 0 to N−1.

In another embodiment, the FEC Payload ID field may include information for identifying a specific encoding symbol. The above-described information may be an Encoding symbol ID field.

Also, according to an embodiment of the present invention, a transport packet may include data in the payload. A field including the above-described data may be referred to as an Encoding symbol(s) field. In an embodiment, the broadcasting receiving apparatus 100 may extract the Encoding symbol(s) field and reconfigure the object. Specifically, data in the Encoding symbol(s) field may be generated from the source block transmitted through the payload of the packet.

FIG. 36 illustrates a configuration of a service signaling message, according to an embodiment of the present invention. Specifically, FIG. 36 may illustrate a syntax of a header of a service signaling message according to an embodiment of the present invention. The service signaling message according to the present embodiment of the present invention may include a signaling message header and a signaling message. In this case, the signaling message may be expressed in a binary format or an XML format. Also, the service signaling message may be included in the payload of a transport protocol packet.

The signaling message header according to the embodiment of FIG. 36 may include identification information for identifying the signaling message. For example, the signaling message may have the form of a session. In this case, the identification information of the signaling message may indicate an identifier (ID) of a signaling table session.

A field indicating the identification information of the signaling message may be a signaling_id field. In a specific embodiment, the signaling_id field may be eight bits.

Also, the signaling message header according to the embodiment of FIG. 36 may include length information indicating a length of the signaling message. A field indicating the length information of the signaling message may be a signaling_length field. In a specific embodiment, the signaling_length field may be 12 bits.

Also, the signaling message header according to the embodiment of FIG. 36 may include identifier extension information for extending the identifier of the signaling message. In this case, the identifier extension information may be information for identifying signaling along with the signaling identifier information. The field indicating the identifier extension information of the signaling message may be a signaling_id_extension field.

The identifier extension information may include protocol version information of the signaling message. A field indicating the protocol version information of the signaling message may be a protocol_version field. In a specific embodiment, the protocol_version field may be 8 bits.

Also, the signaling message header according to the embodiment of FIG. 36 may include version information of the signaling message. The version information of the signaling message may be changed when content included in the signaling message is changed. A field indicating the version information of the signaling message may be a version_number field. In a specific embodiment, the version_number field may be 5 bits.

Also, the signaling message header according to the embodiment of FIG. 36 may include information indicating whether the signaling message is currently available. A field indicating whether the signaling message is currently available may be a current_next_indicator field. In a specific example, when the current_next_indicator field is 1, the current_next_indicator field may indicate that the signaling message is available. In another example, when the current_next_indicator field is 0, the current_next_indicator field may indicate that the signaling message is unavailable, and another signaling message is available, the another signaling message including the same signaling identifier information, signaling identifier extension information, or fragment number information.

Also, the signaling message header according to the embodiment of FIG. 36 may include fragment number information of the signaling message. One signaling message may be divided into a plurality of fragments and then transmitted. Therefore, information for identifying, by a receiver, the plurality of fragments resulting from division may be fragment number information. A field indicating the fragment number information may be a fragment_number field. In a specific embodiment, the fragment_number field may be 8 bits.

Also, when one signaling message is divided into a plurality of fragments and then transmitted, the signaling message header according to the embodiment of FIG. 36 may include information about the last fragment number. When the information about the last fragment number indicates 3, it may represent that the signaling message is divided into three fragments and then transmitted. Also, it is possible to indicate that a fragment including the fragment number of 3 includes the last data of the signaling message. A field indicating information about the last fragment number may be a last_fragment_number field. In a specific embodiment, the last_fragment_number field may be 8 bits.

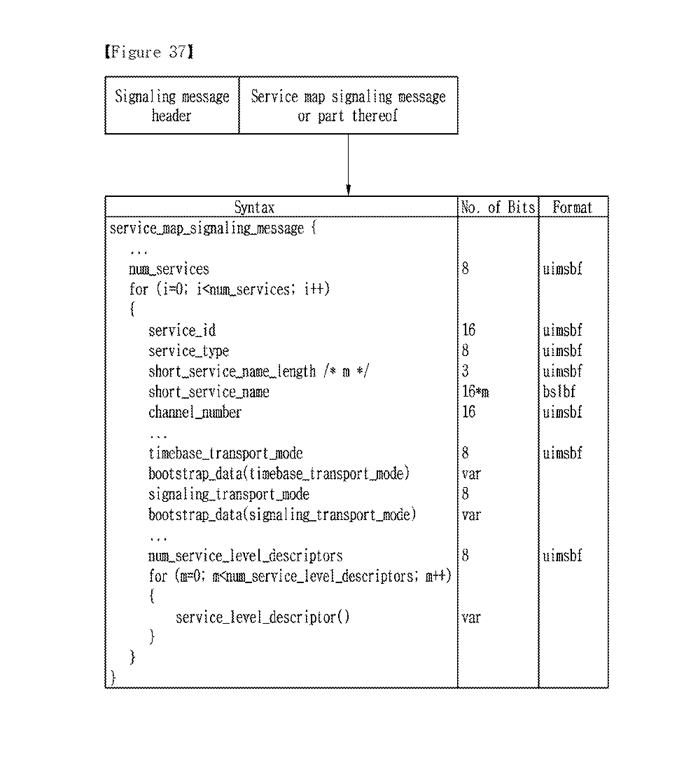

FIG. 37 illustrates a configuration of a broadcast service signaling message in a future broadcast system, according to an embodiment of the present invention. The broadcast service signaling message according to the present embodiment of the present invention is a broadcast service signaling method for allowing the broadcasting receiving apparatus 100 to receive at least one of a broadcast service and content from the future broadcasting system.

The broadcast service signaling method according to the embodiment of FIG. 37 may be based on the configuration of the signaling message illustrated in FIG. 36. The broadcast service signaling message according to the embodiment of FIG. 37 may be transmitted via a service signaling channel. In this case, the service signaling channel may be a sort of physical layer pipe for directly transmitting service signaling information for broadcast service scan without passing through another layer. In a specific embodiment, the service signaling channel may be referred to as at least one of a fast information channel (FIC), a low layer signaling (LLS), and an application layer transport session. Also, a broadcast service signaling message header according to the embodiment of FIG. 37 may have an XML format.

Also, the service signaling message according to the embodiment of FIG. 37 may include information about the number of services included therein. Specifically, a single service signaling message may include a plurality of services and include information indicating the number of services included therein. The information about the number of services may be a num_services field. In a specific embodiment, the num_services field may be 8 bits.

Also, the service signaling message according to the embodiment of FIG. 37 may include identifier information of services. The identifier information may be a service_id field. In a specific embodiment, the service_id field may be 16 bits.

Also, the service signaling message according to the embodiment of FIG. 37 may include service type information. The service type information may be a service_type field. In a specific embodiment, the service_type field has a value of 0x00, a service type indicated by the signaling message may be a scheduled audio service.

In another embodiment, the service_type field has a value of 0x01, a service type indicated by the signaling message may be a scheduled audio/video service. In this case, the scheduled audio/video service may be an audio/video service to be broadcast according to a predetermined schedule.

In another embodiment, the service_type field has a value of 0x02, a service type indicated by the signaling message may be a on-demand service. In this case, the on-demand service may be an audio/video service to be presented in response to a user request. Also, the on-demand service may be a service opposite to the scheduled audio/video service.

In another embodiment, the service type field has a value of 0x03, a service type indicated by the signaling message may be an app-based service. In this case, the app-based service is a non-realtime service, not a realtime broadcast service, and may be a service to be provided through an application. The app-based service may include at least one of a service associated with a realtime broadcast service and a service not associated with a realtime broadcast service. The broadcasting receiving apparatus 100 may download an application and provide an app-based service.

In another embodiment, the service_type field has a value of 0x04, a service type indicated by the signaling message may be a right issuer service. In this case, the right issuer service may be a service to be provided to a person who is issued a right to receive a service.

In another embodiment, the service_type field has a value of 0x05, a service type indicated by the signaling message may be a service guide service. In this case, the service guide service may be a service for providing information about services to be provided. For example, the information about services to be provided may be a broadcast schedule.

Also, the service signaling message according to the embodiment of FIG. 37 may include service name information. The service name information of services may be a short_service_name field.

Also, the service signaling message according to the embodiment of FIG. 37 may include length information of the short_service_name field. The length information of the short_service_name field may be a short_service_name_length field.

Also, the service signaling message according to the embodiment of FIG. 37 may include broadcast service channel number information associated with a service which is signaled. The associated broadcast service channel number information may be a channel_number field.

Also, the service signaling message according to the embodiment of FIG. 37 may include data necessary for the broadcasting receiving apparatus to acquire a timebase or a signaling message according to transport modes to be described below. The data for acquiring the timebase or the signaling message may be a bootstrap( ) field.

The above-described transport mode may be at least one of a timebase transport mode and a signaling transport mode. The timebase transport mode may be a transport mode for a timebase including metadata for a timeline used by a broadcast service. The timeline is a series of time information for media content. Specifically, the timeline may be a series of reference time which are references for media content presentation. The information for the timebase transport mode may be a timebase_transport_mode field.

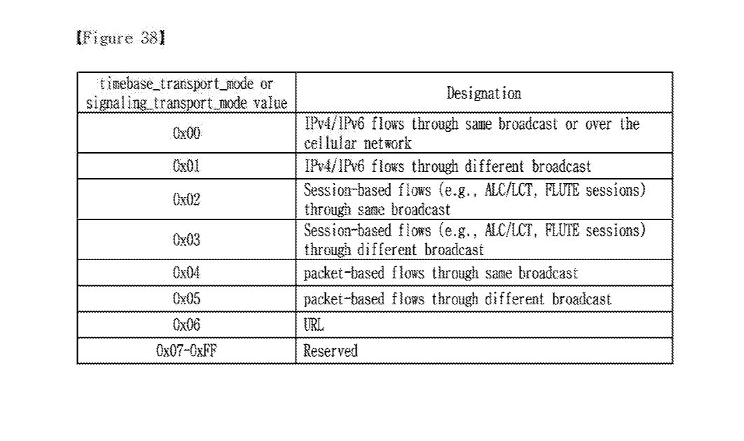

Also, the signaling transport mode may be a mode for transmitting a signaling message used in a broadcast service. The information for the signaling transport mode may be a signaling_transport_mode mode. Content indicated by a value possessed by each of the fields in FIG. 38 will be described below.

FIG. 38 illustrates content meant by a value indicated by a timebase_transport_mode field and a signaling_transport_mode field in a service signaling message, according to an embodiment of the present invention.

The timebase transport mode may include a mode in which the broadcasting receiving apparatus 100 acquires a timebase of a broadcast service through an IP datagram in the same broadcast stream. According to the embodiment of FIG. 38, when the timebase_transport_mode field has a value of 0x00, the timebase_transport_mode field may indicate that the broadcasting receiving apparatus can acquire a timebase of a broadcast service through IP datagram in the same broadcast stream.

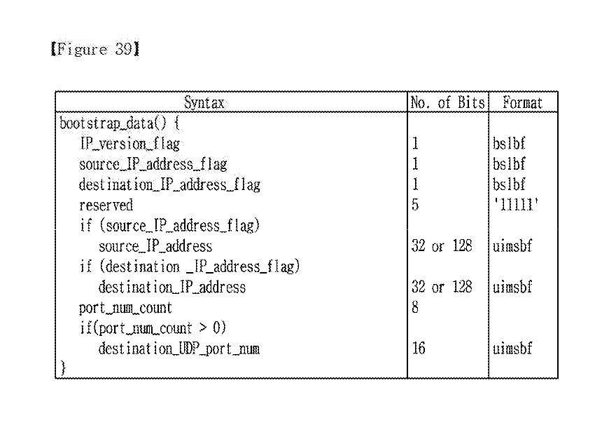

Also, the signaling transport mode may include a mode in which the broadcasting receiving apparatus 100 acquires a signaling message used in a broadcast service through an IP datagram in the same broadcast stream. According to another embodiment of FIG. 38, when the signaling_transport_mode field has a value of 0x00, the signaling_transport_mode field may indicate that the broadcasting receiving apparatus can acquire a signaling message used in a broadcast service through an IP datagram in the same broadcast stream. The same broadcast stream may be the same broadcast stream as a broadcast stream through which the broadcasting receiving apparatus currently receives a service signaling message. Also, the IP datagram may be a transmission unit which is formed by encapsulating a component constituting a broadcast service or content according to the Internet protocol. In this case, the bootstrap( ) field for the timebase and the signaling message may comply with the syntax illustrated in FIG. 39. The syntax illustrated in FIG. 39 may be expressed in the format of XML.

FIG. 39 illustrates a syntax of the bootstrap( ) field when the timebase_transport_mode field and the signaling_transport_mode field have a value of 0x00, according to an embodiment of the present invention.

In the embodiment of FIG. 39, bootstrap data may include information about an IP address format of an IP datagram including a timebase or a signaling message. The information about the IP address format may be an IP_version_flag field. The information about the IP address format may indicate that the IP address format of the IP datagram is IPv4. According to an embodiment, when the information about the IP address format is 0, the information about the IP address format may indicate that the IP address format of the IP datagram is IPv4. The information about the IP address format may indicate that the IP address format of the IP datagram is IPv6. According to another embodiment, when the information about the IP address format is 0, the information about the IP address format may indicate that the IP address format of the IP datagram is IPv6.

In the embodiment of FIG. 39, the bootstrap data may include information indicating whether an IP datagram including a timebase or a signaling message includes a source IP address. In this case, the source IP address may be a source address of the IP datagram. The information indicating whether the IP datagram includes a source IP address may be a source_IP_address_flag field. In an embodiment, when the source_IP_address_flag field is 1, it may indicate that the IP datagram includes a source IP address.

In the embodiment of FIG. 39, the bootstrap data may include information indicating whether an IP datagram including a timebase or a signaling message includes a destination IP address. In this case, the destination IP address may be a destination address of the IP datagram. The information indicating whether the IP datagram includes a destination IP address may be a destination_IP_address_flag field. In an embodiment, when the destination_IP_address_flag field is 1, it may indicate that the IP datagram includes a destination IP address.

In the embodiment of FIG. 39, bootstrap data may include source IP address information of an IP datagram including a timebase or a signaling message. The source IP address information may be a source_IP_address field.

In the embodiment of FIG. 39, bootstrap data may include destination IP address information of an IP datagram including a timebase or a signaling message. The destination IP address information may be a destination_IP_address field.

In the embodiment of FIG. 39, bootstrap data may include information indicating the number of flow ports of an IP datagram including a timebase or a signaling message. In this case, the ports may be channels for receiving the flows of the IP datagram. The information indicating the number of user datagram protocol (UDP) ports of the IP datagram may be a port_num_count field.

In the embodiment of FIG. 39, the bootstrap data may include information indicating a UDP port number of an IP datagram including a timebase or a signaling message. The UDP is a communication protocol using a unidirectional communication scheme in which information is transmitted via Internet uni-directionally, not bi-directionally.

Referring back to FIG. 38, details will be described.

The timebase transport mode may be a mode for acquiring a timebase of a broadcast service through an IP datagram in another broadcast stream. According to another embodiment of FIG. 38, when the timebase_transport_mode field has a value of 0x01, the timebase_transport_mode field may indicate that it is possible to acquire a timebase of a broadcast service through an IP datagram in another broadcast stream The another broadcast stream may be a broadcast stream different from a broadcast stream through which a current service signaling message is received.

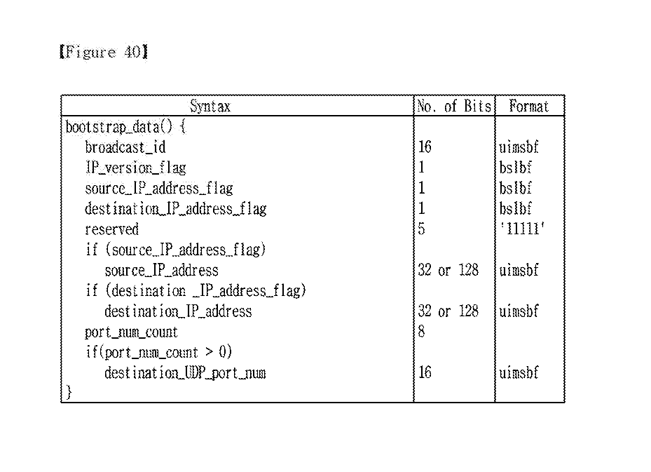

Also, the signaling transport mode may include a mode in which the broadcasting receiving apparatus 100 acquires a signaling message used in a broadcast service through an IP datagram in another broadcast stream. According to another embodiment of FIG. 38, when the signaling_transport_mode field has a value of 0x01, the signaling_transport_mode field may indicate that it is possible to acquire a signaling message used in a broadcast service through an IP datagram in another broadcast stream. In this case, the bootstrap( ) field for the timebase and the signaling message may comply with the syntax illustrated in FIG. 40. The syntax illustrated in FIG. 40 may be expressed in the format of XML.

Also, bootstrap data according to the embodiment of FIG. 40 may include identifier information of a broadcaster which transmits the signaling message. Specifically, the bootstrap data may include unique identifier information of a specific broadcaster which transmits a signaling message through a specific frequency or a transmission frame. The identifier information of a broadcaster may be a broadcasting_id field. Also, the identifier information of a broadcaster may be identifier information of a transport stream for transmitting a broadcast service.

Referring back to FIG. 38, details will be described.

The timebase transport mode may include a mode in which the broadcasting receiving apparatus 100 acquires a timebase through a session-based flow in the same broadcast stream.

According to the embodiment of FIG. 38, when the timebase_transport_mode field has a value of 0x02, it may indicate that it is possible to acquire a timebase of a broadcast service through a session-based flow in the same broadcast stream. Furthermore, the signaling transport mode may include a mode in which the broadcasting receiving apparatus 100 acquires a signaling message through a session-based flow in the same broadcast stream. When the signaling_transport_mode field has a value of 0x02, it may indicate that it is possible to acquire a signaling message used in a broadcast service through an application layer transport session-based flow in the same broadcast stream. In this case, the application layer transport session-based flow may be one of an Asynchronous Layered Coding (ALC)/Layered Coding Transport (LCT) session and a File Delivery over Unidirectional Transport (FLUTE) session.

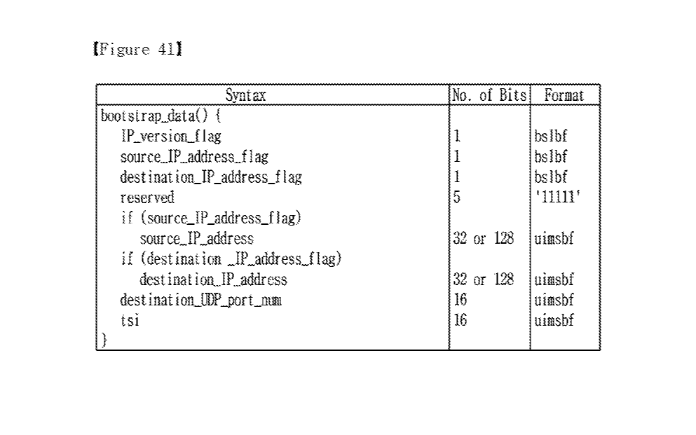

In this case, the bootstrap( ) field for the timebase and the signaling message may comply with the syntax illustrated in FIG. 41. The syntax illustrated in FIG. 41 may be expressed in the format of XML.

The bootstrap data according to the embodiment of FIG. 41 may include identifier (transport session identifier) information of the application layer transport session for transmitting an application layer transport packet including a timebase or a signaling message. In this case, the session for transmitting the transport session may be one of an ALC/LCT session and a FLUTE session. The identifier information of the application layer transport session may be a tsi field.

Referring back to FIG. 38, details will be described.

The timebase transport mode may include a mode in which the broadcasting receiving apparatus 100 acquires a timebase through a session-based flow in another broadcast stream. According to the embodiment of FIG. 38, when the timebase_transport_mode field has a value of 0x03, it may indicate that it is possible to acquire a timebase of a broadcast service through a session-based flow in another broadcast stream. Furthermore, the signaling transport mode may include a mode in which the broadcasting receiving apparatus 100 acquires a signaling message through a session-based flow in the same broadcast stream. When the signaling_transport_mode field has a value of 0x02, it may indicate that it is possible to acquire a signaling message used in a broadcast service through an application layer transport session-based flow in another broadcast stream. In this case, the application layer transport session-based flow may be one of an ALC/LCT session and an FLUTE session.

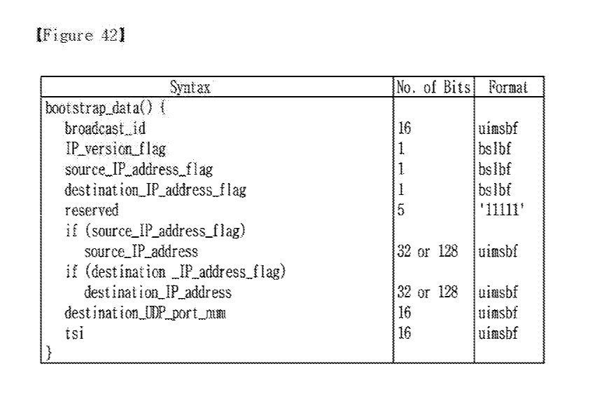

In this case, the bootstrap( ) field for the timebase and the signaling message may comply with the syntax illustrated in FIG. 42. The syntax illustrated in FIG. 42 may be expressed in the format of XML.

Also, the bootstrap data according to the embodiment of FIG. 42 may include identifier information of a broadcaster which transmits a signaling message. Specifically, the bootstrap data may include unique identifier information of a specific broadcaster which transmits the signaling message through a specific frequency or a transmission frame. The identifier information of a broadcaster may be a broadcasting_id field. Also, the identifier information of a broadcaster may be identifier information of a transport stream of a broadcast service.

Referring back to FIG. 38, details will be described.

The timebase transport mode may include a mode in which the broadcasting receiving apparatus 100 acquires a timebase through a packet-based flow in the same broadcast stream. According to the embodiment of FIG. 38, when the timebase_transport_mode field has a value of 0x04, it may indicate that it is possible to acquire a timebase of a broadcast service through a packet-based flow in the same broadcast stream. In this case, the packet-based flow may be an MPEG media transport (MMT) packet flow.

Furthermore, the signaling transport mode may include a mode in which the broadcasting receiving apparatus 100 acquires a signaling message through a packet-based flow in the same broadcast stream. When the signaling_transport_mode field has a value of 0x04, it may indicate that it is possible to acquire a signaling message used in a broadcast service through a packet-based flow in the same broadcast stream. In this case, the packet-based flow may be an MMT packet flow.

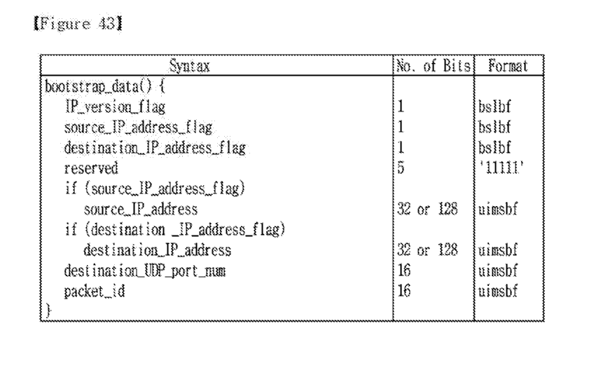

In this case, the bootstrap( ) field for the timebase and the signaling message may comply with the syntax illustrated in FIG. 43. The syntax illustrated in FIG. 43 may be expressed in the format of XML.

The bootstrap data according to the embodiment of FIG. 43 may include identification information of a transport packet for transmitting a timebase or a signaling message. The identifier information of the transport packet may be a packet_id field. The identifier information of the transport packet may be identifier information of an MPEG-2 transport stream.

Referring back to FIG. 38, details will be described.

The timebase transport mode may include a mode in which the broadcasting receiving apparatus 100 acquires a timebase through a packet-based flow in another broadcast stream.

According to the embodiment of FIG. 38, when the timebase_transport_mode field has a value of 0x05, it may indicate that it is possible to acquire a timebase of a broadcast service through a packet-based flow in another broadcast stream. In this case, the packet-based flow may be an MPEG media transport flow.

Furthermore, the signaling transport mode may include a mode in which the broadcasting receiving apparatus 100 acquires a signaling message through a packet-based flow in another broadcast stream. When the signaling_transport_mode field has a value of 0x05, it may indicate that it is possible to acquire a signaling message used in a broadcast service through a packet-based flow in another broadcast stream. In this case, the packet-based flow may be an MMT packet flow.

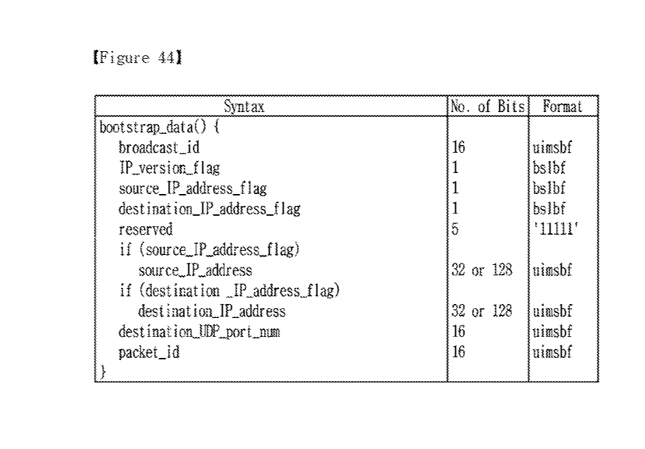

In this case, the bootstrap( ) field for the timebase and the signaling message may comply with the syntax illustrated in FIG. 44. The syntax illustrated in FIG. 44 may be expressed in the format of XML.

The bootstrap data according to the embodiment of FIG. 44 may include identifier information of a broadcaster which transmits a signaling message. Specifically, the bootstrap data may include unique identifier information of a specific broadcaster which transmits the signaling message through a specific frequency or a transmission frame. The identifier information of a broadcaster may be a broadcasting id field. Also, the identifier information of a broadcaster may be identifier information of a transport stream of a broadcast service.

The bootstrap data according to the embodiment of FIG. 44 may include identification information of a transport packet for transmitting a timebase or a signaling message. The identifier information of the transport packet may be a packet_id field. The identifier information of the transport packet may be identifier information of an MPEG-2 transport stream.

Referring back to FIG. 38, details will be described.

The timebase transport mode may include a mode in which the broadcasting receiving apparatus 100 acquires a timebase through a URL.

According to the embodiment of FIG. 38, when the timebase_transport_mode field has a value of 0x06, it may indicate that it is possible to acquire a timebase of a broadcast service through a URL. Furthermore, the signaling transport mode may include a mode for acquiring a signaling message through a URL. When the signaling_transport_mode field has a value of 0x06, it may indicate that it is possible to acquire a signaling message used in a broadcast service through an identifier for identifying an address at which it is possible to receive the signaling message. In this case, the identifier for identifying an address at which it is possible to receive the signaling message used in the broadcast service may be an URL.

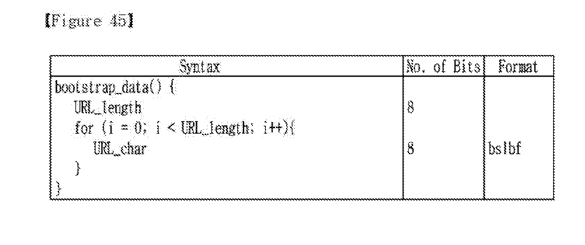

In this case, the bootstrap( ) field for the timebase and the signaling message may comply with the syntax illustrated in FIG. 45. The syntax illustrated in FIG. 45 may be expressed in the format of XML.

The bootstrap data according to the embodiment of FIG. 45 may include length information of the URL at which it is possible to download a timebase or a signaling message of a broadcast service. The URL length, information may be a URL_length field.

The bootstrap data according to the embodiment of FIG. 45 may include actual data of the URL at which it is possible to download a timebase or a signaling message of a broadcast service. The actual data of the URL may be a URL_char field.

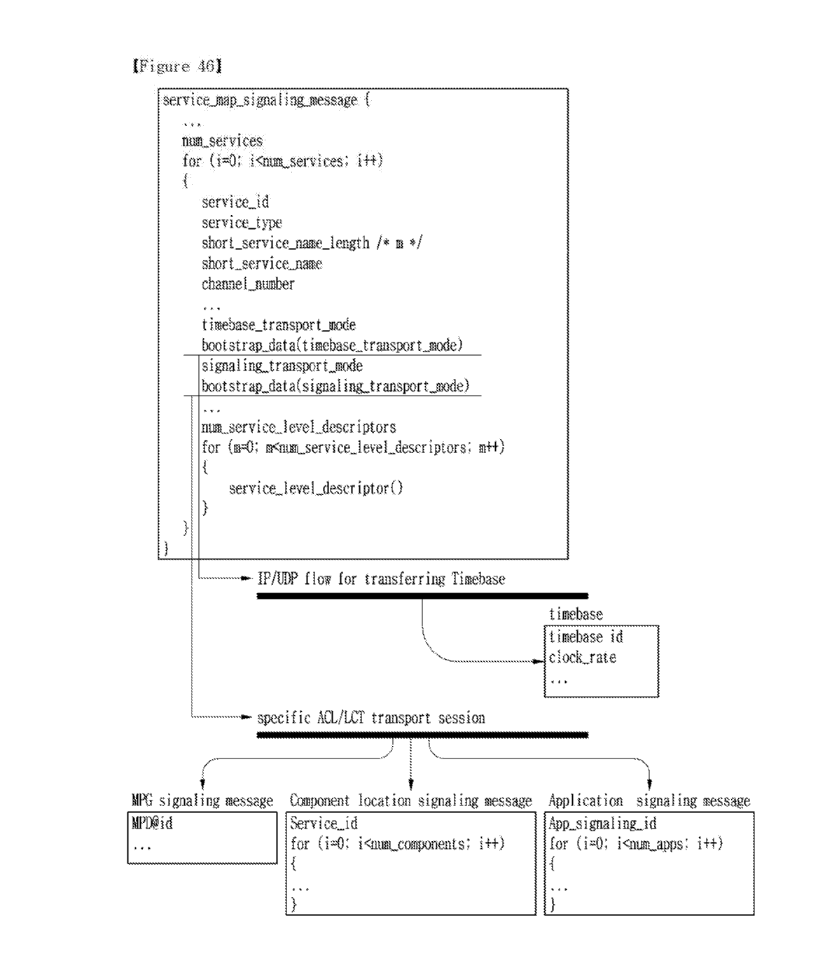

FIG. 46 illustrates a process of acquiring a timebase and a signaling message according to the embodiments of FIGS. 37 to 45.

As illustrated in FIG. 46, the broadcasting receiving apparatus 100 according to an embodiment of the present invention may acquire a timebase through a packet-based transport protocol. Specifically, the broadcasting receiving apparatus 100 may acquire the timebase through an IP/UDP flow by using the service signaling message. Also, the broadcasting receiving apparatus 100 according to the present embodiment of the present invention may acquire a service-related signaling message through a session-based transport protocol. Specifically, the broadcasting receiving apparatus 100 may acquire a service-related signaling message through an ALC/LCT transport session.

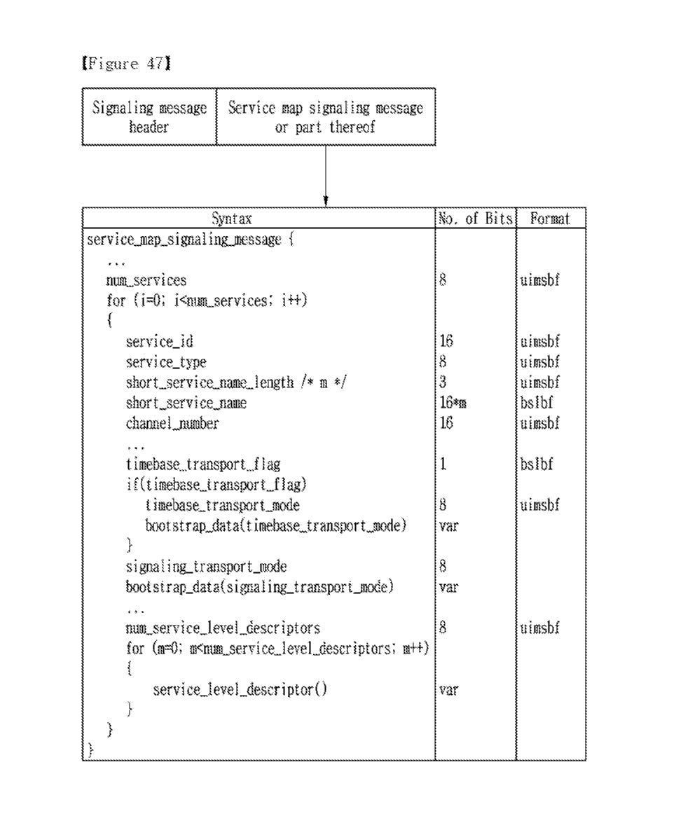

FIG. 47 illustrates a configuration of a broadcast service signaling message in a future broadcast system, according to an embodiment of the present invention. The broadcast service signaling message according to the present embodiment of the present invention is a service signaling method for allowing the broadcasting receiving apparatus to receive a broadcast service and content from the future broadcasting system. The broadcast service signaling method according to the embodiment of FIG. 47 may be based on the configuration of the signaling message illustrated in FIG. 36. The broadcast service signaling message according to the embodiment of FIG. 47 may be transmitted via a service signaling channel. In this case, the service signaling channel may be a sort of physical layer pipe for directly transmitting service signaling information for broadcast service scan without passing through another layer.

In a specific embodiment, the signaling channel may be at least one of a fast information channel (FIC), a low layer signaling, and an application transport session. Also, the broadcast service signaling message according to the embodiment of FIG. 47 may be expressed in the format of XML.

The service signaling message according to the embodiment of FIG. 47 may include information indicating whether the service signaling message includes information necessary to acquire a timebase. In this case, the timebase may include metadata for a timeline used in a broadcast service. The timeline is a series of time information for media content. The information indicating whether the information necessary to acquire the timebase may be a timeline_transport_flag field. In an embodiment, when the timeline_transport_flag field has a value of 1, it may indicate that the service signaling message includes information for timebase transmission.

The service signaling message according to the embodiment of FIG. 47 may include data necessary for the broadcasting receiving apparatus to acquire a timebase or a signaling message according to transport modes to be described below. The data necessary to acquire a timebase or a signaling message may be a bootstrap_data( ) field.

The above-described transport mode may be at least one of a timebase transport mode and a signaling transport mode. The timebase transport mode may be a transport mode for a timebase including metadata for a timeline used by a broadcast service. The information for the timebase transport mode may be a timebase_transport_mode field.

Also, the signaling transport mode may be a mode for transmitting a signaling message used in a broadcast service. The information for the signaling transport mode may be a signaling_transport_mode mode.

Also, the bootstrap_data( ) field according to the timebase_transport_mode field and the signaling_transport_mode field may have the same meaning as described above.

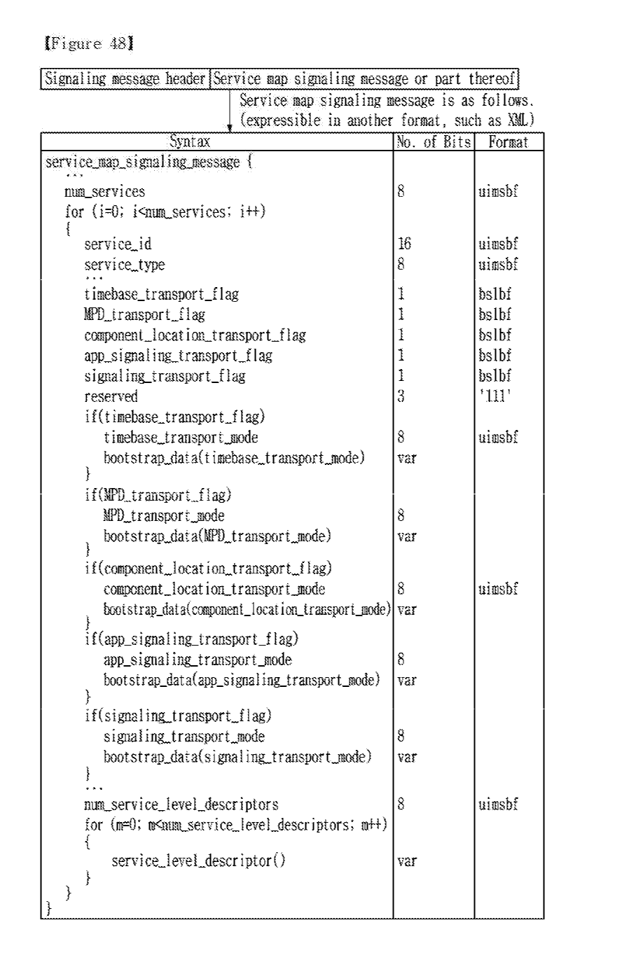

FIG. 48 illustrates a configuration of a broadcast service signaling message in a future broadcast system, according to an embodiment of the present invention. The broadcast service signaling message according to the present embodiment of the present invention is a service signaling method for allowing the broadcasting receiving apparatus to receive a broadcast service and content from the future broadcasting system. The broadcast service signaling method according to the embodiment of FIG. 48 may be based on the configuration of the signaling message illustrated in FIG. 36. The broadcast service signaling message according to the embodiment of FIG. 48 may be transmitted via a service signaling channel. In this case, the service signaling channel, may be a sort of physical layer pipe for directly transmitting service signaling information for broadcast service scan without passing through another layer. In a specific embodiment, the signaling channel may be at least one of a fast information channel (FIC) and low layer signaling (LLS) and an application layer transport session. Also, the broadcast service signaling message according to the embodiment of FIG. 48 may be expressed in the format of XML.

The service signaling message according to the embodiment of FIG. 48 may indicate whether the service signaling message includes information necessary to acquire a timebase. In this case, the timebase may include metadata for a timeline used in a broadcast service. The timeline is a series of time information for media content. The information indicating whether the information necessary to acquire a timebase may be a timeline_transport_flag field. In an embodiment, when the timeline_transport_flag field has a value of 1, it may indicate that the service signaling message includes information for timebase transmission.

The service signaling message according to the embodiment of FIG. 48 may indicate whether the service signaling message includes information necessary to acquire a signaling message. In this case, the signaling message may be a signaling message associated with media presentation data (MPD) or an MPD URL used in the broadcast service. The information indicating whether the information necessary to acquire a signaling message may be an MPD_transport_flag field. In an embodiment, when the MPD_transport_flag field has a value of 1, it may indicate that the service signaling message includes information related with transmission of a signaling message associated with MPD or an MPD URL. An adaptive media streaming based on HTTP may be referred to as dynamic adaptive streaming over HTTP. Detailed information which allows a broadcasting receiving apparatus to acquire segments constituting a broadcast service and content in adaptive media streaming. The MPD may be expressed in the format of XML. An MPD URL-related signaling message may include information about an address at which it is possible to acquire the MPD.

Also, the service signaling message according to the embodiment of FIG. 48 may indicate whether the service signaling message includes path information for acquisition of component data. In this case, the component may be one unit of content data for providing a broadcast service. The information indicating whether the service signaling message includes path information for acquisition of component data may be a component_location_transport_flag field. In an embodiment, when the component_location_transport_flag field has a value of 1, the component_location_transport_flag field may indicate that the service signaling message includes path information for acquisition of component data.

Also, the service signaling message according to the embodiment of FIG. 48 may indicate whether information necessary to acquire an application-related signaling message is included therein. The information indicating whether information necessary to acquire an application-related signaling message is included therein may be an app_signaling_transport_flag field. In an embodiment, when the app_signaling_transport_flag field has a value of 1, the app_signaling_transport_flag field may indicate that the service signaling message includes path information for acquisition of component data.

Also, the service signaling message according to the embodiment of FIG. 48 may indicate whether signaling message transport-related information is included therein. The information indicating whether signaling message transport-related information is included therein may be a signaling_transport_flag field. In an embodiment, when the signaling_transport_flag field has a value of 1, the signaling_transport_flag field may indicate that the service signaling message includes signaling message transport-related information. Also, when the service signaling message does not include the MPD-related signaling, component acquisition path information, and the application-related signaling information which are described above, the broadcasting receiving apparatus may acquire the MPD-related signaling, the component acquisition path information, and the application-related signaling information via a signaling message transmission path.

The service signaling message according to the embodiment of FIG. 48 may indicate a mode for transmitting a timebase used in a broadcast service. The information about the mode for transmitting a timebase may be a timebase_transport_mode field.

The service signaling message according to the embodiment of FIG. 48 may indicate a mode for transmitting an MPD-related or MPD URL-related signaling message used in a broadcast service. Information about the mode for transmitting an MPD-related or MPD URL-related signaling message may be an MPD_transport_mode field.

The service signaling message according to the embodiment of FIG. 48 may indicate a mode for transmitting a component location signaling message including a path for acquisition of component data used in a broadcast service. Information about the mode for transmitting a component location signaling message including a path for acquisition of component data may be a component_location_transport_mode field.

The service signaling message according to the embodiment of FIG. 48 may indicate a mode for transmitting an application-related signaling message used in a broadcast service. Information about the mode for transmitting an application-related signaling message may be an app_signaling_transport_mode field.

The service signaling message according to the embodiment of FIG. 48 may indicate a mode for transmitting a service-related signaling message used in a broadcast service. Information about the mode for transmitting a service-related signaling message may be a signaling_transport_mode field.

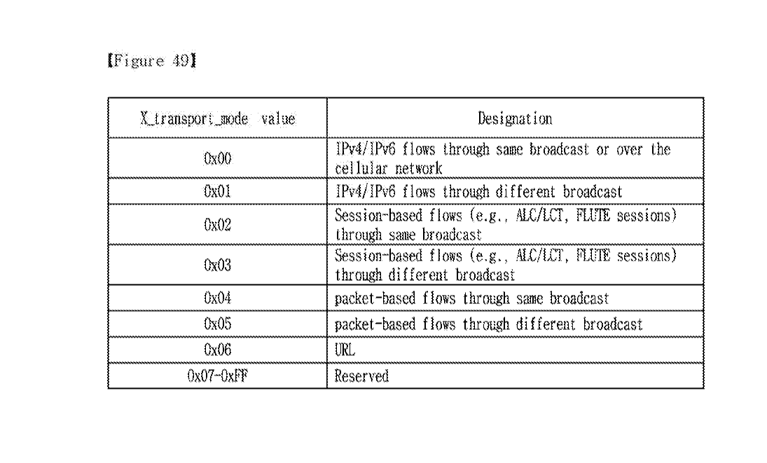

The meaning of values, represented by the timebase_transport_mode field, the MPD_transport_mode field, the component_location_transport_mode field, app_signaling_transport_mode field, and the signaling_transport_mode field, will be described below with reference to FIG. 49.

FIG. 49 illustrates the meaning of values represented by the transport modes described with reference to FIG. 48. In FIG. 49, X_transport_mode may include timebase_transport_mode, MPD_transport_mode, component_location_transport_mode, app_signaling_transport_mode, and signaling_transport_mode. Specific meaning of the values represented by the transport modes are the same as described with reference to FIG. 38. Referring back to FIG. 48, details will be described.

The service signaling message according to the embodiment of FIG. 48 may include information for the broadcasting receiving apparatus to acquire a timebase or a signaling message according to values represented by the modes of FIG. 49. The information necessary to acquire the timebase or the signaling message may be a bootstrap_data( ) field. Specifically, information included in the bootstrap_data( ) field may be the same as described with reference to FIGS. 39 to 45.

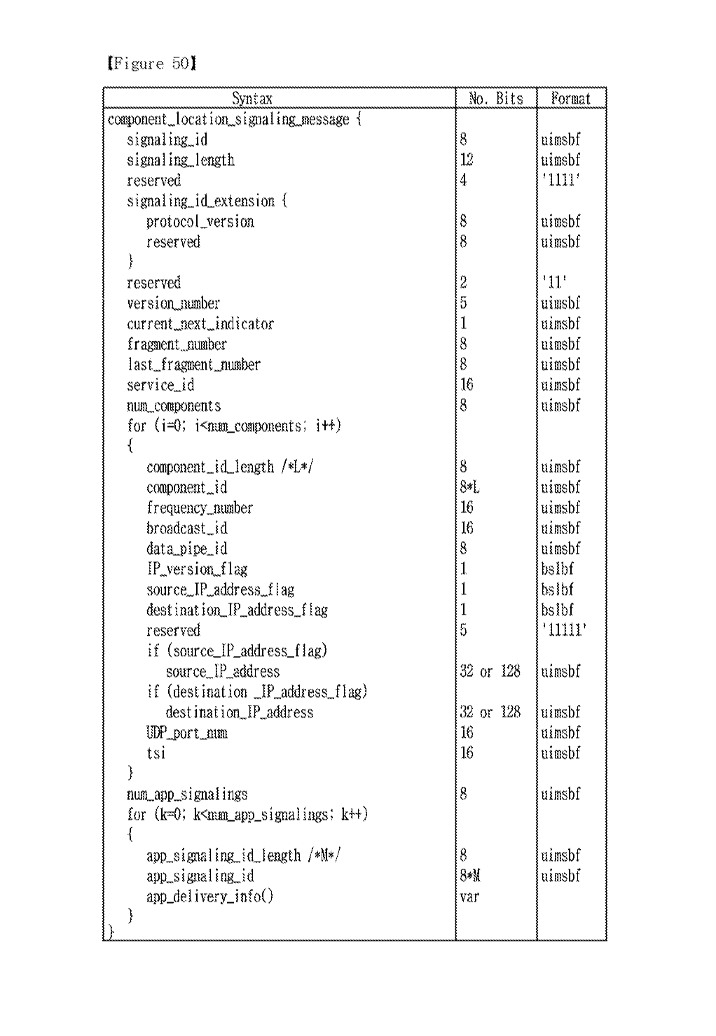

FIG. 50 illustrates a configuration of a signaling message for signaling a component data acquisition path of a broadcast service in a future broadcasting system. A single broadcast service in the future broadcasting system may include one or more components. Based on the signaling message according to the embodiment of FIG. 50, the broadcasting receiving apparatus may acquire information about a path for acquisition of component data and a relevant application from a broadcast stream. In this case, the signaling message according to the embodiment of FIG. 50 may be expressed in the format of XML.

The signaling message according to the embodiment of FIG. 50 may include information for identifying whether the signaling message is a message for signaling a component location. The information for identifying whether the signaling message is a message for signaling a component location may be a signaling_id field. In a specific embodiment, the signaling_id field may be eight bits.

The signaling message according to the embodiment of FIG. 50 may include extension information for identifying whether the signaling message is a message for signaling a component location. In this case, the extension information may include a protocol version of a message for signaling the component location. The extension information may be a signaling_id_extension field.

Also, the signaling message header according to the embodiment of FIG. 50 may include version information of the signaling message. In this case, the version information may indicate that content of the message for signaling the component location is changed. The version information may be a version_number field.

Also, the signaling message according to the embodiment of FIG. 50 may include identifier information of an associated broadcast service. The identifier information of the associated broadcast service may be a service_id field.

Also, the signaling message according to the embodiment of FIG. 50 may include the number of components associated with a broadcast service. The number of associated components may be a num_component field.

Also, the signaling message according to the embodiment of FIG. 50 may include an identifier of each component. For example, the component identifier may be configured by combining MPEG DASH- [symbol] MPD@id, period@id, and representation@id. The identifier information of each component may be a component_id field.

Also, the signaling message according to the embodiment of FIG. 50 may include a length of a component_id field. The length information of the component_id field may be a component_id_length field.

Also, the signaling message according to the embodiment of FIG. 50 may include frequency information indicating a frequency at which it is possible to acquire component data. The component data may include a DASH segment. In this case, the frequency information at which it is possible to acquire the component data may be a frequency_number field.

Also, the signaling message according to the embodiment of FIG. 50 may include a unique identifier of a broadcaster. The broadcaster may transmit the component data through a specific frequency or a transmission frame to be transmitted. Information about the unique identifier of the broadcaster may be a broadcast_id field.

Also, the signaling message according to the embodiment of FIG. 50 may include an identifier of a physical layer pipe for transmitting component data. In this case, information about the identifier of a physical layer pipe for transmitting component data may be a datapipe_id field.

Also, the signaling message according to the embodiment of FIG. 50 may include an IP address format of an IP datagram including component data. Information about the IP address format of the IP datagram may be an IP_version_flag field. In a specific embodiment, when the IP_version_flag field has a field value of 0 indicates an IPv4 format, or when the IP_version_flag field has a field value of 1 indicates an IPv6 format.

Also, the signaling message according to the embodiment of FIG. 50 may include information indicating whether a source IP datagram including component data includes a source IP address. The information indicating whether an IP datagram including component data includes a source IP address may be a source_IP_address_flag field. In an embodiment, when the source IP address_flag field has a value of 1, it indicates that the IP datagram includes a source IP address

Also, the signaling message according to the embodiment of FIG. 50 may include information indicating whether a destination IP datagram including component data includes a destination IP address. The information indicating whether the IP datagram includes a destination IP address may be a destination_IP_address_flag field. In an embodiment, when the destination_IP_address_flag field has a value of 1, it indicate that the IP datagram includes a destination IP address.

Also, the signaling message according to the embodiment of FIG. 50 may include source IP address information of an IP datagram including component data. In an embodiment, when the source_IP_address_flag field has a value of 1, the signaling message may include the source IP address information. The source IP address information may be a source_IP_address field.

Also, the signaling message according to the embodiment of FIG. 50 may include destination IP address information of the IP datagram including component data. In an embodiment, when the destination_IP_address_flag field has a value of 1, the signaling message may include the destination IP address information. The destination IP address information may be a destination_IP_address field.

Also, the signaling message according to the embodiment of FIG. 50 may include UDP port number information of the IP datagram including component data. The UDP port number information may be a UDP_port_num field.

The signaling message according to the embodiment of FIG. 50 may include identifier (transport session identifier) information of an application layer transport session for transmitting a transport packet including the component data. The session for transmitting the transport session may be at least one of, an ALC/LCT session and a FLUTE session. The identifier information of a session may be a tsi field.

Also, the signaling message according to the embodiment of FIG. 50 may include identifier information a transport packet including component data. The identifier information of the transport packet may be a packet_id field.

Also, the signaling message according to the embodiment of FIG. 50 may include the number of application signaling messages associated with a broadcast service. In this case, the broadcast service may be a broadcast service identified by a service_id field. Information about the number of application signaling messages may be a num_app_signaling field.

Also, the signaling message header according to the embodiment of FIG. 50 may include identifier information of an application signaling message. The identifier information of an application signaling message may be an app_signaling_id field.

Also, the signaling message according to the embodiment of FIG. 50 may include length information of the app_signaling_id field. The length information of the app_signaling_id field may be an app_signaling_id_length field.

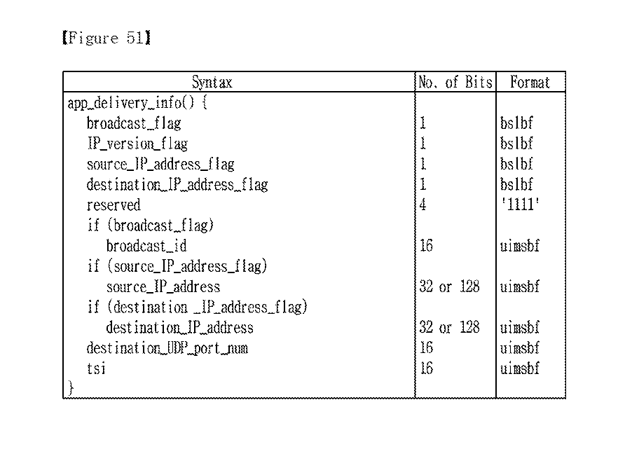

Also, the signaling message header according to the embodiment of FIG. 50 may include data about a path in which application data included in the signaling message associated with the identifier of the application signaling message can be acquired. Path information for application acquisition included in the signaling message associated with the identifier of the application signaling message may be an app_delivery_info( ) field. An embodiment of the app_delivery_info( ) field will be described below with reference to FIG. 51.

FIG. 51 illustrates a syntax an app_delivery_info( ) field, according to an embodiment of the present invention.

The data about the path in which application data included in the signaling message associated with the identifier of the application signaling message according to the embodiment of FIG. 51 can be acquired may include information about whether an application or associated data is transmitted through another broadcast stream. The information about whether an application or associated data is transmitted through another broadcast stream may be a broadcasting_flag field.

Also, the data about the path in which application data included in the signaling message associated with the identifier of the application signaling message according to the embodiment of FIG. 51 can be acquired may include an IP address format of the IP datagram including an application or associated data. Information about the IP address format of the IP datagram may be an IP_version_flag field. In an embodiment, when the IP_version_flag field has a value of 0, the IP datagram including an application or associated data may indicate that the IP datagram uses an IPv4 format and when the IP_version_flag field has a value of 1, the IP datagram including an application or associated data may indicate that the IP datagram uses an IPv4 format.

Also, the data about the path in which application data included in the signaling message associated with the identifier of the application signaling message according to the embodiment of FIG. 51 can be acquired may indicate whether the IP datagram including an application or associated data includes a source IP address. In this case, the associated data may be data necessary for execution of the application.

The information indicating whether the IP datagram including an application or associated data includes a source IP address may be a source_IP_address_flag field. In an embodiment, when the source_IP_address_flag field is 1, it may indicate that the IP datagram includes a source IP address.

Also, the data about the path in which application data included in the signaling message associated with the identifier of the application signaling message according to the embodiment of FIG. 51 can be acquired may include information about whether the IP datagram including an application or associated data includes a source IP address.

The information about whether the IP datagram including an application or associated data includes a destination IP address may be a destination_IP_address_flag field. In an embodiment, when the destination_IP_address_flag field is 1, it may indicate that the IP datagram includes a destination IP address.

Also, the data about the path in which application data included in the signaling message associated with the identifier of the application signaling message according to the embodiment of FIG. 51 can be acquired may include a unique identifier of a broadcaster which transmits the application or the associated data through a specific frequency or a transmission frame which is transmitted.

In other words, the data about the path in which application data included in the signaling message associated with the identifier of the application signaling message according to the embodiment of FIG. 51 can be acquired may include an identifier of a broadcast service transport stream. Information about the unique identifier of the broadcaster which transmits the application or the associated data through the specific frequency or the transmission frame which is transmitted may be a broadcast_id field.

Also, the data about the path in which application data included in the signaling message associated with the identifier of the application signaling message according to the embodiment of FIG. 51 can be acquired may include a source IP address of the IP datagram including an application or associated data, when the source_IP_address_flag field has a value of 1. Information about the source IP address of the IP datagram including the application or the associated data may be a source_IP_address field.

Also, the data about the path in which application data included in the signaling message associated with the identifier of the application signaling message according to the embodiment of FIG. 51 can be acquired may include a destination IP address of the IP datagram including an application or associated data, when the destination_IP_address_flag field has a value of 1. Information about the destination IP address of the IP datagram including the application or the associated data may be a destination IP address field.

Also, the data about the path in which application data included in the signaling message associated with the identifier of the application signaling message according to the embodiment of FIG. 51 can be acquired may include the number of ports of an IP datagram flow including the application or the associated data. Information about the number of ports of the IP datagram flow including the application or the associated data may be a port_num_count field.

Also, the data about the path in which application data included in the signaling message associated with the identifier of the application signaling message according to the embodiment of FIG. 51 can be acquired may include a UDP port number of the datagram including the application or the associated data. Information about the UDP port number of the IP datagram including the application or the associated data may be a destination_UDP_port_number field.

Also, the data about the path in which application data included in the signaling message associated with the identifier of the application signaling message according to the embodiment of FIG. 51 can be acquired may include an identifier of a transport session for transmitting the application or the associated data. The transport session for transmitting the application or the associated data may be one of an ALC/LCT session and a FLUTE session. Information about the identifier of the transport session for transmitting the application or the associated data may be a tsi field.

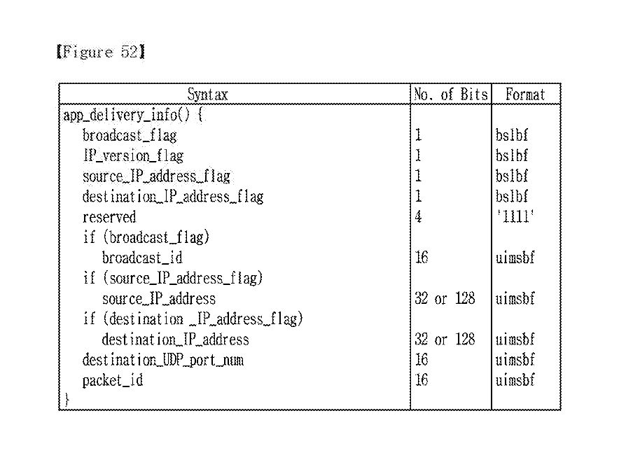

FIG. 52 illustrates a syntax of an app_delivery_info( ) field according to another embodiment of the present invention.

The data about the path in which application data included in the signaling message associated with the identifier of the application signaling message according to the embodiment of FIG. 52 can be acquired may indicate an identifier of a transport packet for transmitting the application or the associated data. The transport packet for transmitting the application or the associated data may comply with a protocol based on a packet-based transmission flow. For example, the packet-based transmission flow may include an MPEG media transport protocol. Information about the identifier of the transport packet for transmitting the application or the associated data may be a packet_id field.

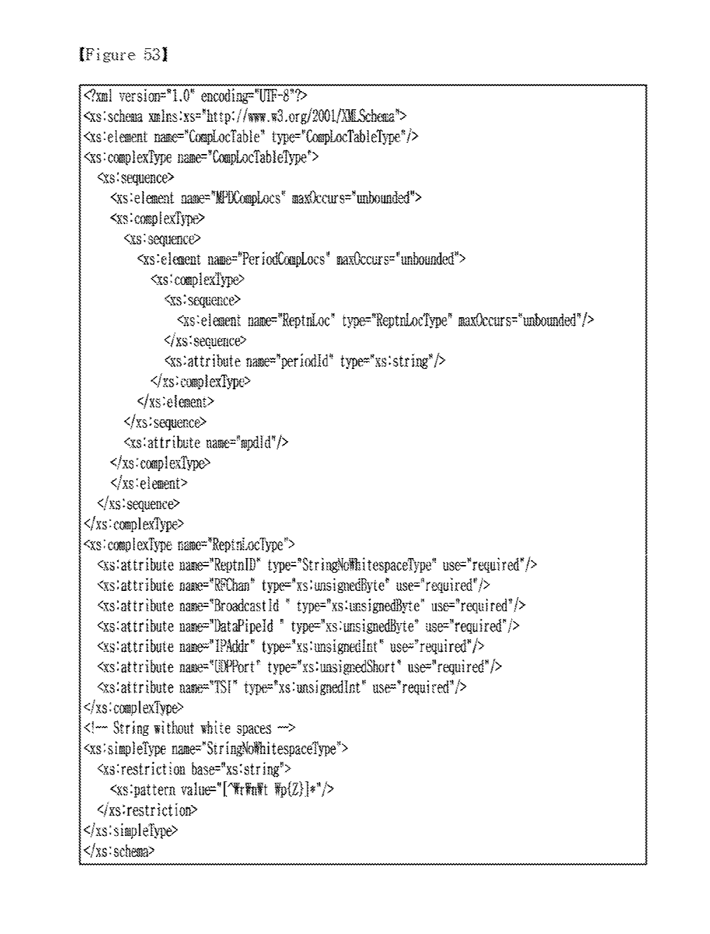

FIG. 53 illustrates component location signaling including information about a path in which one or more pieces of component data constituting a broadcast service can be acquired. Specifically, FIG. 53 illustrates information about a path in which component data including a DASH segment can be acquired, when the one or more pieces of components constituting a broadcast service are expressed by a MPEG DASH segment.

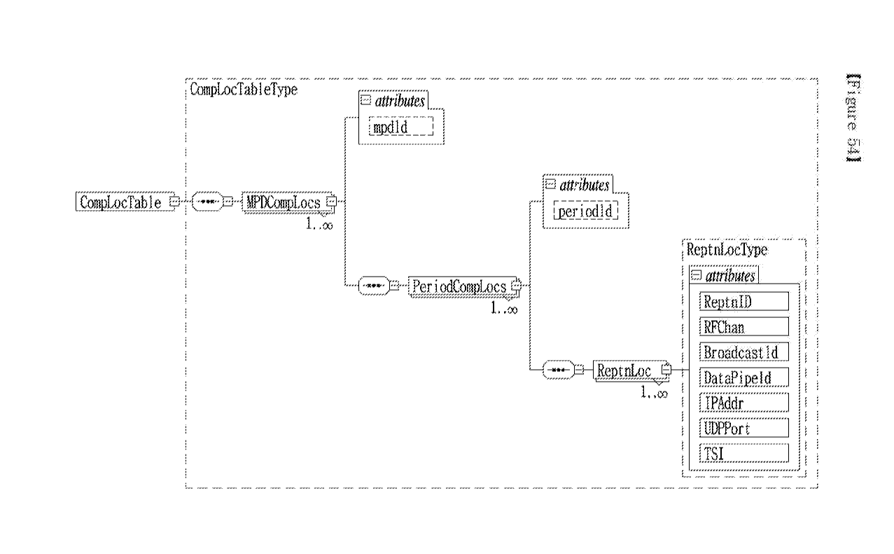

FIG. 54 illustrates a configuration of the component location signaling of FIG. 53.

The component location signaling according to the embodiment of FIG. 54 may include identifier information of an MPEG DASH MPD associated with the broadcast service. The identifier information of the MPEG DASH MPD may be an mpdip field.

Also, the component location signaling according to the embodiment of FIG. 54 may include an identifier of a period attribute in the MPEG DASH MPD indicated by the mpdip field. Information about the identifier of the period attributes in the MPEG DASH MPD may be a periodid field.

Also, the component location signaling according to the embodiment of FIG. 54 may include an identifier of a representation attribute within the period indicated by the periodid field. Information about the identifier of the representation attribute within the period may be a ReptnID field.

Also, the component location signaling according to the embodiment of FIG. 54 may include a frequency number for acquiring a DASH segment included in the representation attribute with in the period indicated by the ReptnID field. The frequency number for acquiring the DASH segment may be an RF channel number. The frequency number for acquiring the DASH segment may be an RFchan field.

Also, the component location signaling according to the embodiment of FIG. 54 may include a unique identifier of a broadcaster which transmits the DASH segment through a specific frequency or a transmission frame which is transmitted. Information about the unique identifier of a broadcaster which transmits the DASH segment may be a Broadcastingid field.

Also, the component location signaling according to the embodiment of FIG. 54 may include an identifier of a physical layer pipe for delivering the DASH segment. The physical layer pipe may be a data pipe transmitted through a physical layer. Information about an identifier of the physical layer pipe for delivering the DASH segment may be a DataPipeId field.

Also, the component location signaling according to the embodiment of FIG. 54 may include a destination IP address of an IP datagram including the DASH segment. Information about the destination IP address of the IP datagram including the DASH segment may be an IPAdd field.

Also, the component location signaling according to the embodiment of FIG. 54 may include a UDP port number of the IP datagram including the DASH segment. Information about the UDP port number of the IP datagram including the DASH segment may be a UDPPort field.

Also, the component location signaling according to the embodiment of FIG. 54 may include an identifier (transport session identifier) of a session for transmitting a transport packet including the DASH segment. The identifier of the session for transmitting the transport packet may be at least one of an ALC/LCT session and a FLUTE session. Information about the identifier of the session for transmitting the transport packet may be a TSI field.

Also, the component location signaling according to the embodiment of FIG. 54 may include an identifier of the transport packet including the DASH segment. Information about the identifier of the transport packet may be a PacketId field.

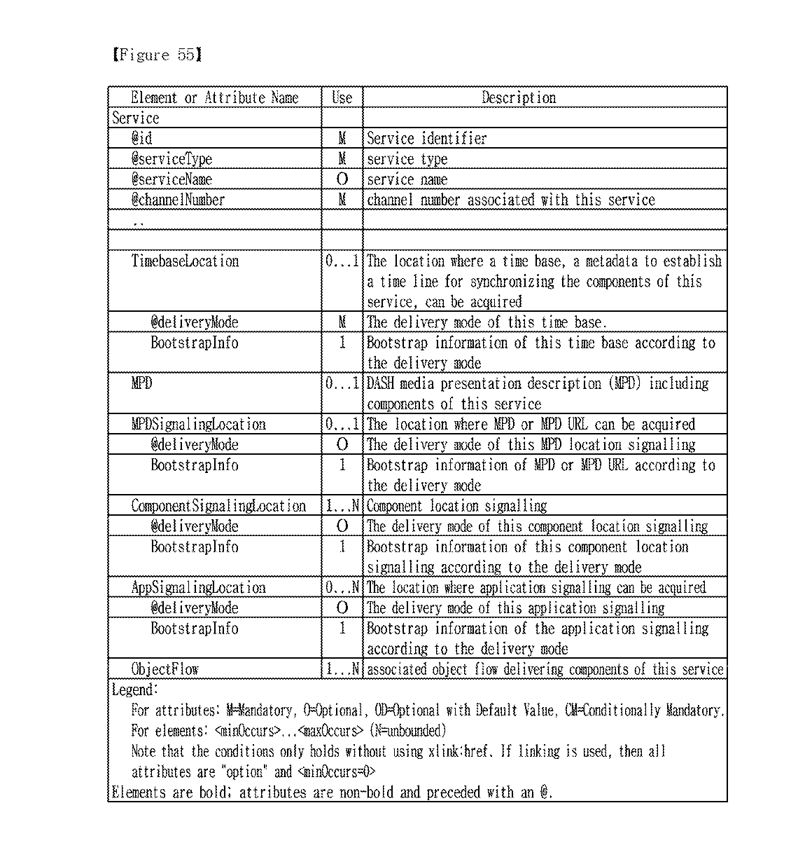

FIG. 55 illustrates another information including signaling of a broadcast service in a further broadcast system according to an embodiment of the present invention.

Among information included in the signaling of the broadcast service illustrated in FIG. 55, a bootstrapInfo element may include information for acquiring at least one of timebase, MPD/MPD URL, component signaling, and application signaling. Also, as described above, the bootstrapInfo element may include at least one of pieces of information about an IP address, a port number, an identifier of a transport session, and an identifier of an associated packet.

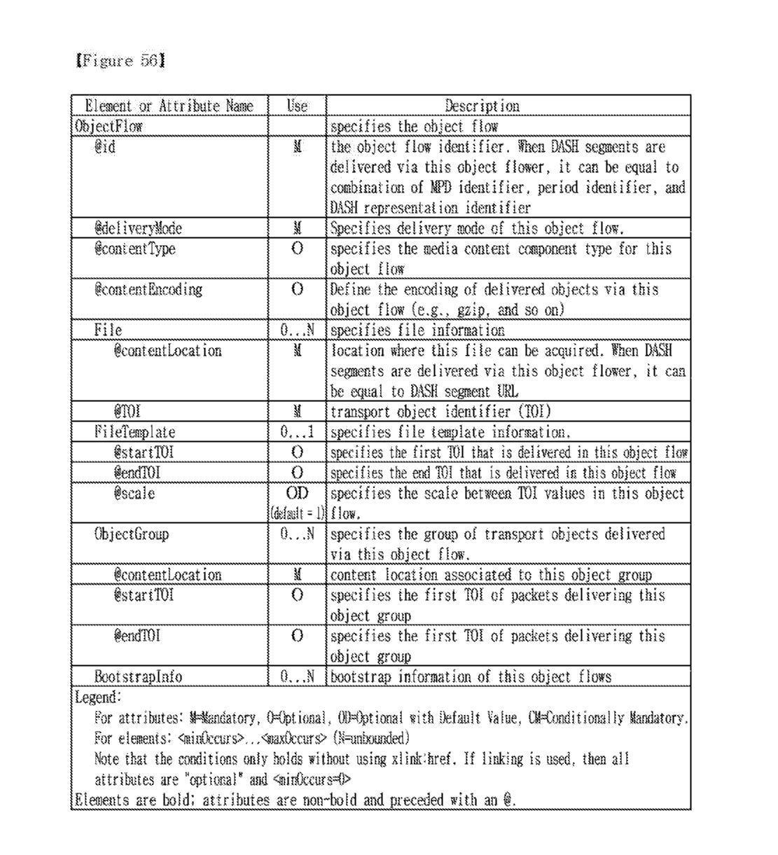

Referring to FIG. 56, an objectFlow element of information included in the signaling of the broadcast service illustrated in FIG. 55 will be described below.

FIG. 56 illustrates still another information included in signaling for an object flow. Each object flow may be a flow for transmitting one or more components constituting a service. Therefore, one service may include information about one or more object flows.

Among the information included in signaling for the object flow according to FIG. 56, a @deliveryMode element may include information about a transport mode including data delivered over the object flow.

In a first embodiment, a transport mode over the object flow may be a mode in which transmission is performed while a general file for supporting non-realtime is being transmitted. The transport mode according to the first embodiment may be a generic file delivery mode.

In a second embodiment, the transport mode over the object flow may be a data transport mode for supporting realtime streaming. For example, the transport mode according to the second embodiment may be a mode for transmitting the DASH segment. The transport mode according to the second embodiment may be a segment delivery mode.

In a third embodiment, the transport mode over the object flow may be a mode for transmitting data expressed in the form of an HTTP entity in order to support realtime streaming. The HTTP entity may be one object for transmitting HTTP-based content. The transport mode according to the third embodiment may be an HTTP entity delivery mode.

In a fourth embodiment, the transport mode over the object flow may be a mode for transmitting data configured by packets of a packet-based transport protocol. The transport mode according to the fourth embodiment may be a packet delivery mode.

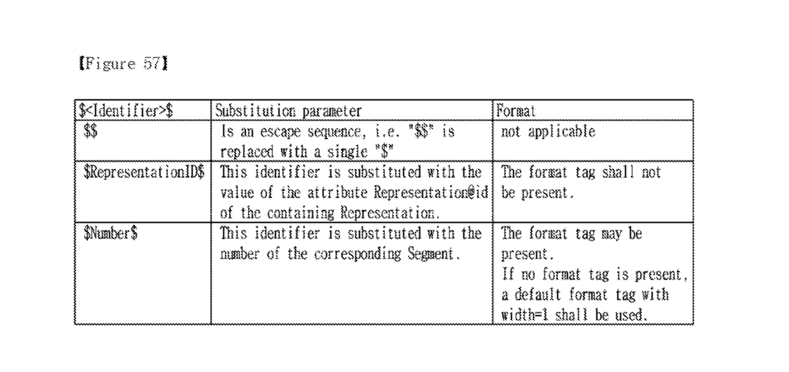

Referring to FIG. 57, a File Template element of information included in signaling for the object flow illustrated in FIG. 56 will be described below.

FIG. 57 illustrates a combination of pieces of information for expressing a file template, according to an embodiment of the present invention. The file template may be expressed by combining a Representation@id and a segment number. For example, in the case of transmitting a DASH segment, as illustrated in FIG. 57, information of content location for each file may be generated dynamically by combining the Representation@id and the segment number. As a result, the broadcasting receiving apparatus may effectively acquire a flow of a transport packet including a specific component according to content location information generated dynamically.

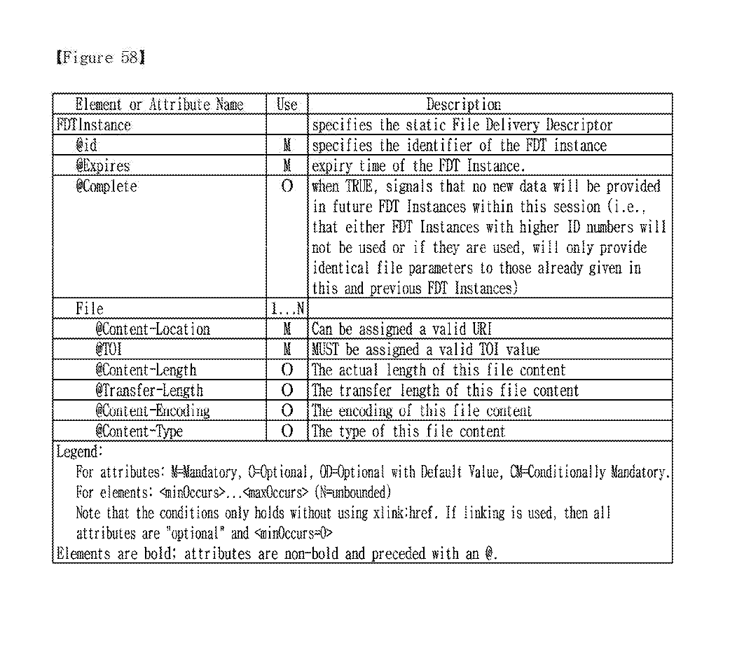

FIG. 58 illustrates another information included in signaling of a broadcast service in a future broadcast system according to an embodiment of the present invention. In the case of an existing FLUTE client, after the FLUTE client receives a file description table (FDT), the FLUTE client can receive a file according to the FDT. However, the above solution may be inappropriate to transmit and receive a file through a realtime broadcast service. In other words, a FLUTE protocol is a unidirectional transport protocol, and may be inappropriate to be applied to a realtime broadcast service. According to an embodiment of the present invention, service signaling may include FDT information.

Specifically, as illustrated in FIG. 58, an FDTInstansce element according to an embodiment of the present invention may include an @id attribute (element). The @id attribute may indicate a specific identifier of the FDTInstance. Therefore, the broadcasting receiving apparatus may identify the FDTInstance through the @id attribute and generate the FDTInstance dynamically. Also, the broadcasting receiving apparatus may receive and process realtime streaming data expressed by a file format according to the generated FDTInstance.

Also, the FDTInstansce element according to an embodiment of the present invention may include an @Expires attribute. The @Expires attribute may include information about expiry time of the FDTInstance. Therefore, the broadcasting receiving apparatus 100 may discard the expired FDTInstance according to the @Expires attribute.

Also, the FDTInstansce element according to an embodiment of the present invention may include a @Complete attribute. In an embodiment, when the @Complete attribute has a true value, the @Complete attribute may indicate that an FDTInstance to be provided in the same session does not include new data.

Also, the FDTInstansce element according to an embodiment of the present invention may include a @Content-Location attribute. The @Content-Location attribute may assign a valid URI.

Also, the FDTInstansce element according to an embodiment of the present invention may include a @TOI attribute. The @TOI attribute is required to be assigned a valid TOI value.

Also, the FDTInstansce element according to an embodiment of the present invention may include a @Content-Length attribute. The @Content-Length attribute may indicate actual length information of file content.

Also, the FDTInstansce element according to an embodiment of the present invention may include a @Transfer-Length attribute. The @Transfer-Length attribute may be transmission length information of file content.

Also, the FDTInstansce element according to an embodiment of the present invention may include a @Content-Encoding attribute. The @Content-Encoding attribute may be encoding information of file content.

Also, the FDTInstansce element according to an embodiment of the present invention may include a @Content-Type attribute. The @Content-Type attribute may be type information of file content.

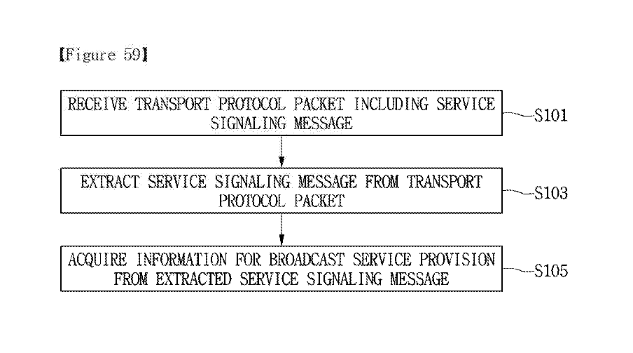

FIG. 59 is a flowchart of operation of a broadcasting receiving apparatus according to an embodiment.

A reception unit of the broadcasting receiving apparatus receives a transport protocol packet including a service signaling message (S101). The reception unit may include an Internet protocol communication unit and a broadcasting receiving unit. The service signaling message may be information for signaling at least one of a broadcast service and media content. In an embodiment, the transport protocol may be an Internet protocol (IP). Also, in an embodiment, the transport protocol may be expressed by at least one of a binary format and an XML format. A transport protocol packet may include a signaling message header and a signaling message.

The control unit of the broadcasting receiving apparatus extracts the service signaling message from the received transport protocol packet (S103). Specifically, the service signaling message may be extracted by parsing the transport protocol packet. The control unit may acquire an Internet protocol datagram from a layered transport protocol packet. The acquired Internet protocol datagram may include the service signaling message.

The control unit of the broadcasting receiving apparatus acquires information for providing a broadcast service from the service signaling message. The information for providing a broadcast service may be a part of the service signaling message.

In an embodiment, the information for providing a broadcast service may be transport mode information for a timebase including metadata for a timeline that is a series of time information for content.

In another embodiment, the information for providing a broadcast service may be transport mode information for detailed information for acquisition of segments constituting content in an adaptive media streaming. The detailed information for acquisition of segments constituting content in the adaptive media streaming may be referred to as media presentation description (MPD).

In another embodiment, the information for providing a broadcast service may be transport mode information for a path in which component data constituting content in a broadcast service is acquired. The component data may be an entity constituting the broadcast service or the content. In this case, information about the path in which component data is acquired may be identification information of a physical layer pipe for delivering component data. The layered transport protocol packet may include a physical layer pipe to be delivered through the physical layer. There may be a plurality of physical layer pipes. Therefore, it is required to identify a physical layer pipe including the component data to be acquired, from among the plurality of physical layer pipes.

In another embodiment, the information for providing a broadcast service may be transport mode information for a signaling message for an application used in a broadcast service. In this case, the transport mode information for the signaling message for an application may be at least one of identifier information of a broadcaster that transmits the application, a source IP address of an Internet protocol datagram including the application, a destination IP address of the Internet protocol datagram including the application, a port number of a user datagram protocol (UDP) of the Internet protocol datagram including the application, identifier information of a transport session for transmitting the application, and identifier information of a packet for transmitting the application.

In another embodiment, the information for providing a broadcast service may be transport mode information for a signaling message for a service used in a broadcast service. In this case, the service may be one content.

In another embodiment, the information for providing a broadcast service includes transport mode information for component data constituting a service. The transport mode information for component data may indicate at least one of a transport mode for supporting a non-realtime service, a transport mode for supporting a realtime service, and a transport mode for packet transmission.

In another embodiment, the information for providing the broadcast service may include information for reception of a realtime service with a file format.

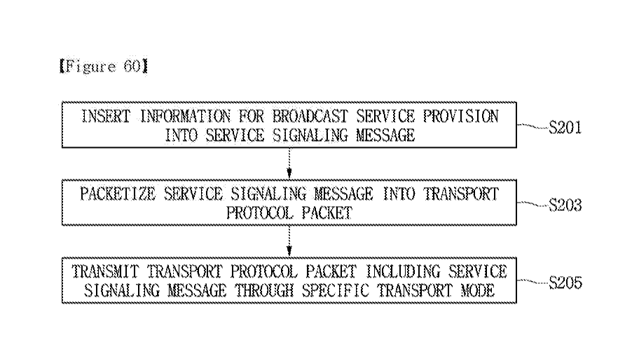

FIG. 60 is a flowchart of operation of a broadcasting transmitting apparatus according to an embodiment of the present invention.

The control unit of the broadcasting transmitting apparatus inserts information for broadcast service provision into a service signaling message (S201). In an embodiment, the control unit of the broadcasting transmitting apparatus inserts XML formatted-information for broadcast service provision into the service signaling message (S201). In another embodiment, the control unit of the broadcasting transmitting apparatus may insert binary-formatted information for broadcast service provision into the service signaling message.

The control unit of the broadcasting transmitting control unit packetizes, as a transport protocol packet, the service signaling message into which the information for broadcast service provision (S203). In this case, the transport protocol may be one of a session-based transport protocol (ALC/LCT or FLUTE) and a packet-based transport protocol (MPEG-2 TS or MMT).

A transmission unit of the broadcasting transmitting apparatus may transmit the transport protocol packet resulting from packetization of the service signaling message to the broadcasting receiving apparatus through a specific transport mode (S205). In an embodiment, the transport mode for transmitting the packetized transport protocol packet may be a transport mode for a timebase including metadata for a timeline that is a series of time information for content, used for a broadcast service. In another embodiment, the transport mode for transmitting the packetized transport protocol packet may be a transport mode for detailed information for acquisition of segments constituting content in an adaptive media streaming. In another embodiment, the transport mode for transmitting the packetized transport protocol packet may be a transport mode for a path in which component data constituting content in a broadcast service is acquired. In another embodiment, the transport mode for transmitting the packetized transport protocol packet may be a transport mode for a signaling message for an application used in a broadcast service. In another embodiment, the transport mode for transmitting the packetized transport protocol packet may be a transport mode for a signaling message for a service used in a broadcast service.

The characteristics, structures, and effects described in the embodiments above are included in at least one embodiment but are not limited to one embodiment.

Furthermore, the characteristic, structure, and effect illustrated in each embodiment may be combined or modified for other embodiments by a person skilled in the art. Thus, it would be construed that contents related to such a combination and such a variation are included in the scope of embodiments.

Embodiments are mostly described above. However, they are only examples and do not limit the inventive concept. A person skilled in the art may appreciate that many variations and applications not presented above may be implemented without departing from the essential characteristic of embodiments. For example, each component particularly represented in embodiments may be varied. In addition, it should be construed that differences related to such a variation and such an application are included in the scope of the inventive concept defined in the following claims.

1. A broadcasting receiving apparatus comprising:
a reception unit configured to receive a transport protocol packet including a service signaling message for signaling a broadcast service; and
a control unit configured to extract the service signaling message from the received transport protocol packet and acquire information for providing the broadcast service from the extracted service signaling message.

2. The broadcasting receiving apparatus according to claim 1, wherein the information for providing the broadcast service includes at least one of first transport mode information for a timebase including metadata for a timeline that is a series of time information for content, used in the broadcast service, second transport mode information for detailed information for acquisition of segments constituting content in adaptive media streaming, third transport mode information for a path for acquisition of component data constituting content in the broadcast service, fourth transport mode information for a signaling message for an application used in the broadcast service, and fifth transport mode information for a signaling message for a service used in the broadcast service.

3. The broadcasting receiving apparatus according to claim 1, wherein the control unit acquires at least one of the timebase, the detailed information for acquisition of the segments, the path for acquisition of the component data, the signaling message for the application, and the signaling message for the service, via an Internet protocol datagram in the same broadcast stream as a broadcast stream through which the service signaling message is received currently.

4. The broadcasting receiving apparatus according to claim 1, wherein the control unit acquires at least one of the timebase, the detailed information for acquisition of the segments, the path for acquisition of the component data, the signaling message for the application, and the signaling message for the service, via an Internet protocol datagram in a different broadcast stream from a broadcast stream through which the service signaling message is received currently.

5. The broadcasting receiving apparatus according to claim 4, wherein the control unit acquires information for identifying a broadcaster which transmits the different broadcast stream from the broadcast stream through which the service signaling message is received currently.

6. The broadcasting receiving apparatus according to claim 1, wherein the control unit acquires at least one of the timebase, the detailed information for acquisition of the segments, the path for acquisition of the component data, the signaling message for the application, and the signaling message for the service, via a session-based transport protocol in the same broadcast stream as a broadcast stream through which the service signaling message is received currently.

7. The broadcasting receiving apparatus according to claim 1, wherein the control unit acquires at least one of the timebase, the detailed information for acquisition of the segments, the path for acquisition of the component data, the signaling message for the application, and the signaling message for the service, via a session-based transport protocol in a different broadcast stream from a broadcast stream through which the service signaling message is received currently.

8. The broadcasting receiving apparatus according to claim 1, wherein the control unit acquires at least one of the timebase, the detailed information for acquisition of the segments, the path for acquisition of the component data, the signaling message for the application, and the signaling message for the service, via a packet-based flow in the same broadcast stream as a broadcast stream through which the service signaling message is received currently.

9. The broadcasting receiving apparatus according to claim 1, wherein the control unit acquires at least one of the timebase, the detailed information for acquisition of the segments, the path for acquisition of the component data, the signaling message for the application, and the signaling message for the service, via a packet-based flow in a different broadcast stream from a broadcast stream through which the service signaling message is received currently.

10. The broadcasting receiving apparatus according to claim 2, wherein the third transport mode information includes at least one of identification information of a physical layer pipe for delivering the component data, a source Internet protocol address of the Internet protocol datagram including the component data, and a destination Internet protocol address of the Internet protocol datagram including the component data.

11. The broadcasting receiving apparatus according to claim 2, wherein the fourth transport mode information includes at least one of identifier information of a broadcaster which transmits the application, a source IP address of an Internet protocol datagram including the application, a destination IP address of the Internet protocol datagram including the application, a port number of a user datagram protocol (UDP) of the Internet protocol datagram including the application, identifier information of a transport session for transmitting the application, and identifier information of a packet for transmitting the application.

12. The broadcasting receiving apparatus according to claim 1, wherein the information for providing the broadcast service includes sixth transport mode information for component data constituting a service, and
the sixth transport mode information indicates at least one of a transport mode for supporting a non-realtime service, a transport mode for supporting a realtime service, and a transport mode for transmitting a packet.

13. The broadcasting receiving apparatus according to claim 1, wherein the information for providing the broadcast service includes information for receiving a realtime service with a file format.

14. A method for operating a broadcasting receiving apparatus comprising:
receiving a transport protocol packet including a service signaling message for signaling a broadcast service;
extracting the service signaling message from the received transport protocol packet; and
acquiring information for providing the broadcast service from the extracted service signaling message.

15. The method according to claim 14, wherein the acquiring of the information for providing the broadcast service comprises acquiring at least one of first transport mode information for a timebase including metadata for a timeline that is a series of time information for content, used in the broadcast service, second transport mode information for detailed information for acquisition of segments constituting content in adaptive media streaming, third transport mode information for a path for acquisition of component data constituting content in a broadcast service, fourth transport mode information for a signaling message for an application used in the broadcast service, and fifth transport mode information for a signaling message for a service used in the broadcast service.

16. The method according to claim 14, wherein the acquiring of the information for providing the broadcast service comprises acquiring sixth transport mode information for component data constituting a service, and
the sixth transport mode information indicates at least one of a transport mode for supporting a non-realtime service, a transport mode for supporting a realtime service, and a transport mode for transmitting a packet.

17. The method according to claim 14, wherein the acquiring of the information for providing the broadcast service comprises acquiring information for receiving a realtime service with a file format.

18. A broadcasting transmitting apparatus comprising:
a control unit configured to insert information for providing a broadcast service into a service signaling message and packetize the service signaling message into a transport protocol packet; and
a transmission unit configured to transmit the transport protocol packet through a specific transport mode.

19. The broadcasting transmitting apparatus according to claim 18, wherein the specific transport mode is at least one of a transport mode for a timebase including metadata for a timeline that is a series of time information for content, used in the broadcast service, a second transport mode for detailed information for acquisition of segments constituting content in adaptive media streaming, a third transport mode for a path for acquisition of component data constituting content in a broadcast service, a fourth transport mode for a signaling message for an application used in the broadcast service, and a fifth transport mode for a signaling message for a service used in the broadcast service.

20. The broadcasting transmitting apparatus according to claim 18, wherein the specific transport mode further includes a transport mode for component data constituting the broadcast service.
